(19) United States
(12) Patent Application Publication
(10) Pub. No.: US 2016/0006914 A1
(43) Pub. Date: Jan. 7, 2016

(54) Interactive Illumination for Gesture and/or Object Recognition

(71) Applicant: 2r1y, San Francisco, CA (US)

(72) Inventor: Richard William NEUMANN, San Francisco, CA (US)

(21) Appl. No.: 14/597,819

(22) Filed: Jan. 15, 2015

Related U.S. Application Data
(63) Continuation of application No. PCT/US13/50551, filed on Jul. 15, 2013.
(60) Provisional application No. 61/671,764, filed on Jul. 15, 2012.
(60) Provisional application No. 61/682,299, filed on Aug. 12, 2012.
(60) Provisional application No. 61/754,914, filed on Jan. 21, 2013.

(51) Int. Cl. H04N 5/225; H04N 5/235; H04N 5/33; G06F 3/01; G06F 3/03

(52) U.S. Cl. CPC H04N 5/2256; G06F 3/013; G06F 3/0325; H04N 5/33; H04N 5/2354

(57) ABSTRACT

Methods and systems described here may be used for target illumination and mapping. Certain embodiments include a light source and an image sensor, where the light source configured to, communicate with a processor, scan a target area within a field of view, receive direction from the processor regarding projecting light within the field of view on at least one target, the image sensor configured to, communicate with the processor, receive reflected illumination from the target area within the field of view, generate data regarding the received reflected illumination; and send the data regarding the received reflected illumination to the processor.

### CROSS-REFERENCE TO RELATED APPLICATIONS

This patent application claims priority from and is related to International application no. PCT/US13/50551 filed 15 Jul. 2013, which claims priority from U.S. provisional applications 61/671,764 filed 15 Jul. 2012, 61/682,299 filed 12 Aug. 2012, and 61/754,914 filed 21 Jan. 2013, which are hereby incorporated by reference in their entirety.

### TECHNICAL FIELD

The embodiments here relates to an illumination system for illumination of a target area for image capture in order to allow for three dimensional object recognition and target mapping.

### BACKGROUND

Current object recognition illumination and measuring systems do not provide energy efficient illumination. Thus there is a need for an improved, cost efficient illumination device for illumination of a target object such as a human.

### SUMMARY

The disclosure includes methods and systems including a system for target illumination and mapping, comprising, a light source and an image sensor, the light source configured to, communicate with a processor, scan a target area within a field of view, receive direction from the processor regarding projecting light within the field of view on at least one target, the image sensor configured to, communicate with the processor, receive reflected illumination from the target area within the field of view, generate data regarding the received reflected illumination, and send the data regarding the received reflected illumination to the processor.

Such systems where the light source is an array of light emitting diodes (LEDs). Such systems where the light source is a laser, where the laser is at least one of, amplitude modulated and pulse width modulated.

Such systems where the laser is an infrared laser and the image sensor is configured to receive and process infrared energy. Such systems where the direction received from the processor includes direction to track the at least one target. Such systems where the data regarding the received reflected illumination includes information that would allow the processor to determine the distance from the system to the select target via triangulation.

Such systems where the system is light source is further configured to receive direction from the processor to illuminate the tracked target in motion. Such systems where the light source is further configured to block illumination of particular areas on the at least one select target via direction from the processor.

Such systems where the target is a human, and where the particular areas on the at least one select target are areas which correspond to eyes of the target. Such systems where the scan of the target area is a raster scan. Such systems where the raster scan is completed within one frame of the image sensor.

Such systems where the light source includes at least one of, a single axis micro electromechanical system mirror (MEMS) and a dual axis MEMS, to direct the light. Such systems where the light source includes at least one of, a rotating mirror. Such systems where the tracking the selected target includes more than one selected target.

Such systems where the image sensor is further configured to generate gray shade image data based on the received infrared illumination, and assign visible colors to gray shades of the image data. Such systems where the image sensor is a complementary metal oxide semiconductor (CMOS). Such systems where the image sensor is a charge coupled device (CCD). Such systems where the light source and the image sensor include optical filters. Such systems where the light source is a laser.

Another example system includes a system for illuminating a target area, including, a directionally controlled laser light source, and an image sensor, the directionally controlled laser light source configured to, communicate with a processor, scan the target area, receive direction on illuminating specific selected targets within the target area from the processor, where the laser is at least one of, amplitude modulated and pulse width modulated, and the image sensor configured to communicate with the processor, receive the laser light reflected off of the target area, generate data regarding the received reflected laser light, and send the data regarding the received laser light to the processor.

Such systems where the laser light source is further configured to receive direction from the processor to illuminate at least two target objects with different illumination patterns. Such systems where the data regarding the received reflected laser light is configured to allow the processor to calculate a depth map. Such systems where the image sensor is a complementary metal oxide semiconductor (CMOS).

Such systems where the image sensor is a charge coupled device (CCD). Such systems where the light source and the image sensor include optical filters. Such systems where the data regarding the received reflected laser light is configured to allow the processor to calculate a point cloud. Such systems where the directional control is via at least one of a single axis micro electromechanical system mirror (MEMS) and a dual axis MEMS.

Such systems where the directional control is via at least one rotating mirror. Such systems where the laser is a continuous wave laser, and the laser light source is further configured to receive direction to send a pulse of energy to a unique part of the target area, creating pixels for the image sensor.

Another example method includes a method for target illumination and mapping, including, via a light source, communicating with a processor, scanning a target area within a field of view, receiving direction from the processor regarding projecting light within the field of view on at least one target, via an image sensor, communicating with the processor, receiving reflected illumination from the target area within the field of view, generating data regarding the received reflected illumination, and sending the data regarding the received reflected illumination to the processor.

Such methods where the light source is an array of light emitting diodes (LEDs). Such methods where the light source is a laser, where the laser is at least one of, amplitude modulated and pulse width modulated. Such methods where the laser is an infrared laser and the image sensor is configured to receive and process infrared energy.

Such methods where the direction received from the processor includes direction to track the at least one target. Such methods where the data regarding the received reflected illumination includes information that would allow the processor to determine the distance from the system to the select target via triangulation. Such methods further comprising, via the light source, receiving direction from the processor to illuminate the tracked target in motion.

Such methods further comprising, via the light source, blocking illumination of particular areas on the at least one select target via direction from the processor. Such methods where the target is a human, and where the particular areas on the at least one select target are areas which correspond to eyes of the target. Such methods where the scan of the target area is a raster scan. Such methods where the raster scan is completed within one frame of the image sensor. Such methods where the light source includes at least one of, a single axis micro electromechanical system mirror (MEMS) and a dual axis MEMS, to direct the light. Such methods where the light source includes at least one of, a rotating mirror.

Such methods where the tracking the selected target includes more than one selected target. Such methods further comprising, via the image sensor, generating gray shade image data based on the received infrared illumination, and assigning visible colors to gray shades of the image data. Such methods where the image sensor is a complementary metal oxide semiconductor (CMOS). Such methods where the image sensor is a charge coupled device (CCD). Such methods where the light source and the image sensor include optical filters. Such methods where the light source is a laser.

Another example method includes a method for illuminating a target area, comprising, via a directionally controlled laser light source, communicating with a processor, scanning the target area, receiving direction on illuminating specific selected targets within the target area from the processor, where the laser is at least one of, amplitude modulated and pulse width modulated, and via an image sensor, communicating with the processor, receiving the laser light reflected off of the target area, generating data regarding the received reflected laser light, and sending the data regarding the received laser light to the processor. Such methods further comprising, via the laser light source, receiving direction from the processor to illuminate at least two target objects with different illumination patterns.

Such methods where the data regarding the received reflected laser light is configured to allow the processor to calculate a depth map. Such methods where the image sensor is a complementary metal oxide semiconductor (CMOS). Such methods where the image sensor is a charge coupled device (CCD). Such methods where the light source and the image sensor include optical filters.

Such methods where the data regarding the received reflected laser light is configured to allow the processor to calculate a point cloud. Such methods where the directional control is via at least one of a single axis micro electromechanical system mirror (MEMS) and a dual axis MEMS. Such methods where the directional control is via at least one rotating mirror. Such methods further comprising, via the laser light source, receiving direction to send a pulse of energy to a unique part of the target area, creating pixels for the image sensor. Such methods where the laser is a continuous wave laser.

Another example system includes a system for target area illumination, comprising, a directional illumination source and image sensor, the directional illumination source configured to, communicate with a processor, receive direction to illuminate the target area from the processor, and project illumination on the target area, where the laser is at least one of, amplitude modulated and pulse width modulated, and the image sensor configured to, communicate with the processor, capture reflected illumination off of the target area, generate data regarding the captured reflected illumination, and send the data regarding the capture reflected illumination to the processor, where the illumination source and the image sensor share an aperture and which a throw angle of the directed illumination and a field of view angle of the reflected captured illumination are matched.

Such systems where the laser is an infrared laser and the image sensor is configured to receive and process infrared energy. Such systems where the laser includes at least one of a single axis micro electromechanical system mirror (MEMS) and a dual axis MEMS to direct the light. Such systems where the data regarding the captured reflected illumination includes information regarding triangulation for distance measurements. Such systems where the illumination source is further configured to receive instruction regarding motion tracking of the select target. Such systems where the shared aperture is at least one of adjacent, common and objective.

Another example method includes a method for target area illumination, comprising, via a directional illumination source, communicating with a processor, receiving direction to illuminate the target area from the processor, and projecting illumination on the target area, where the laser is at least one of, amplitude modulated and pulse width modulated, and via an image sensor, communicating with the processor, capturing reflected illumination off of the target area, generating data regarding the captured reflected illumination, and sending the data regarding the capture reflected illumination to the processor, where the illumination source and the image sensor share an aperture and which a throw angle of the directed illumination and a field of view angle of the reflected captured illumination are matched. Such methods where the laser is an infrared laser and the image sensor is configured to receive and process infrared energy, and where the shared aperture is at least one of adjacent, common and objective.

Such methods where the laser includes at least one of a single axis micro electromechanical system mirror (MEMS) and a dual axis MEMS to direct the light. Such methods where the data regarding the captured reflected illumination includes information regarding triangulation for distance measurements.

Another example system includes a system for illuminating a target area, comprising, a light source and an image sensor, the light source configured to, communicate with a processor, illuminate a target area with at least one pattern of light, within a field of view, receive direction to illuminate at least one select target within the target area from the processor, and receive information regarding illuminating the at least one select target with at least one calibrated pattern of light, from the processor, where the laser is at least one of, amplitude modulated and pulse width modulated, and the image sensor configured to, communicate with the processor, receive reflected illumination patterns from the at least one select target within the field of view, generate data regarding the received reflected illumination patterns, and send data about the received reflected illumination patterns to the processor, where the data includes, information allowing the processor to determine distance to the at least one select target via triangulation of the illumination and received reflected illumination, and information regarding structured light of the at least one received reflected illumination patterns.

Such methods where the pattern is at least one of, alternating illuminated and non-illuminated stripes, intensity modulated stripes, sequential sinusoidal, trapezoidal, Moire' pattern, multi-wavelength 3D, continuously varying, striped indexing, segmented stripes, coded stripes, indexing gray scale, De Bruiin sequence, pseudo-random binary, mini-pattern, wavelength coded grid, and wavelength dot array. Such methods where the light source is further configured to change illumination patterns. Such methods where the light source is a laser. Such methods where the direction to illuminate at least one select target, includes direction to track the motion of the at least one select target.

Another example system includes a system for allowing mapping of a target area, comprising, a laser and an image sensor, the laser configured to, communicate with a processor, receive direction to illuminate at least one select target with a pattern of light, project illumination on the at least one select target with the pattern of light, receive information regarding calibration of the pattern of light, project calibrated illumination on the at least one select target, the image sensor configured to, communicate with the processor, receive reflected laser illumination patterns from the at least one select target, generate data regarding the received reflected laser illumination patterns, and send the data regarding the received reflected laser illumination to the processor, where the data includes information that would allow the processor to, determine distance via triangulation, generate a map of the target area via 3D surface measurements, and generate a point cloud of the select target.

Such systems where the pattern is at least one of, alternating illuminated and non-illuminated stripes, intensity modulated stripes, sequential sinusoidal, trapezoidal, Moire' pattern, multi-wavelength 3D, continuously varying, striped indexing, segmented stripes, coded stripes, indexing gray scale, De Bruiin sequence, pseudo-random binary, mini-pattern, wavelength coded grid, and wavelength dot array. Such systems where the light source is further configured to change illumination patterns. Such systems where the laser is further configured to receive direction to track a motion of the selected target. Such systems where the image sensor is at least one of complementary metal oxide semiconductor (CMOS) and charge coupled device (CCD).

Another example method includes a method for illuminating a target area, comprising, via a light source, communicating with a processor, illuminating a target area with at least one pattern of light, within a field of view, receiving direction to illuminate at least one select target within the target area from the processor, and receiving information regarding illuminating the at least one select target with at least one calibrated pattern of light, from the processor, where the laser is at least one of, amplitude modulated and pulse width modulated, and via an image sensor, communicating with the processor, receiving reflected illumination patterns from the at least one select target within the field of view, generating data regarding the received reflected illumination patterns, and sending data about the received reflected illumination patterns to the processor, where the data includes, information allowing the processor to determine distance to the at least one select target via triangulation of the illumination and received reflected illumination, and information regarding structured light of the at least one received reflected illumination patterns.

Such methods where the pattern is at least one of, alternating illuminated and non-illuminated stripes, intensity modulated stripes, sequential sinusoidal, trapezoidal, Moire' pattern, multi-wavelength 3D, continuously varying, striped indexing, segmented stripes, coded stripes, indexing gray scale, De Bruiin sequence, pseudo-random binary, mini-pattern, wavelength coded grid, and wavelength dot array. Such methods further comprising, via the light source, projecting a new illumination pattern. Such methods where the light source is a laser. Such methods where the direction to illuminate at least one select target, includes direction to track the motion of the at least one select target.

Another example method includes a method for allowing mapping of a target area, comprising, via a laser, communicating with a processor, receiving direction to illuminate at least one select target with a pattern of light, projecting illumination on the at least one select target with the pattern of light, receiving information regarding calibration of the pattern of light, projecting calibrated illumination on the at least one select target, via an image sensor, communicating with the processor, receiving reflected laser illumination patterns from the at least one select target, generating data regarding the received reflected laser illumination patterns, and sending the data regarding the received reflected laser illumination to the processor, where the data includes information that would allow the processor to, determine distance via triangulation, generate a map of the target area via 3D surface measurements, and generate a point cloud of the select target.

Such methods where the pattern is at least one of, alternating illuminated and non-illuminated stripes, intensity modulated stripes, sequential sinusoidal, trapezoidal, Moire' pattern, multi-wavelength 3D, continuously varying, striped indexing, segmented stripes, coded stripes, indexing gray scale, De Bruiin sequence, pseudo-random binary, mini-pattern, wavelength coded grid, and wavelength dot array. Such methods further comprising, via the light source, projecting a new illumination pattern. Such methods further comprising, via the laser, receiving direction to track a motion of the selected target. Such methods where the image sensor is at least one of complementary metal oxide semiconductor (CMOS) and charge coupled device (CCD).

Another example system includes a system for target illumination and mapping, comprising, an infrared light source and an image sensor, the infrared light source configured to, communicate with a processor, illuminate a target area within a field of view, receive direction from the processor, to illuminate at least one select target within the field of view, project illumination on the at least one select target, where the laser is at least one of, amplitude modulated and pulse width modulated, and the image sensor, having a dual band pass filter, configured to, communicate with the processor, receive reflected illumination from the target area within the field of view, receive reflected illumination from the at least one select target within the target area, generate data regarding the received reflected illumination, and send the data to the processor. Such systems where the dual band pass filter is configured to allow visible light and light at the wavelengths emitted by the infrared light source, to pass. Such systems where the visible light wavelengths are between 400 nm and 700 nm. Such systems where dual band pass filter includes a notch filter. Such systems where the image sensor is at least one of a complementary metal oxide semiconductor (CMOS) and a charge coupled device (CCD), and where the infrared light source includes at least one of a single axis micro electromechanical system mirror (MEMS) and a dual axis MEMS to direct the light.

Another example method includes a method for target illumination and mapping, comprising, via an infrared light source, communicating with a processor, illuminating a target area within a field of view, receiving direction from the processor, to illuminate at least one select target within the field of view, projecting illumination on the at least one select target, where the laser is at least one of, amplitude modulated and pulse width modulated, and via an image sensor, having a dual band pass filter, communicating with the processor, receiving reflected illumination from the target area within the field of view, receiving reflected illumination from the at least one select target within the target area, generating data regarding the received reflected illumination, and sending the data to the processor.

Such methods where the dual band pass filter is configured to allow visible light and light at the wavelengths emitted by the infrared light source, to pass. Such methods where the visible light wavelengths are between 400 nm and 700 nm. Such methods where dual band pass filter includes a notch filter. Such methods where the image sensor is at least one of a complementary metal oxide semiconductor (CMOS) and a charge coupled device (CCD), and where the infrared light source includes at least one of a single axis micro electromechanical system mirror (MEMS) and a dual axis MEMS to direct the light.

Another example system includes a system for target illumination and mapping, comprising, a laser light source and an image sensor, the laser light source configured to, communicate with a processor, project square wave illumination to at least one select target, where the square wave includes at least a leading edge and a trailing edge, send information to the processor regarding the time the leading edge of the square wave illumination was projected and the time the trailing edge of the square wave was projected, where the laser is at least one of, amplitude modulated and pulse width modulated, and the image sensor configured to, communicate with the processor, receive at least one reflected square wave illumination from the at least one select target, generate a signal based on the received reflected square wave illumination, where the signal includes at least information regarding the received time of the leading edge and received time of the trailing edge of the square wave, and send the signal regarding the received reflected square wave illumination to the processor.

Such systems where the laser light source is further configured to pulse, and where the square wave leading edge is caused by the laser pulse on and the trailing edge is caused by the laser pulse off. Such systems where the laser light source is further configured to change polarization, and where the square wave is caused by a change of polarization. Such systems where the laser light source is further configured to switch gain in order to change polarization. Such systems where the image sensor is a current assisted photon demodulation (CAPD).

Another example method includes a method for target illumination and mapping, comprising, via a laser light source, communicating with a processor, projecting square wave illumination to at least one select target, where the square wave includes at least a leading edge and a trailing edge, sending information to the processor regarding the time the leading edge of the square wave illumination was projected and the time the trailing edge of the square wave was projected, where the laser is at least one of, amplitude modulated and pulse width modulated, and via an image sensor, communicating with the processor, receiving at least one reflected square wave illumination from the at least one select target, generating a signal based on the received reflected square wave illumination, where the signal includes at least information regarding the received time of the leading edge and received time of the trailing edge of the square wave, and sending the signal regarding the received reflected square wave illumination to the processor.

Such methods, further comprising, via the laser light source, projecting a pulse of energy, where the square wave leading edge is caused by the laser pulse on and the trailing edge is caused by the laser pulse off. Such methods, further comprising, via the laser light source, projecting energy with a new polarization, where the square wave is caused by a change of polarization. Such methods further comprising, via the laser light source switching gain in order to change polarization. Such methods where the image sensor is a current assisted photon demodulation (CAPD).

Another example system includes a system for target illumination and mapping, comprising, an infrared laser light source and an image sensor, the infrared laser light source configured to, communicate with a processor, illuminate at least one select target within a field of view, where the laser is at least one of, amplitude modulated and pulse width modulated, and the image sensor configured to, communicate with the processor, receive reflected illumination from the at least one select target within the field of view, create a signal based on the received reflected illumination, and send the signal to the processor, where the signal includes at least information that would allow the processor to map the target area and generate an image of the target area.

Such systems where the image is a gray scale image. Such systems where the signal further includes information that would allow the processor to assign visible colors to the gray scale. Such systems where the infrared laser light source is further configured to receive direction from the processor to illuminate a select target. Such systems where the infrared laser light source is further configured to receive direction from the processor to track the motion of the select target and maintain illumination on the select target.

Another example method includes a method for target illumination and mapping, comprising, via an infrared laser light source, communicating with a processor, illuminating at least one select target within a field of view, where the laser is at least one of, amplitude modulated and pulse width modulated, and via an image sensor, communicating with the processor, receiving reflected illumination from the at least one select target within the field of view, creating a signal based on the received reflected illumination, and sending the signal to the processor, where the signal includes at least information that would allow the processor to map the target area and generate an image of the target area.

Such methods where the image is a gray scale image. Such methods where the signal further includes information that would allow the processor to assign visible colors to the gray scale. Such methods where the infrared laser light source is further configured to receive direction from the processor to illuminate a select target. Such methods where the infrared laser light source is further configured to receive direction from the processor to track the motion of the select target and maintain illumination on the select target.

Another example system includes a system for target illumination comprising, an illumination device in communication with an image sensor, the illumination device further configured to, communicate with a processor, project low level full scan illumination to a target area, where the laser is at least one of, amplitude modulated and pulse width modulated, the image sensor further configured to, communicate with the processor, receive reflected illumination from the target area, the processor configured to, identify specific target areas of interest, map the target area, set a value of the number of image pulses for one scan, calculate the energy intensity of each pulse, calculate the total intensity per frame, and compare the total intensity per frame to an eye safety limit, the computing system further configured to, direct the illumination device to scan if the total intensity per frame is less than the eye safety limit, and direct the illumination device to stop scan if the total intensity per frame is greater than or equal to the eye safety limit.

Such systems where the processor is further configured to communicate to a user an error message if the total intensity per frame is greater than or equal to the eye safety limit. Such systems where the processor is further configured to, if the total intensity per frame is greater than or equal to the eye safety limit, map the target area, set a new value of the number of image pulses for one scan, calculate the energy intensity of each pulse, calculate the total intensity per frame, and compare the total intensity per frame to an eye safety limit. Such systems where the computing system is further configured to track the specific target of interest and direct the illumination source to illuminate the specific area of interest. Such systems where the illumination source includes a laser and a micro electromechanical system mirror (MEMS) to direct the light.

Another example method includes a method for target illumination comprising, via an illumination device, communicating with a processor, projecting low level full scan illumination to a target area, where the laser is at least one of, amplitude modulated and pulse width modulated, via an image sensor, communicating with the processor, receiving reflected illumination from the target area, via the processor, identifying specific target areas of interest, mapping the target area, setting a value of the number of image pulses for one scan, calculating the energy intensity of each pulse, calculating the total intensity per frame, and comparing the total intensity per frame to an eye safety limit, directing the illumination device to scan if the total intensity per frame is less than the eye safety limit, and directing the illumination device to stop scan if the total intensity per frame is greater than or equal to the eye safety limit.

Such methods further comprising, via the processor, communicating to a user an error message if the total intensity per frame is greater than or equal to the eye safety limit. Such methods further comprising, via the processor, if the total intensity per frame is greater than or equal to the eye safety limit, mapping the target area, setting a new value of the number of image pulses for one scan, calculating the energy intensity of each pulse, calculating the total intensity per frame, and comparing the total intensity per frame to an eye safety limit. Such methods where the computing system is further configured to track the specific target of interest and direct the illumination source to illuminate the specific area of interest. Such methods where the illumination source includes a laser and a micro electromechanical system mirror (MEMS) to direct the light.

Another example system includes a system for target illumination and mapping, comprising, a directed light source, at least one image projector, and an image sensor, the directed light source configured to, communicate with a processor, illuminate at least one select target area within a field of view, receive direction to illuminate an at least one select target, where the laser is at least one of, amplitude modulated and pulse width modulated, the image sensor configured to, communicate with the processor, receive reflected illumination from the at least one select target within the target area, create data regarding the received reflected illumination, send data regarding the received reflected illumination to the processor, and the image projector configured to, communicate with the processor, receive direction to project an image on the at least one select target, and project an image on the at least one select target.

Such systems where the directed light source is an infrared laser. Such systems where the data regarding the received reflected illumination includes information regarding the distance from the system to the target via triangulation. Such systems where the image projector is calibrated to the distance calculation from the processor, where calibration includes adjustments to a throw angle of the image projector. Such systems where the image projector is further configured to project at least two images on at least two different identified and tracked targets. Such systems where the image sensor is at least one of a complementary metal oxide semiconductor (CMOS) and a charge coupled device (CCD). Such systems where the directed light source is configured to project a pattern of illumination on the select target.

Another example system includes a system for target illumination and mapping, comprising, a directed light source and an image sensor, the directed light source configured to, communicate with a processor, illuminate at least one target area within a field of view, receive direction to track a selected target within the target area from the processor, receive direction to project an image on the tracked selected target from the processor, project an image on the tracked selected target according to the received direction, the image sensor configured to, communicate with the processor, receive reflected illumination from the at least one select target within the field of view, generate data regarding the received reflected illumination, and send the received reflected illumination data to the processor. Such systems where the directed light source is a visible light laser and the image is a laser scan image, where the laser is at least one of, amplitude modulated and pulse width modulated. Such systems where the image sensor is at least one of a complementary metal oxide semiconductor (CMOS) and a charge coupled device (CCD).

Another example method includes a method for target illumination and mapping, comprising, via a directed light source, communicating with a processor, illuminating at least one select target area within a field of view, receiving direction to illuminate an at least one select target, where the laser is at least one of, amplitude modulated and pulse width modulated, via an image sensor, communicating with the processor, receiving reflected illumination from the at least one select target within the target area, creating data regarding the received reflected illumination, sending data regarding the received reflected illumination to the processor, and via an image projector, communicating with the processor, receiving direction to project an image on the at least one select target, and projecting an image on the at least one select target.

Such methods where the directed light source is an infrared laser. Such methods where the data regarding the received reflected illumination includes information regarding the distance from the system to the target via triangulation. Such methods where the image projector is calibrated to the distance calculation from the processor, where calibration includes adjustments to a throw angle of the image projector. Such methods, further comprising, via the image projector, projecting at least two images on at least two different identified and tracked targets. Such methods where the image sensor is at least one of a complementary metal oxide semiconductor (CMOS) and a charge coupled device (CCD). Such methods further comprising, via the directed light source, projecting a pattern of illumination on the select target.

Another example method includes a method for target illumination and mapping, comprising, via a directed light source, communicating with a processor, illuminating at least one target area within a field of view, receiving direction to track a selected target within the target area from the processor, receiving direction to project an image on the tracked selected target from the processor, projecting an image on the tracked selected target according to the received direction, via an image sensor, communicating with the processor, receiving reflected illumination from the at least one select target within the field of view, generating data regarding the received reflected illumination, and sending the received reflected illumination data to the processor.

Such methods where the directed light source is a visible light laser and the image is a laser scan image, where the laser is at least one of, amplitude modulated and pulse width modulated. Such methods where the image sensor is at least one of a complementary metal oxide semiconductor (CMOS) and a charge coupled device (CCD).

Another example system includes a system for target illumination and mapping, comprising, a directional light source and an image sensor, the directional light source configured to, communicate with a processor, illuminate at least one target area within a field of view with a scan of at least one pixel point, receive direction to illuminate the target with additional pixel points over time for additional calculations of distance, from the at least one processor, the image sensor configured to, communicate with the processor, receive a reflection of the at least one pixel point from the at least one select target within the field of view, generate data regarding the received pixel reflection, send the data regarding the received pixel reflection to the at least one processor, where the data includes information that the processor could analyze and determine distance from the system to the target via triangulation, and where the data further includes information regarding the relative proximity between the directional light source and the image sensor.

Such systems where the directional light source is a laser, and at least one of, amplitude modulated and pulse width modulated. Such systems where the data further includes information that the processor could analyze and determine a depth map, based on the calculations of distance of the at least one target pixel point. Such systems where the data further includes information that the processor could analyze and determine the distance between the system and the target via triangulation among the directed light source, the image sensor, and the additional pixel points. Such systems where the directional light source is further configured to receive direction to illuminate the selected target with at least one pixel point from the processor.

Another example method includes a method for target illumination and mapping, comprising, via a directional light source, communicating with a processor, illuminating at least one target area within a field of view with a scan of at least one pixel point, receiving direction to illuminate the target with additional pixel points over time for additional calculations of distance, from the at least one processor, via an image sensor, communicating with the processor, receiving a reflection of the at least one pixel point from the at least one select target within the field of view, generating data regarding the received pixel reflection, sending the data regarding the received pixel reflection to the at least one processor, where the data includes information that the processor could analyze and determine distance from the system to the target via triangulation, and where the data further includes information regarding the relative proximity between the directional light source and the image sensor.

Such methods where the directional light source is a laser, and at least one of, amplitude modulated and pulse width modulated. Such methods, where the data further includes information that the processor could analyze and determine a depth map, based on the calculations of distance of the at least one target pixel point. Such methods where the data further includes information that the processor could analyze and determine the distance between the system and the target via triangulation among the directed light source, the image sensor, and the additional pixel points. Such methods further comprising, via the directional light source receiving direction to illuminate the selected target with at least one pixel point from the processor.

Another example system includes a system for biometric analysis, comprising, a directed laser light source and an image sensor, the directed laser light source configured to communicate with a processor, illuminate a target area within a field of view, receive direction to illuminate at least one select target in the target area, receive direction to illuminate a biometric area of the at least one select target, where the laser is at least one of, amplitude modulated and pulse width modulated, and the image sensor configured to, communicate with the processor, receive reflected illumination from the at least one target area within the field of view, generate data regarding the received reflected illumination, send the generated data to the processor, where the data includes at least information that would allow the processor to map the target area, identify the select target within the target area, and determine a biometric reading of the at least one select target.

Such systems where the biometric reading is at least one of, skin deflection, skin reflectivity, and oxygen absorption. Such systems where the illumination is a pattern of illumination, and where the computing system is further configured to analyze the reflected pattern illumination from the target. Such systems where the data contains further information that would allow the processor to calculate a distance from the system to the target via triangulation. Such systems where the light source is further configured to receive calibration information of the illumination pattern, and project the calibrated pattern on the at least one select target.

Another example method includes a method for biometric analysis, comprising, via a directed laser light source, communicating with a processor, illuminating a target area within a field of view, receiving direction to illuminate at least one select target in the target area, receiving direction to illuminate a biometric area of the at least one select target, where the laser is at least one of, amplitude modulated and pulse width modulated, and via an image sensor, communicating with the processor, receiving reflected illumination from the at least one target area within the field of view, generating data regarding the received reflected illumination, sending the generated data to the processor, where the data includes at least information that would allow the processor to map the target area, identify the select target within the target area, and determine a biometric reading of the at least one select target.

Such methods where the biometric reading is at least one of, skin deflection, skin reflectivity, and oxygen absorption. Such methods where the illumination is a pattern of illumination, and where the computing system is further configured to analyze the reflected pattern illumination from the target. Such methods where the data contains further information that would allow the processor to calculate a distance from the system to the target via triangulation. Such methods further comprising, via the light source, receiving calibration information of the illumination pattern, and projecting the calibrated pattern on the at least one select target.

Another example system includes a system for target illumination and mapping, comprising, a directed light source, and an image sensor, the light source having an aperture and configured to, illuminate a target area within a field of view, via an incremental scan, where each increment has a unique outbound angle from the light source aperture, and a unique inbound angle to the image sensor aperture, send data regarding the incremental outbound angles to the processor, and the image sensor having an aperture and configured to, receive reflected illumination from the at least one select target within the field of view, generate data regarding the received reflected illumination including inbound angles, and send the data regarding the received reflected illumination to the processor, where the data regarding the outbound angles and the data regarding the inbound angles include information used to calculate a distance from the system to the target via triangulation, and where the distance between light source aperture and the image capture aperture is relatively fixed.

Such systems where the directed light source is a laser, where the laser is at least one of, amplitude modulated and pulse width modulated. Such systems where the image senor includes optical filters. Such systems where the data regarding the outbound angles and the data regarding the inbound angles further include information used to calculate a depth map based on the illumination. Such systems where the data regarding the outbound angles and the data regarding the inbound angles further include information used to calculate a point cloud based on the depth map.

Another example method includes a method for target illumination and mapping. Such a method including, via a directed light source, having an aperture, illuminating a target area within a field of view, via an incremental scan, where each increment has a unique outbound angle from the light source aperture, and a unique inbound angle to the image sensor aperture, sending data regarding the incremental outbound angles to the processor, and via an image sensor, having an aperture, receiving reflected illumination from the at least one select target within the field of view, generating data regarding the received reflected illumination including inbound angles, and sending the data regarding the received reflected illumination to the processor, where the data regarding the outbound angles and the data regarding the inbound angles include information used to calculate a distance from the system to the target via triangulation, and where the distance between light source aperture and the image capture aperture is relatively fixed.

Methods here where the directed light source is a laser, where the laser is at least one of, amplitude modulated and pulse width modulated. Methods here where the image senor includes optical filters. Methods here where the data regarding the outbound angles and the data regarding the inbound angles further include information used to calculate a depth map based on the illumination. Methods here where the data regarding the outbound angles and the data regarding the inbound angles further include information used to calculate a point cloud based on the depth map.

### BRIEF DESCRIPTION OF THE DRAWINGS

For a better understanding of the embodiments described in this application, reference should be made to the Detailed Description below, in conjunction with the following drawings in which like reference numerals refer to corresponding parts throughout the figures.

FIG. 1 is a perspective view of components consistent with certain aspects related to the innovations herein.

FIGS. 2A-2B show an example monolithic array and projection lens, front side and perspective view consistent with certain aspects related to the innovations herein.

FIGS. 3A-3B are a front, top, side, and perspective views showing an example array consistent with certain aspects related to the innovations herein.

FIGS. 4A-4B are a front, top, side, and perspective views show an example array with a flexible PCB consistent with certain aspects related to the innovations herein.

FIG. 5 is an illustration of an example full/flood array illuminated target area consistent with certain aspects related to the innovations herein.

FIGS. 6A-6E are a perspective view and sequence illustrations of example array column illuminations consistent with certain aspects related to the innovations herein.

FIGS. 7A-7E are a perspective view and sequence illustrations of example sub-array illuminations consistent with certain aspects related to the innovations herein.

FIGS. 8A-8E are a perspective view and sequence illustrations of example single array element illuminations consistent with certain aspects related to the innovations herein.

FIG. 9 is a perspective view of example system components of certain directional illumination embodiments herein.

FIGS. 10A-10D show example views of various possible scanning mechanism designs consistent with certain aspects related to the innovations herein.

FIG. 11 is a depiction of a target area illuminated by an example directional scanning illumination consistent with certain aspects related to the innovations herein.

FIG. 12 depicts an example embodiment of a 2-axis MEMS consistent with certain aspects related to the innovations herein.

FIG. 13 depicts an example embodiment of a 2 single-axis MEMS configuration according to certain embodiments herein.

FIG. 14 depicts an example embodiment including a single rotating polygon and a single axis mirror consistent with certain aspects related to the innovations herein.

FIG. 15 depicts an example embodiment including dual polygons consistent with certain aspects related to the innovations herein.

FIG. 16 is a depiction of an example full target illumination consistent with certain aspects related to the innovations herein.

FIG. 17 is an illustration of an illumination utilized to create a subject outline consistent with certain aspects related to the innovations herein.

FIG. 18 is an illustration of illumination of a sub-set of the subject, consistent with certain aspects related to the innovations herein.

FIG. 19 is an illustration of illumination of multiple sub-sets of the subject, consistent with certain aspects related to the innovations herein.

FIG. 20 depicts an example skeletal tracking of a target consistent with certain aspects related to the innovations herein.

FIG. 21 depicts an example projection of a pattern onto a target area consistent with certain aspects related to the innovations herein.

FIG. 22 is a flow chart depicting target illumination and image recognition consistent with certain aspects related to the innovations herein.

FIG. 23 illustrates system components and their interaction with both ambient full spectrum light and directed NIR consistent with certain aspects related to the innovations herein.

FIG. 24 is a perspective view of an example video imaging sensing assembly consistent with certain aspects related to the innovations herein.

FIG. 25 is an associated graph of light transmission through a certain example filter consistent with certain aspects related to the innovations herein.

FIG. 26A is a perspective view of the video imaging sensing assembly of the present invention illustrating one combined notch and narrow band optical filter utilizing two elements consistent with certain aspects related to the innovations herein.

FIG. 26B is an associated graph of light transmission through certain example filters of certain embodiments herein.

FIG. 27A is a perspective view of an example video imaging sensing assembly illustrating three narrow band filters of different frequencies consistent with certain aspects related to the innovations herein.

FIG. 27B is an associated graph of light transmission through certain example filters consistent with certain aspects related to the innovations herein.

FIG. 28 is a perspective view of triangulation embodiment components consistent with certain aspects related to the innovations herein.

FIG. 29 is a depiction of block areas of a subject as selected by the user or recognition software consistent with certain aspects related to the innovations herein.

FIG. 30 is a depiction of a single spot map as determined by the user or recognition software consistent with certain aspects related to the innovations herein.

FIG. 31 depicts an example embodiment showing superimposed distance measurements in mm as related to certain embodiments herein.

FIG. 32 depicts an example multiple spot map as determined by the user or recognition software consistent with certain aspects related to the innovations herein.

FIG. 33 depicts an example embodiment showing superimposed distance in mm and table as related to certain embodiments herein.

FIG. 34 depicts an example embodiment showing axial alignment of the components of directed light source and the image sensor consistent with certain aspects related to the innovations herein.

FIG. 35 shows an example embodiment with a configuration including axial alignment and no angular component to the light source consistent with certain aspects related to the innovations herein.

FIG. 36 shows an example embodiment with a configuration including axial alignment and an angular component to the light source consistent with certain aspects related to the innovations herein.

FIG. 37A-37C depict an example embodiment showing a top, side, and axial views of configurations consistent with certain aspects related to the innovations herein.

FIG. 38A-38C depict an example embodiment of a top, side, and axial views of a configuration according to certain embodiments herein with a horizontal and vertical offset between the image sensor and the illumination device.

FIG. 39 depicts an example embodiment configuration including axial alignment and an angular component to the light source with an offset in the Z axis between the image sensor and the illumination device consistent with certain aspects related to the innovations herein.

FIG. 40 depicts an example embodiment of a process flow and screenshots consistent with certain aspects related to the innovations herein.

FIG. 41 depicts an example embodiment including light interacting with an image sensor consistent with certain aspects related to the innovations herein.

FIG. 42 depicts an example embodiment of image spots overlaid on a monochrome pixel map of a sensor consistent with certain aspects related to the innovations herein.

FIG. 43 shows an example perspective view of an example of illumination being directed onto a human forehead for biometrics purposes consistent with certain aspects related to the innovations herein.

FIG. 44A shows an example embodiment of sequential triangulation and a perspective view including one line of sequential illumination being directed into a room with a human figure consistent with certain aspects related to the innovations herein.

FIG. 44B shows an example embodiment of sequential triangulation and a perspective view including select pixels consistent with certain aspects related to the innovations herein.

FIG. 45 shows an example embodiment a human subject with a projected image consistent with certain aspects related to the innovations herein.

FIG. 46A is an example embodiment showing a human subject with a projected illumination incorporating safety eye blocking consistent with certain aspects related to the innovations herein.

FIG. 46B is another example embodiment showing a human subject with a projected illumination incorporating safety eye blocking consistent with certain aspects related to the innovations herein.

FIG. 47A is a detailed illustration of a human eye and the small output window of the illumination device.

FIG. 47B is a human eye pupil relative to the small illumination device output window.

FIG. 47C is a detailed illustration of a human eye and the large output window of the illumination device.

FIG. 47D is a human eye pupil relative to the large illumination device output window.

FIG. 48A is an example embodiment showing a chart assigning color values to shades of gray consistent with certain aspects related to the innovations herein.

FIG. 48B shows an example perspective view of certain embodiments herein including illumination directed onto a human figure after color enhancement consistent with certain aspects related to the innovations herein.

FIG. 49A is an example graph showing a square wave formed by different systems consistent with certain aspects related to the innovations herein.

FIG. 49B is an example perspective view illustrating one line of a propagated square wave consistent with certain aspects related to the innovations herein.

FIG. 50A is an example perspective view of the throw angle effect on projected patterns consistent with certain aspects related to the innovations herein.

FIG. 50B is an example perspective view showing calibrated projected patterns to compensate for distance consistent with certain aspects related to the innovations herein.

FIG. 50C is an example perspective with of oriented calibration based on object shape consistent with certain aspects related to the innovations herein.

FIG. 51 is an example table of projected pattern methodologies consistent with certain aspects related to the innovations herein.

FIG. 52A is a perspective view of an example of an adjacent configuration consistent with certain aspects related to the innovations herein.

FIG. 52B is a perspective view of an example system consistent with certain aspects related to the innovations herein.

FIG. 52C is a perspective view of an example of an objective configuration consistent with certain aspects related to the innovations herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the inventions to these particular embodiments. In other instances, well-known data structures, timing protocols, software operations, procedures, and components have not been described in detail so as not to unnecessarily obscure aspects of the embodiments of the invention.

### Overview

Enhanced software and hardware control of light sources has led to vast possibilities when it comes to gesture recognition, depth-of-field measurement, image/object tracking, three dimensional imaging, among other things. The embodiments here may work with such software and/or systems to illuminate targets, capture image information of the illuminated targets, and analyze that information for use in any number of operational situations. Additionally, certain embodiments may be used to measure distances to objects and/or targets in order to aid in mapping of three dimensional space, create depth of field maps and/or point clouds.

Object or gesture recognition is useful in many technologies today. Such technology can allow for system/software control using human gestures instead of keyboard or voice control. The technology may also be used to map physical spaces and analyze movement of physical objects. To do so, certain embodiments may use an illumination coupled with a camera or image sensor in various configurations to map the target area. The illumination could be sourced any number of ways including but not limited to arrays of Light Emitting Diodes (LEDs) or directional scanning laser light.

In some instances light in the visible spectrum may not be optimal at a level necessary or augmenting with visible light may not be desirable at a level necessary for image sensors to adequately detect; therefore the use of infrared/near infrared (IR/NIR) may be used in such systems.

There are numerous infrared/near infrared (IR/NIR) illumination systems on the market which produce non-directed flood type illumination. However, providing a directed source of illumination may require a dynamic connection between the recognition software/hardware and the source of illumination. Issues of human eye safety also place constraints on the total amount of IR/NIR illumination that can safely be used.

Direction and eye safety may be achieved, depending on the configuration of the system, by utilizing an addressable array of emitting devices or using a scanning mechanism, while minimizing illumination to non-targeted areas, thus reducing the overall energy required as compared with flood illumination. The system may also be used to calculate the amount of illumination required, the total output power, and help determine the duration of each cycle of illumination. The system may then compare the illumination requirements to any number of maximum eye safe levels in order to adjust any of the parameters for safety. This may also result in directing the light on certain areas to improve illumination in those, while minimizing other areas.

Various optics, filters, durations, intensities and polarizations could also be used to modify the light used to illuminate the objects in order to obtain additional illuminated object data. The image capture could be through any of various cameras and image sensors. Various filters, lenses and focus features could be used to capture the illuminated object data and send it to computing hardware and/or software for manipulation and analysis.

In certain examples, using an array of illumination sources, individual illumination elements may be grouped into columns or blocks to simplify the processing by the computers. In a directional illumination embodiment, targeted areas could be thus illuminated. Other examples, using directional illumination sources, could be used to project pixels of light onto a target area.

Such example segments/areas may each be illuminated for an approximately equal fraction of frame rate such that an image capture device, such as a Complementary Metal Oxide Semiconductor (CMOS) camera may view and interpret the illumination as homogeneous illumination for the duration of one frame or refresh.

The illumination and image capture should be properly timed to ensure that the targeted areas are illuminated during the time that the image capture device collects data. Thus, the illumination source(s) and the image capture should synchronize in order to ensure proper data capture. If the image capture and illumination are out of synch, the system will have a hard time deciphering if the target object has moved, or if the illumination merely missed the target.

Further, distance calculations derived from using the illumination and capture systems described herein may add to the information that the system may use to calculate and map three dimensional space. This may be accomplished, in certain embodiments, using triangulation measurements among the illumination source, the image capture device(s) and the illuminated object(s).

Thus, certain example systems may include certain components, including combinations of, an illumination source such as an addressable array of semiconductor light emitting devices or directional sources using lasers, some kind of projection optics or mechanical structure for spreading the light if an array of sources, an image capture devices, such as a CMOS, Charge Couple Device (CCD) or other imaging device which may incorporate a short band pass filter allowing visible and specific IR/NIR in certain embodiments, computing devices such as a microprocessor(s) which may be used in conjunction with computing instructions to control the array or directional illumination source, database(s) and/or data storage to store data information as it is collected, object and/or gesture recognition instructions to interpret and analyze the captured image information. Recognition instructions/software could be used to help analyze any captured images in order to do any number of things including to identify the subject requiring directed illumination to send commands to the microprocessor controlling the array identifying only the necessary elements to energize as to direct illumination on the target, thereby creating the highest possible level of eye safe illumination on the target.

In some example embodiments, for safety, the system may utilize object tracking technology such as recognition software, to locate a person's eyes who may be in the target field, and block the light from a certain area around them for eye safety. Such an example may keep emitted light from a person's eyes, and allow the system to raise the light intensity in other areas of illumination, while keeping the raised intensity light away from the eyes of a user or person within the system's range.

### Detailed Examples

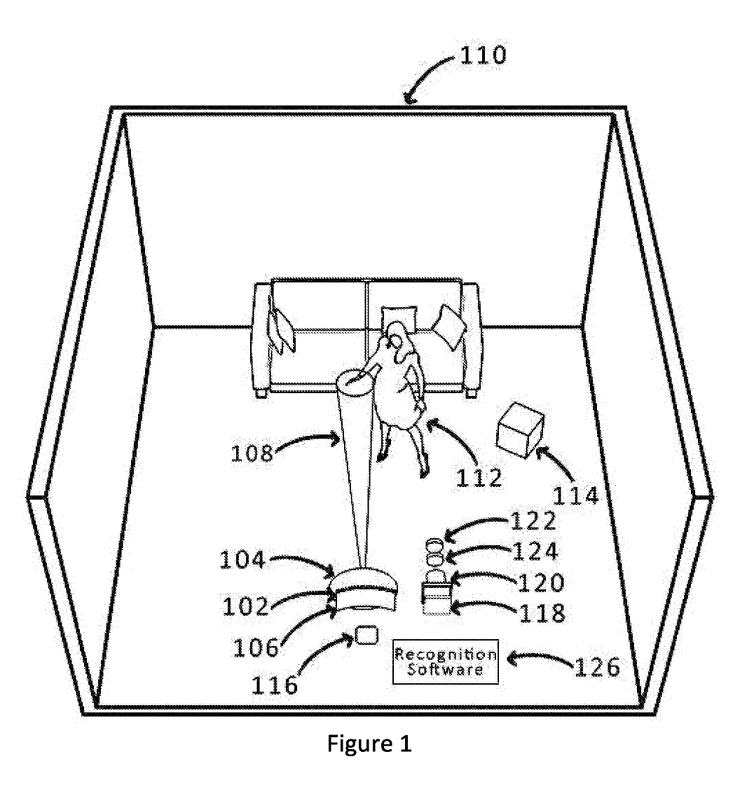

A preferred embodiment of the present invention will be described with reference to FIGS. 1 to 52C.

### Array of Illumination Sources

As described above, the illumination of the target field may be accomplished a number of ways. One such way is through an array of illumination sources such as LEDs. FIG. 1 illustrates an example system utilizing such illumination sources. To illuminate a target or target area, the illumination source may be timed in accordance with the image capture device's frame duration and rate. In this way, during one open frame time of the image capture device/camera, which can be any amount of time but is often 1/30th, 1/60th or 1/120th of a second, the illumination source may illuminate the target and/or target area. These illumination sources can operate a number of ways during that one frame time, including, turning on all elements, or a select number of elements, all with the same power level or intensity, and for the entire frame duration. Other examples include turning the illumination sources on all at the same intensity or power, but change the length of time each is on, within the frame time. Still other examples include changing the power or intensity of illumination sources, but keep all with the same length of time to be on, and yet another is changing both the power and time the illumination sources are on.

As will be discussed in more detail below, the effective output power for the array may be measured over time to help calculate safe levels of exposure, for example, to the human eye. Thus, an eye safety limits may be calculated by dividing output power over time. This output power would be affected by the variations in illumination time and intensity disclosed above.

In FIG. 1, the illumination device 102, is arranged as an array 102 utilizing diverging projection optics 104, housed on a physical mechanical structure 106. The array of illumination sources, arranged to generate directed illumination 108 on a particular target area 110, shown in this example as a human form 112 and an object 114 but could be any number of things. The illumination device 102 in FIG. 1, is connected to a computer system including an example microprocessor 116, as well as the image capture system shown here as a video imaging camera 118, lens tube 120, camera lens 122, and camera filter 124. The system is also shown in communication with a computer system including object recognition software or instructions 126 that can enable the system to direct and/or to control the illumination in any number of ways described herein.

In this example, the array 102 is shown connected to a computing system including a microprocessor 116 which can individually address and drive the different semiconductor light emitting devices 102 through an electronic control system. The example microprocessor 116 may be in communication with a memory or data storage (not pictured) for storing predefined and/or user generated command sequences. The computing system is further shown with an abstract of recognition software 126, which can enable the software to control the directed illumination. In the example drawing, these objects are shown in exploded and/or exaggerated forms, whereas in practice they may take any number of shapes and configurations. Here, they are shown as sometimes separate and symbolic icons.

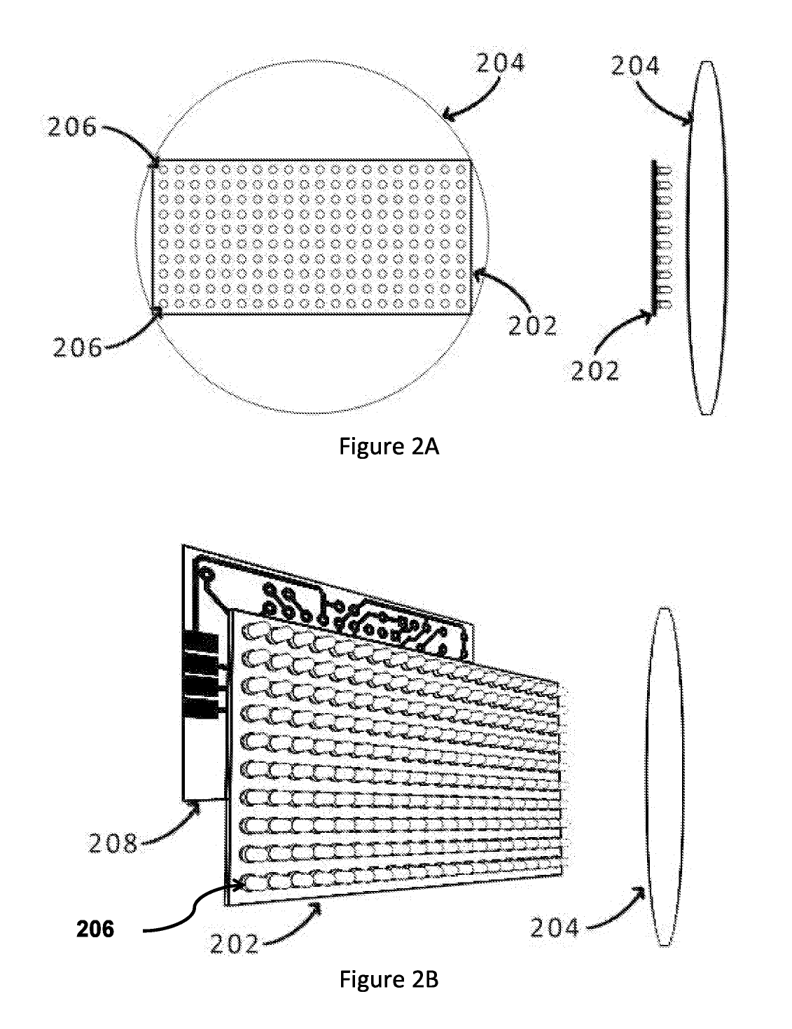

As depicted in the example shown in FIG. 2A, the illumination device 202 may comprise a monolithic array of semiconductor light emitting devices 206, projection optics 204, such as a lens, arranged in between the array 202 and semiconductor light emitting devices 206 and the target area. The array 202 may be any number of things including but not limited to, separate Light Emitting Diodes (LEDs), Edge Emitting Lasers (EELs), Vertical Cavity Surface Emitting Lasers (VCSELs) or other types of semiconductor light emitting devices.

In the example shown in FIG. 2B, the monolithic array 202 is arranged on a printed circuit board (PCB) 208, along with associated driving electronics. The semiconductor light emitting devices 206 are uniformly distributed over the area of the array 202 thereby forming a matrix. Any kind of arrangement of light sources could be used, in order to allow for the light to be projected and directed toward the target area.

The number of semiconductor light emitting devices 206 used may vary. For example, an array provided with 10×20 array LEDs, for example, may result in proper directed illumination for a particular target area. For standalone devices, a PCB array of discrete semiconductor light emitting devices such as LEDs may suffice such as, for example, an auxiliary system for a laptop or television.

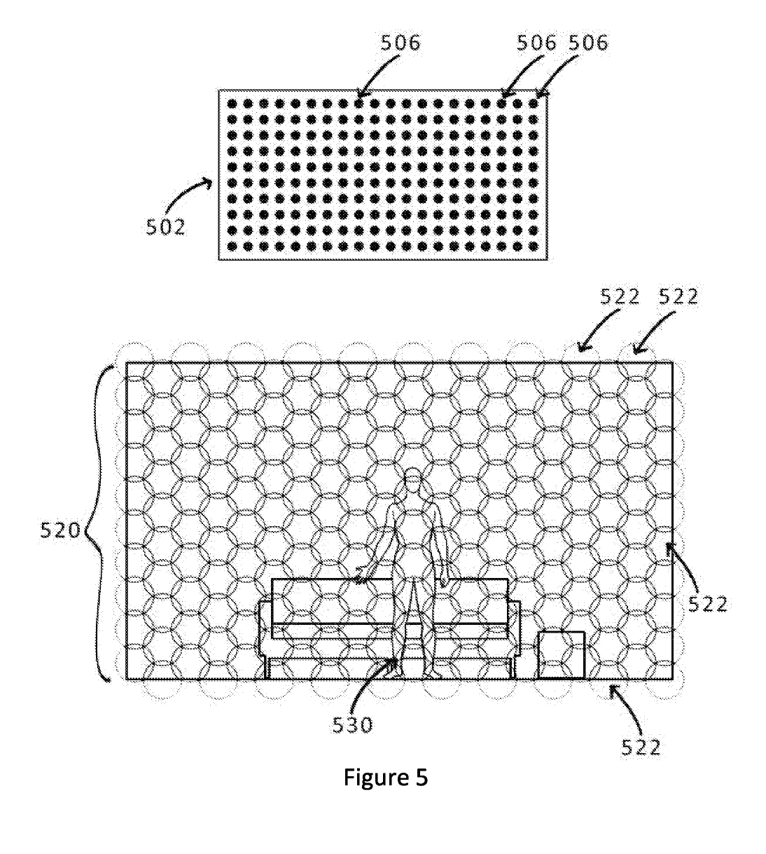

In one example embodiment herein, the semiconductor light emitting devices 206 are either physically offset or the alignment of alternating columns is offset such that it creates a partially overlapping pattern of illumination. This partially overlapping pattern is described below, for example later in FIG. 5.

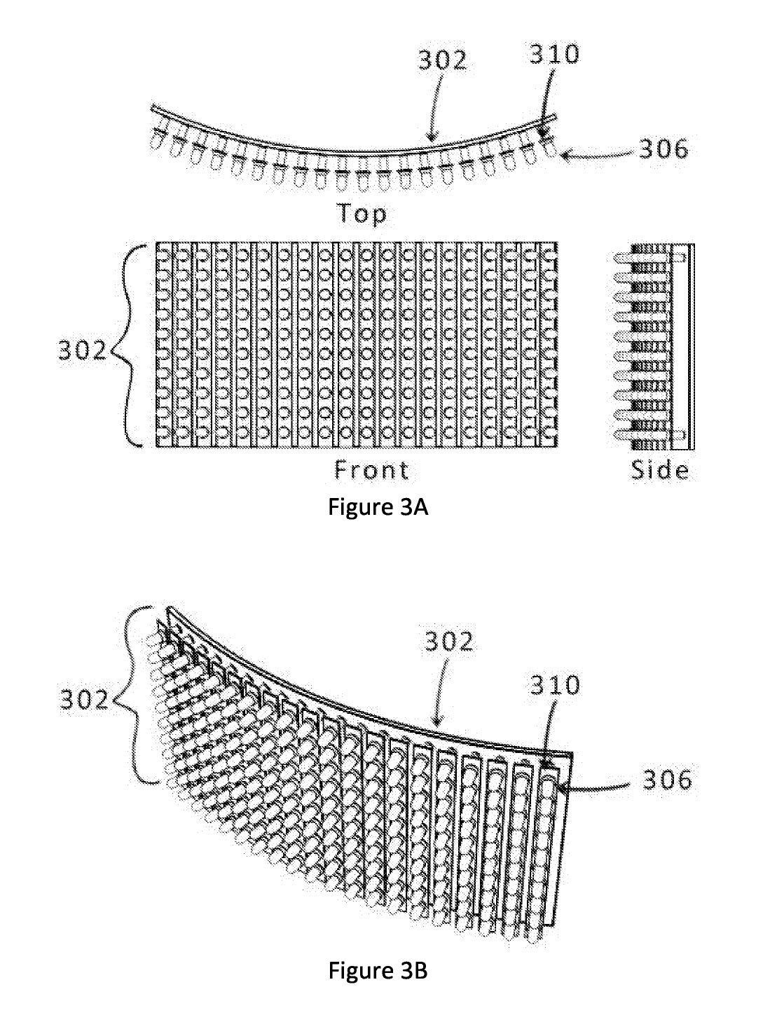

As depicted in FIG. 3A, the illumination device 306 may include an array of semiconductor light emitting devices 306, mechanical structure 302, or a frame work with a defined curvature onto which PCBs are mounted which are one or more semiconductor light emitting devices 306 X-wide by Y-tall, arranged with a defined angle of curvature attached to a physical frame. The sub-array PCBs 310 may comprise a sub-array of semiconductor light emitting devices 306 X-wide by Y-tall, hereinafter referred to as sub-array. Each sub-array may include any number of illumination sources including but not limited to, separate LEDs, EELs, VCSELs or other types of semiconductor light emitting devices. The array 302 with sub-array PCBs 310 may include associated driving electronics. The semiconductor light emitting devices 306 may be uniformly distributed over the area of the array 302 sub-array PCBs 310 thereby forming a matrix. The number of semiconductor light emitting devices 306 used in the matrix may vary and the determination may be predefined, or defined by the user or the software. An illumination device for example, may include 10×20 array LEDs for directed illumination. For standalone devices, a PCB sub-array of discrete semiconductor light emitting devices such as LEDs may be used for an auxiliary system for a laptop or television. In some embodiments, the array 302 could be constructed of monolithic sub-arrays, single chip device having all of the semiconductor light emitting devices on a single chip. FIG. 3B shows a perspective view of a curved array from FIG. 3A.

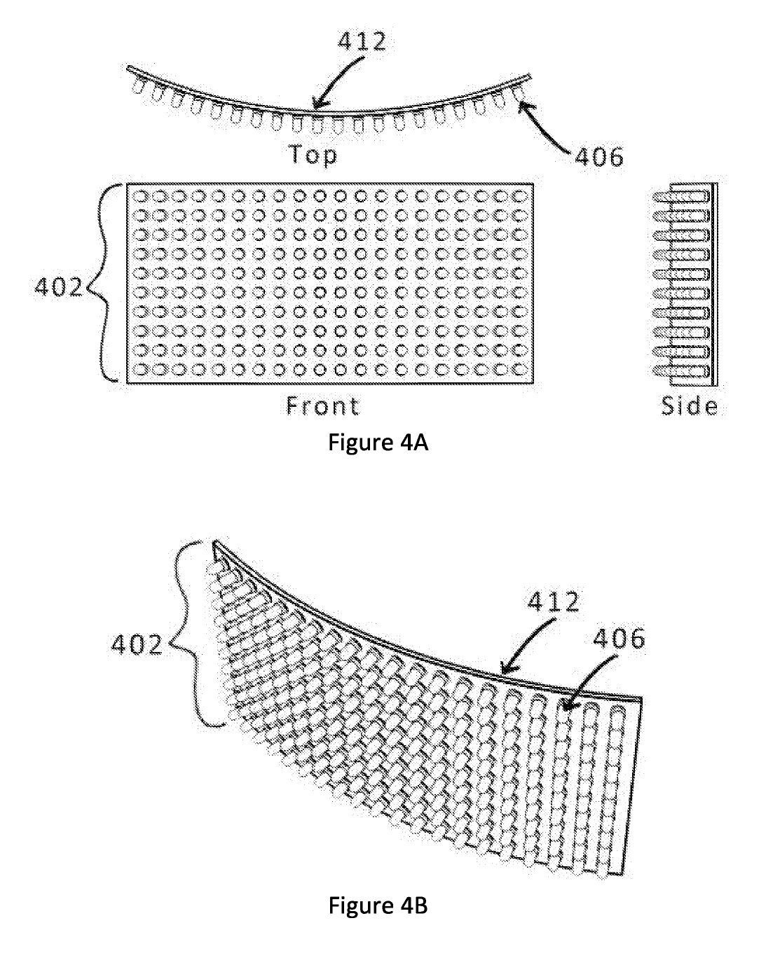

As depicted in FIG. 4A, the illumination device 402 may include an array of semiconductor light emitting devices 406, a flexible PCB 412 arranged with a defined angle of curvature which may be attached to a physical frame, including associated driving electronics. The semiconductor light emitting devices 406 may be uniformly distributed over the area of the array 402 thereby forming a matrix. The number of semiconductor light emitting devices 406 used in the matrix may vary and the determination may be predefined, or defined by the user or the software. For example, an illumination device provided with 10×20 array LEDs may provide sufficient directed illumination for a particular application. For standalone devices, such as an auxiliary system for a laptop or television, a flexible PCB made up of discrete semiconductor light emitting devices such as LEDs would suffice. FIG. 4B shows another example view of the curved array from FIG. 4A.

FIG. 5 depicts an illustration of an example array 502 and what a target area 520 that could be energized and/or illuminated by the array 502 may look like. In the figure, each example circle 522 depicts the coverage area of one of the light emitting devices or illumination sources 506. As can be seen from the example, the coverage of each light emitting device 522 may overlap with the adjacent coverage 522, depending on the width of the light emitting device beam and the distance of the target object 530 from the array 502. As will be described in detail below, any arrangement of single illumination devices could be used in any combination. The example in FIG. 5 shows all of the devices on at once.

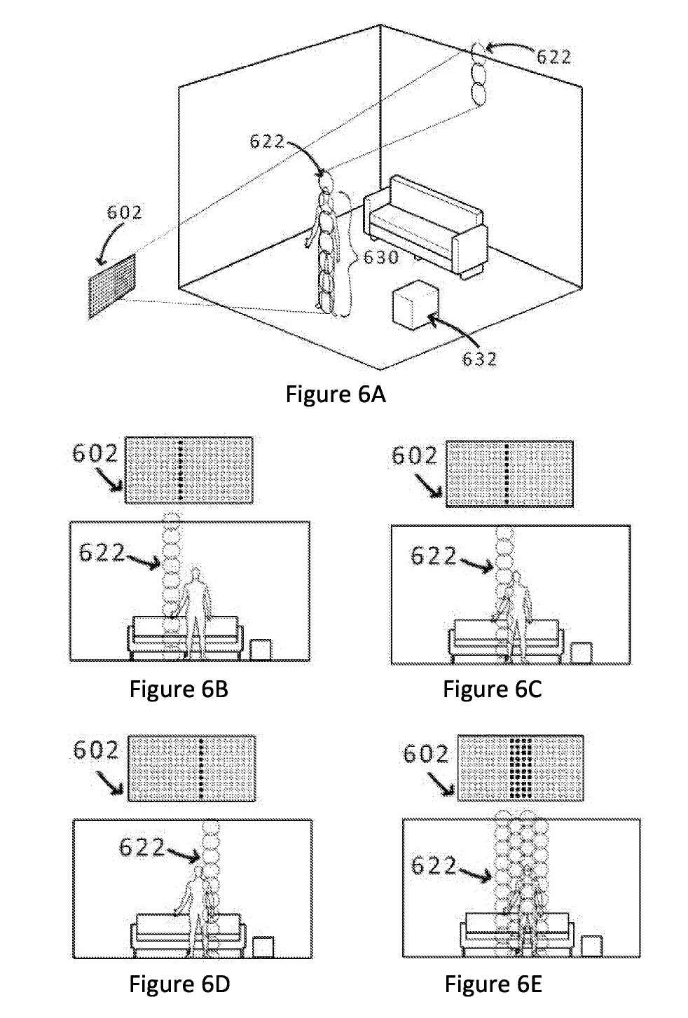

FIG. 6A depicts an example of the system illuminating a target area and a human 630. The system could also be used to target anything else in the target area, such as, an object 632. The example array 602 is shown in this example, showing one example column of light sources and their respective light beam coverage circles 622. Using an example column defined as one element or light source wide by X elements tall, in this example 1X10 but the number of elements can vary, the system is used to illuminate specific targets.

In certain embodiments, only certain precise areas of the overall target area require illumination. The system could first identify those precise areas within the overall target area using object recognition, and then illuminate those precise area or areas to highlight for additional granularity. Thus, using coordinates of a precise area which requires specific illumination, the system may provide those coordinates to the computing system including the microprocessor which in turn may calculate the correct precise area elements to illuminate and/or energize. The system could also decipher safety parameters such as the safe duration of that illumination during one cycle.

For example, the coordinate calculation could be, in an example where Columns=4, one column P=F/4 where P is the length of time an element or block of elements are energized during a cycle and F is the duration of one cycle.

The system could be used to sequentially illuminate a given example area. FIGS. 6B and 6C depict the first and the second illuminated columns in an example sequence, where the light emitting array 602 is shown with a particular column in dark, corresponding to a light coverage 622 on the target area. FIG. 6B shows an example where one column is lit, of four, 6C is two of four, etc. FIG. 6D depicts the last column of the sequence to be illuminated, which is four of four in the example sequence shown here. Thus, the system's sequential illumination is shown in parts.

FIG. 6E depicts what the camera would see in an example duration of one cycle corresponding to the amount of time of one capture frame. In this example, that is columns one through four, with the light coverage circles 622 now overlapping. In other words, in this example, the illumination source could flip through multiple iterations of illuminating a target, within the time of one camera or image capture device shutter frame. Thus, to the image capture device, the multiple and sequential illumination cycles show up in one frame of image capture, and to the image capture device, appear as if they are all illuminated at once. Any number of configurations, illumination patterns and timing could be used, depending on the situation.

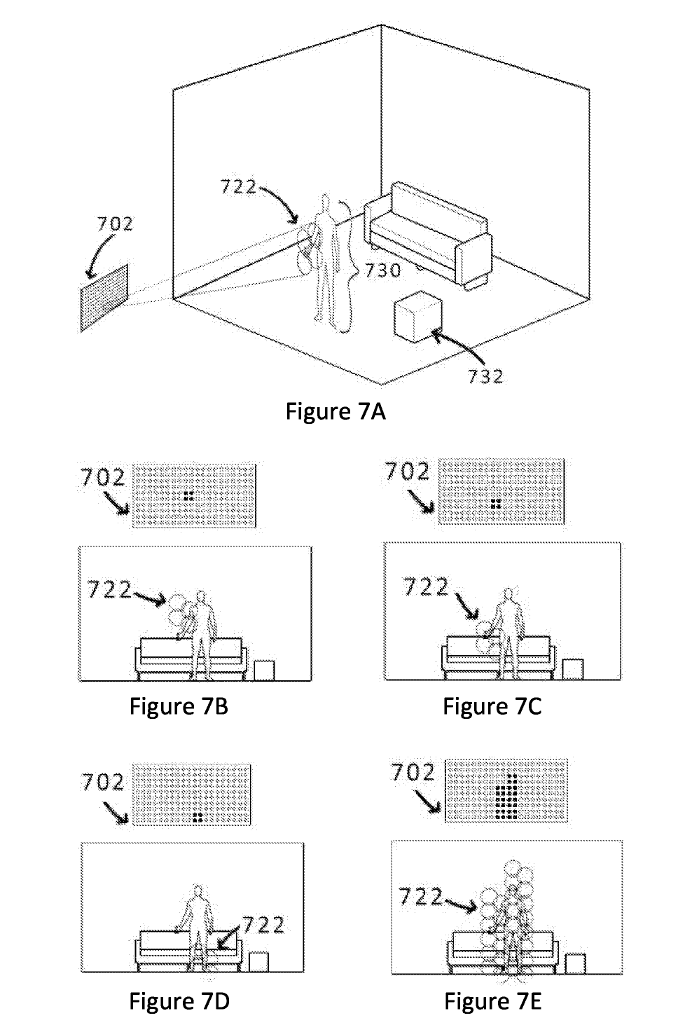

FIG. 7A depicts another example of system's ability to illuminate different target areas for capture and recognition. In this example, the goal is to recognize and identify an example target 730 but could be anything, such as an object, 732. This example uses blocks of elements projecting their respective beams of illumination 722 defined as Y number of elements wide by X elements tall (in this example 2X2 but the number of elements can vary). This is different than the columns shown in FIGS. 6A-6E. In the examples of FIGS. 7A-7E, the system may be used to identify the coordinates of the area which requires illumination and provides that to the microprocessor which in turn may calculate the correct elements to energize and the safe duration of that illumination during one cycle.

In one such example calculation, the number of Blocks=7. Therefore for one block P=F/7.

FIGS. 7B and 7C depict the first and the second illuminated blocks in the example sequence. 7B is one of seven, 7C is two of seven. FIG. 7D depicts the last block of the sequence to be illuminated, which is seven of seven.

FIG. 7E depicts what the camera may see illuminated within the duration of one example frame, which is blocks one through seven and all of the illumination circles 722 now overlapping. As described in FIG. 6E, FIG. 7E is the culmination of multiple illuminations, all illuminated at some time during one frame of the image capture device.

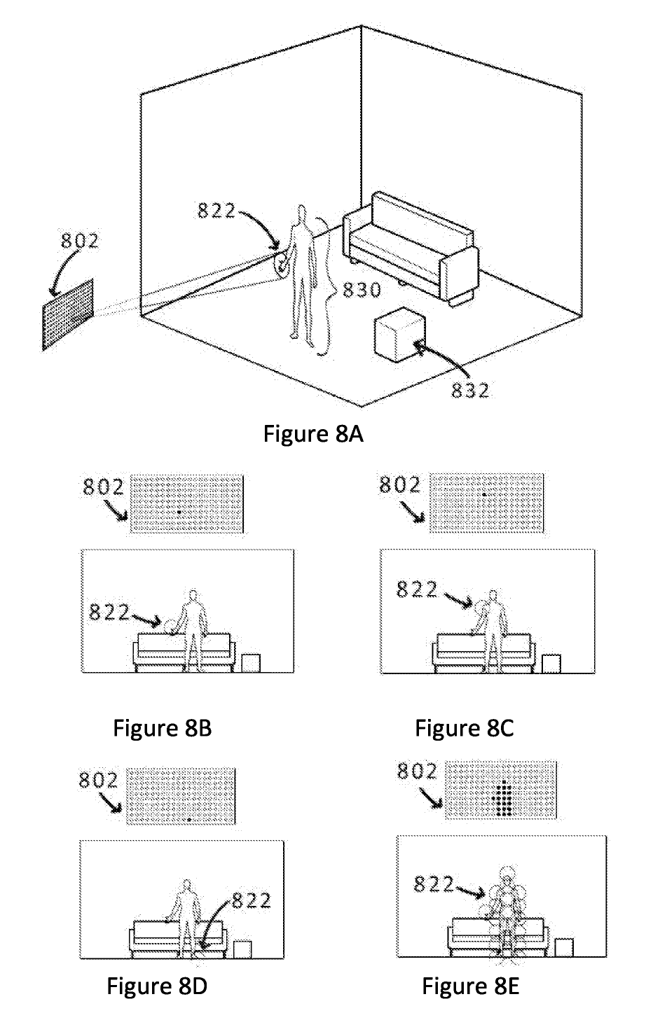

FIG. 8A depicts an example of the system identifying targets such as a human 830 but could be anything such as an object, 832 within a target area. This example uses individual illumination sources or elements, which allow the image capture devices and computer/software to identify the coordinates of the area which may require specific illumination. Thus, the system can then calculate the specific target elements to illuminate and/or energize for greater granularity, or safety measures.

In this example, the calculation may include where Elements=20. Therefore for one element P=F/20.

FIGS. 8B and 8C depict examples of the first and the second illuminated elements in the example sequence. 8B is one of twenty, 8C is two of twenty. FIG. 8D depicts the last element of the sequence to be illuminated, which is twenty of twenty.

FIG. 8E depicts what the camera or image capture device may see in duration of one frame. In this way, the illumination sources have illuminated one through twenty, now with illumination circles 822, all overlapping the adjacent one, and the image capture device detects all of the illumination within one frame.

### Eye Safety for Array Embodiments

Example embodiments here may be configured to determine certain operational statistics. Such statistics may include measuring the amount, intensity and/or power the system puts out. This can be used, for example, to ensure that safety limits are met, such as eye safety limits for projection of IR/NIR. The system may utilizes information provided by the illumination source and image sensors to determine the correct duration of each element during one cycle, period between refresh or time length of one frame.

E=number of semiconductor light emitting devices to be energized
F=duration of one cycle
F/E=P the length of time one element or block of elements is energized during a cycle

Further, the system may verify the eye safe limits of each cycle. Each semiconductor light emitting device may be assigned a value corresponding to the eye safe limits determined for the array and associated optics. As the variables which determine eye safe limits vary greatly depending upon the size of the external aperture, wavelength of light, mode, coherence, and duration, the specific criteria will be established matching the specifications of the final design, establishing a Lmax-maximum eyesight level per cycle. If

E×P>Lmax

The system will reduce P until E×P<Lmax

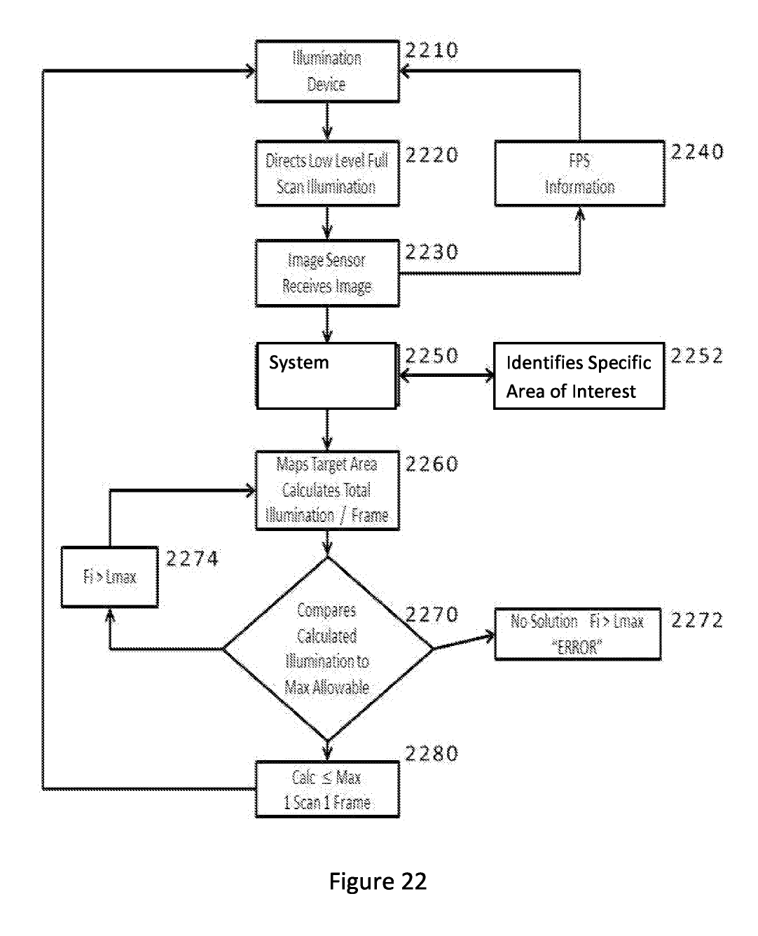

If no allowable solution exists for E×P<Lmax then the system may shift into a fail safe mode which may prevent any element of the array from energizing and return an error message to the recognition software. The process flow is described later in this disclosure in FIG. 22.

### Scanning Directional Illumination Source

In certain example embodiments, a directional illumination may be used. In such examples, the target area and subsequent targeted subject areas may be illuminated using a scanning process or a process that uses a fixed array of Micro Electrical Mechanical Systems (“MEMS”) mirrors. Any kind of example laser direction control could be used, and more examples are discussed below. Additionally, any resolution of directional scan could be used, depending on the ability to pulse the illumination source, laser for example, and the direction control system to move the laser beam. In certain examples, the laser may be pulsed, and the MEMS may be moved, directing each separate pulse, so that separate pixels are able to be illuminated on a target area, during the time it takes the camera or image capture system to open for one frame. More granularity/resolution could be achieved if the laser could be pulsed faster and/or the directional control could move faster. Any combination of these could add to the number of pixels that could be illuminated during one frame time.

Regarding the scanning pattern for the light illumination source, many options could be utilized, including but not limited to raster, interlaced, de-interlaced progressive or other methods. The illumination projection device may have, for example, the ability to control the intensity of each pixel, by controlling the output power or light intensity for each pulse. The intensity of each pulse can be controlled by the amount of electrical current being applied to the semiconductor light emitting device, or by sub dividing the pulse into smaller increments and controlling the number of sub-pulses on during one pulse, or in the case of an array of MEMs controlling the duration of the pulse where the light is directed to the output, for example.

Scanned light may be precisely directed on a targeted area to minimize illumination to non-targeted areas. This may reduce the overall energy required to conduct proper image capture, as compared with the level of flood illumination required to achieve the same level of illumination on a particular target. Instructions and/or software may be used to help calculate the amount of illumination required for an image capture, the output power of each pulse of illumination to achieve that, the number of pulses per scanning sequence, and help determine the total optical output of each frame of illumination.

The system may specifically direct illumination to both stationary and in-motion objects and targets such as humans. Thus, the first frame and every X frames as directed by the recognition software or default setting within the microprocessor, the system may perform a complete illumination of the entire target area, thus allowing the recognition software to check for new objects or changes in the subject(s) being targeted. In some embodiments, a light-shaping diffuser can be arranged between the semiconductor light emitting device(s) and the projection optics, to create blurred images of the pulses. Blurring may reduce the dark or un-illuminated transitions between the projected pixels of illumination. Utilization of a diffuser may have the effect of improving eye safe output thus allowing for increased levels of illumination emitted by the device.

According to certain embodiments, the device can produce dots or targets of illumination at key points on the subject for the purpose of calculating distance or providing reference marks for collection of other information. Distance calculations are disclosed in more detail below.

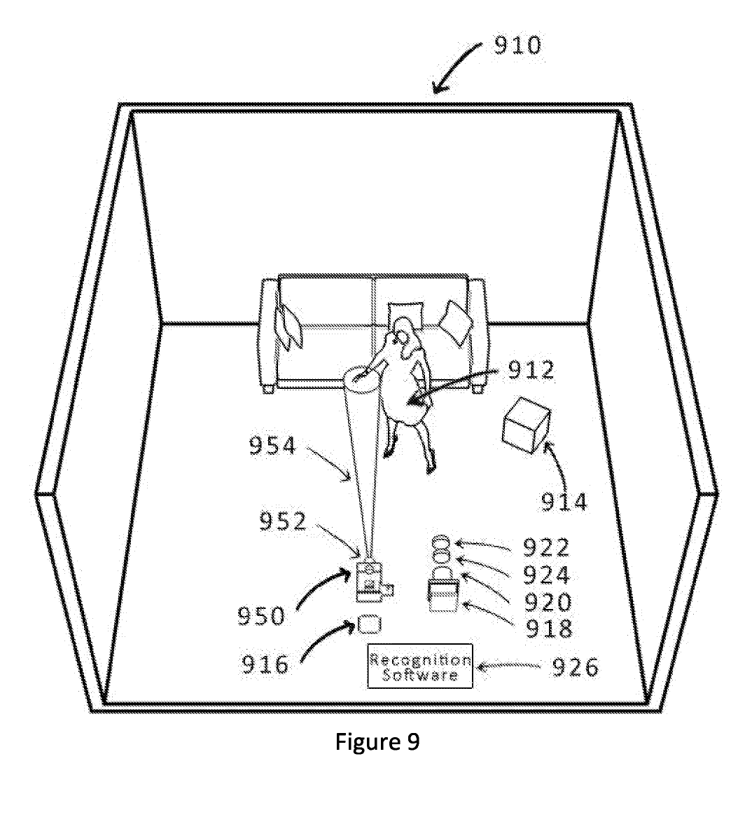

FIG. 9 illustrates an example illumination device 950, utilizing diverging projection optics 952, to generate directed illumination 954 on a target area 910, as identified in this example as human form 912 and object 914. The illumination device 950 in this example is connected to a microprocessor 916, a video imaging sensor 918, lens tube 920, camera lens 924, camera filter 922, object recognition software 926, enabling the recognition software to control the illumination. In the example drawing, these objects are shown in exaggerated and/or exploded forms, whereas in practice they may take any number of shapes and configurations. Here, they are shown as sometimes separate and symbolic icons.

The illumination device 950 may be configured to be in communication with and/or connected to a computing device such as a microprocessor 916 which can control the scanning mechanism and the semiconductor light emitting device 950. The microprocessor 916, which may be equipped with and/or in communication with memory or storage for storing predefined and/or user generated command sequences. Further, the computing system may receive instructions from recognition software 926, thereby enabling the system to control the directed illumination.

In some embodiments, FIG. 9 also illustrates example embodiments based on an embodiment where a single image sensor 918 is utilized to obtain both red, green, blue (“RGB”) and NIR data for enhancing the ability of machine vision and recognition software 926. This may require the utilization of a band pass filter 924 to allow for RGB imaging and a narrow band filter 922 closely matched to the wavelength of a NIR light source 954 used for augmenting the illumination. The optical filtration can be accomplished by single or multiple element filters. The NIR light source 954 can be from light emitting devices such as, for example but not limited to, LEDs, EEL, VCSELs, DPL, or other semiconductor-based light sources. The way of directing the light onto the subject area 912 can be via many sources including a MEMS device 950 such as a dual axis or eye MEMS mirror, two single axis MEMS mirrors working in conjunction, a multiple MEMS mirror array, or a liquid crystal array, as examples. Other reflective devices could also be used to accurately point a directed light source, such as a laser beam. In the example drawing, these objects are shown in exaggerated forms, whereas in practice they may take any number of shapes and configurations. Here, they are shown as sometimes separate and symbolic icons.

In certain example embodiments, a light shaping diffuser (not pictured), can be arranged somewhere after the illumination device 950 and the projection optics 952 to create a blurred projected pixel. The light shaping diffuser may create a blurred projection of the light and a more homogenous overlap of illumination. The light shaping diffuser also has the added effect of allowing for increased levels of illumination while remaining within eye safe limits.

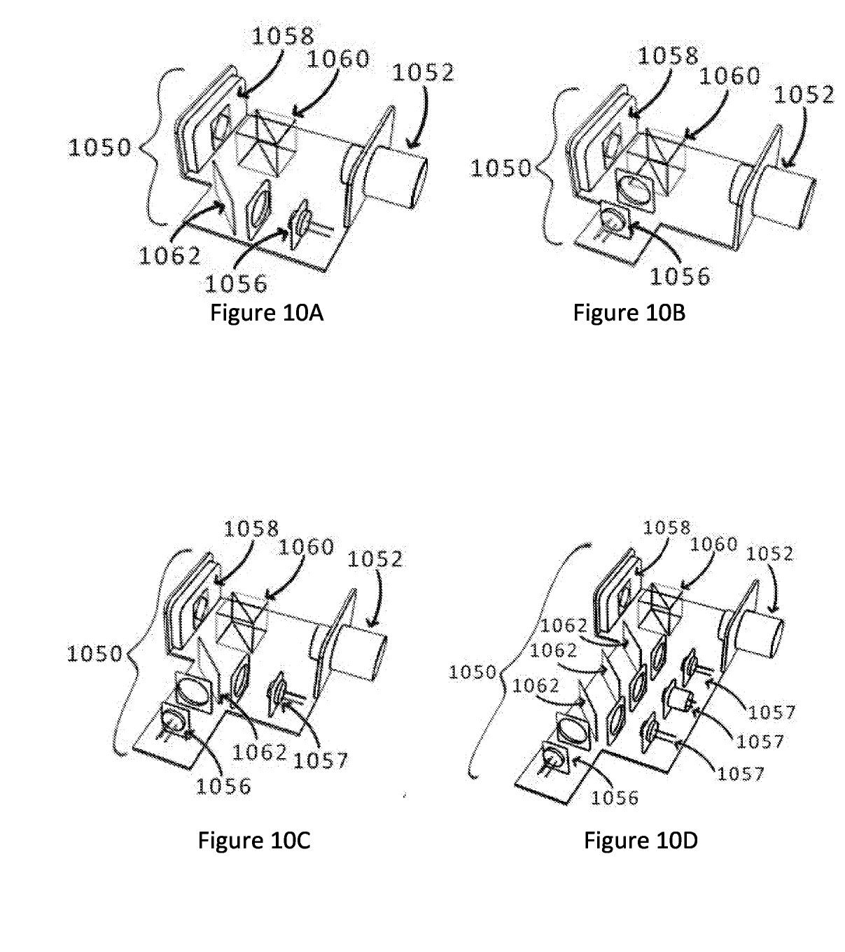

Turning now to FIGS. 10A and 10B, the illumination device 1050 includes a semiconductor light emitting device 1056, and a scanning mechanism 1058, projection optics 1052, such as a lens. The illumination device can include a semiconductor light emitting device 1056, such as any number of devices including but not limited to, an LED, EEL, single element or an array of VCSELs, DPL, or other semiconductor based light emitting device, producing light in the infrared and or near infrared light wavelengths. The intensity per pulse can be controlled by a change in numerous things, including, input current which correlates to a change in output power, frequency which would divide each pulse into sub-pulses of an equal energy output with the control of the intensity being determined by the number of sub-pulses “ON” during one pulse, or in the case of an array where each element of the array had a fixed output, the change in intensity would be determined by the number of elements “ON” during one pulse. The light may be directed to the scanning mechanism 1058 through a beam splitter 1060. The scanning mechanism 1058 may be a digital light processor (DLP) or similar device using an array of MEMs mirrors, LCOS (Liquid Crystal On Silicon), LBS (Laser Beam Steering), or combination of two single axis MEMs mirrors or a dual axis or “Eye” type of MEM as mirrors. The vertical scan could perform a linear scan at a low frequency (60 Hz as an example display refresh rate), whereas the horizontal scan requires a higher frequency (for example, greater than 90 kHz for a 1920×1080 HD display). The stability of the scan in either direction could affect the results, therefore, an example such as one pixel resolution could provide good resolution.

FIG. 10B shows an alternate embodiment than FIG. 10A, where the semiconductor light emitting device 1056 is aligned differently, and without a reflector 1062 needed, as in FIG. 10A, before the beam splitter 1060. The reflector 1056 could be a partial mirror as well, allowing light to pass from one side and reflecting from another.

As depicted in FIG. 10C, the illumination device 1050 includes a semiconductor light emitting device 1056, an additional semiconductor light emitting device 1057 which may be a source of white light or a single source emitting either visible red, green and blue light or a secondary source of IR/NIR light, a scanning mechanism 1058, and projection optics 1052, such as a lens. The illumination device 1050 can include a semiconductor light emitting device 1056, such as, any number of things including but not limited to, an LED, EEL, single element or an array of VCSELs, DPL, or other semiconductor based light emitting devices, producing light in the infrared and/or near infrared light wavelengths. The intensity per pulse can be controlled by a change in, input current which correlates to a change in output power, frequency which would divide each pulse into sub-pulses of an equal energy output with the control of the intensity being determined by the number of sub-pulses “ON” during one pulse, or in the case of an array where each element of the array had a fixed output, the change in intensity would be determined by the number of elements “ON” during one pulse. The light may be directed to the scanning mechanism 1058 through a beam splitter 1060.

In the figure, a reflector 1062 is shown between the light emitting device 1056 and the beam splitter 1060. The reflector 1056 could be a partial mirror as well, allowing light to pass from one side and reflecting from another. The scanning mechanism 1058 may be any number of things including but not limited to, a DLP or similar device using an array of MEMs mirrors, LCOS, LBS, or combination of two single axis MEMs mirrors or a dual axis or “Eye” type of MEMs mirrors. The vertical scan could perform a linear scan at a low frequency (60 Hz for a typical display refresh rate), whereas the horizontal scan requires a higher frequency (greater than 90 kHz for a 1920×1080 HD display), for example. If scan in either direction is stable, within one pixel resolution, less error correction is needed.

As depicted in FIG. 10D, the illumination device 1050 includes a semiconductor light emitting device 1056, and additional semiconductor light emitting devices 1057 which may be single sources emitting visible red, green and blue light or a secondary source of IR/NIR light, a scanning mechanism 1058, and projection optics 1052, such as a lens. In certain embodiments, light emitting devices 1057 could be any number of single colored lasers including but not limited to red, green and blue, and the associated differing wavelengths. These illumination sources, for instance lasers 1057 could each have a unique wavelength or wavelengths as well. The illumination device can include a semiconductor light emitting device, such as any number of things including but not limited to, an LED, EEL, single element or an array of VCSELs, DPL, or other semiconductor based light emitting device, producing light in the infrared and or near infrared light wavelengths. The intensity per pulse can be controlled by a change in, input current which correlates to a change in output power, frequency which would divide each pulse into sub-pulses of an equal energy output with the control of the intensity being determined by the number of sub-pulses “ON” during one pulse; or in the case of an array where each element of the array had a fixed output, the change in intensity would be determined by the number of elements “ON” during one pulse. The light may be directed to the scanning mechanism 1058 through a beam splitter 1060. The scanning mechanism 1058 may be any number of things including but not limited to, a DLP or similar device using an array of MEMs mirrors, LCOS, LBS, or combination of two single axis MEMs mirrors or a dual axis or “Eye” type of MEMs mirrors. The vertical scan could perform a linear scan at a low frequency (60 Hz for a typical display refresh rate), whereas the horizontal scan may require a higher frequency (greater than 90 kHz for a 1920×1080 HD display).

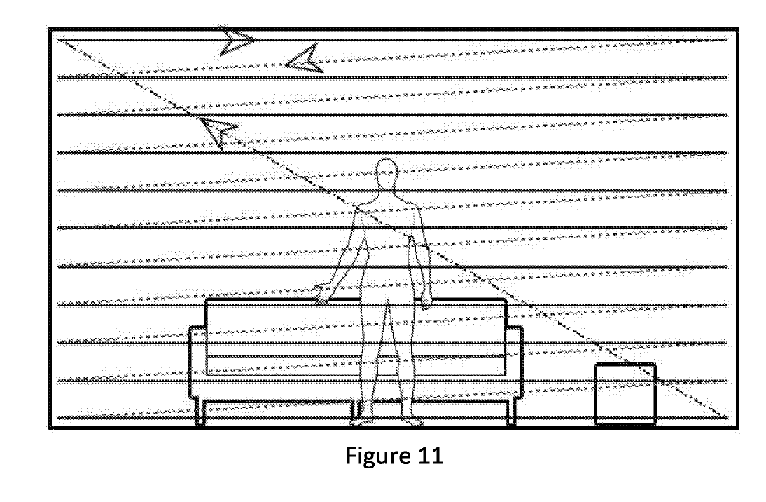

FIG. 11 depicts an example illustration of how the system may scan the subject area being illuminated. This kind of example scan is an interlaced scan. Any number of other example scan patters may be used to scan an illuminated area, the one in FIG. 11 is merely exemplar. In other embodiments of FIG. 11, the scanning mechanism may produce a scanned illumination in other patterns, such as but not limited to, a raster, progressive or de-interlaced or other format depending upon the requirements of the overall system.

In this example, using a directionally controlled pulsed laser, each horizontal line is divided into pixels which are illuminated with one or more pulses per pixel. Each pulse width/length becomes a pixel, as MEMS or reflector scans the line in a continuous motion and then moves to the next horizontal line. For example, 407,040 pixels may cover the target area, which is limited by the characteristics of the steering mechanism, in this example with 848 pixels per horizontal line and 480 horizontal lines. Other numbers of pixels may also be used. For example, if the MEMS can move 480 lines in the vertical access and 848 lines in the horizontal access, assuming the laser can pulse at the appropriate rate, 407,040 pixels could be projected to cover a target area. As this is limited by the laser pulse length and the time it takes for the directional control system to aim the beam, any other numbers of pixels may be used depending on the situation and the ability of the laser to pulse and the directional control to position each pulse emission.

### EYE Safety for Directed Illumination/Scan Embodiments

Example embodiments here may be used to determine certain operational statistics. Such statistics may include measuring the amount, intensity and/or power the system puts out. This can be used, for example, to ensure that safety limits are met, such as eye safety limits for projection of IR/NIR. The system, and in some embodiments the microprocessor computer system, may be instructed via code which may utilize the information provided from the illumination source and/or image sensor to help determine the correct duration of each pulse during one frame.

Recognition software analyzes image information from a CMOS or CCD sensor. The software determines the area(s) of interest. The coordinates of that area(s) of interest are sent to a microprocessor with the additional information as to the refresh rate/scanning rate/fps (frames per second), of the system.

P=number pulses “ON” during one scan
n=total number of total pixels/pulses in a scan
I=energy intensity of each pulse
energy intensity may also be defined as luminous intensity or radiance intensity
   S=scanned lines per cycle or frame
   F=FPS−length of time of one frame or one complete scan per second
   Fi=total intensity per frame or Σ(I₁, I₂, . . . Iₙ)×F

Further, the system may also verify the eye safe limits of each frame. In such an example, each light pulse may be assigned a value corresponding to the eye safe limits as determined by the semiconductor light emitting device and associated optics. As the variables which determine eye safe limits vary greatly depending upon the size of the external aperture, wavelength of light, mode, coherence, and duration, the specific criteria will be established using the specifications of the final design of the light emitting device. This may establish an Lmax-maximum eyesight safety level per frame. If

Fi>Lₘₐₓ

The system will reduce I and/or P until Fi<Lₘₐₓ

If no solution exists for Fi<Lₘₐₓ then the system may shift into a fail safe mode which will prevent the current cycle from energizing and returns an error message to the recognition software.

The system may include additional eye safe protections. In one embodiment, the system incorporates object recognition and motion tracking software in order to identify and track a target human's eyes. Where it is possible for eye tracking software to identify the biological eyes, the system may create a blacked out space preventing the scan from illuminating or shining light directly at the identified eyes of a target human.

The system may also include hardware protection which incorporates circuitry designed with a current limiting system that prevents the semiconductor light emitting device from exceeding the power necessary to drive it beyond the maximum safe output level.

### Examples for Directing Illumination

Discussed below are directed illumination example embodiments that could be used with any of the embodiments herein to capture the image, and also be used for distance measurement, depending on the embodiment.

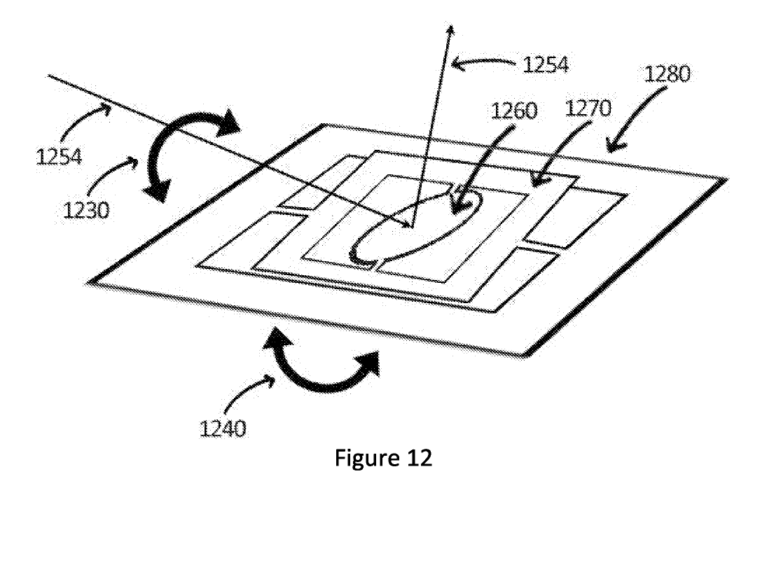

FIG. 12 illustrates one example of a way to steer an illumination source, such as a laser, here by a dual axis MEMS device. Any kind of beam steering technology could be used, but in this example embodiment, a MEMS is utilized. In this example, outgoing laser beam 1254 from the light source is directed onto the horizontal scan plane 1260 which directs the beam in a horizontal motion as indicated by horizontal direction of rotation 1230. The horizontal scan plane 1260 may be attached to the vertical scan plane 1270. The vertical scan plane 1270 and horizontal scan plane 1260 may direct the light in a vertical motion as indicated by vertical direction of rotation 1240. Both scan planes may be attached to a MEMS frame 1280. The combined horizontal and vertical motions of the scan planes allow the device to direct light in a sweeping pattern. This method of scanning is referred to as a raster scan and can produce an image in a number of scan patterns, such as but not limited to, an interlaced, de-interlaced, or progressive method.

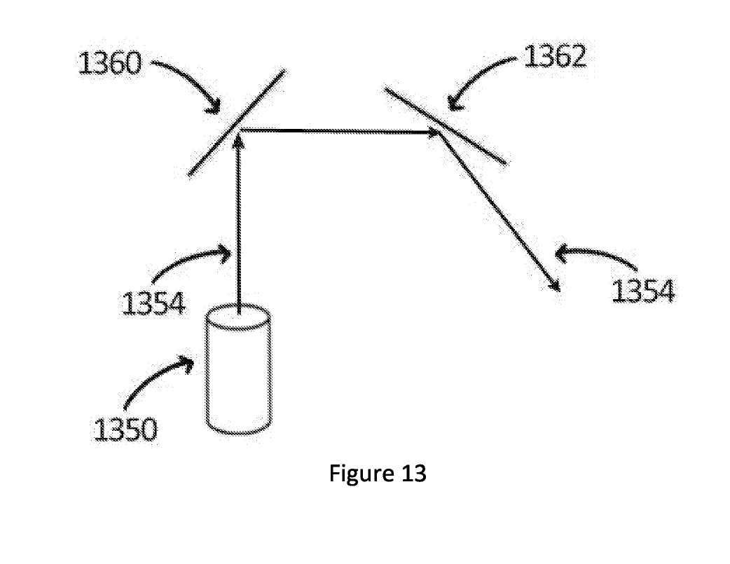

FIG. 13 shows an example embodiment using two single axis MEMS instead of one dual axis MEMS as shown in FIG. 12. In this example, a system of creating a raster scan uses two single axis MEMS or mirrors to steer an illumination from a source, in this example, a laser beam. Outgoing laser beam 1354 from the illumination source 1350 is directed onto the vertical scan mirror 1360 which directs the beam in a vertical motion. The outgoing laser beam 1354 is then directed to the horizontal mirror 1362 which may create a horizontal sweeping pattern. The combined horizontal and vertical motions of the mirrors or MEMS enables the device to direct light in a sweeping pattern. The system can also be used to direct pulses of laser light at different points in space, by reflecting each pulse in a different area. Progressive illumination of the target using a pulsed illumination source may result in a scanning of a target area over a given time as disclosed above. Certain methods of scanning may be referred to as a raster scan and can produce an image in an interlaced, de-interlaced, or progressive method, for example.

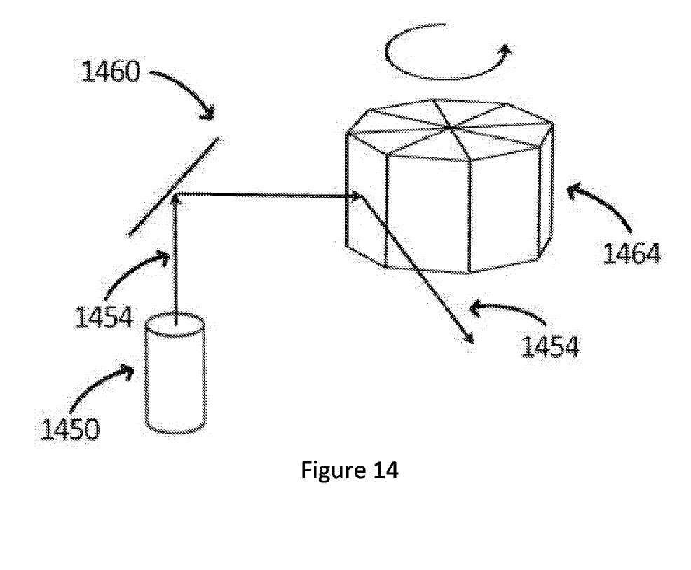

FIG. 14 illustrates an example embodiment of creating a raster scan utilizing one single axis MEMS or mirror 1460 and one rotating polygon mirror 1464. Outgoing laser beam 1454 from the light source 1450 is directed onto the vertical mirror 1460 which directs the beam in a vertical motion. In this example, the outgoing laser beam 1454 is then directed to the rotating polygon mirror 1464 which creates a horizontal sweeping motion of the outgoing laser beam 1454. The combined horizontal and vertical motions of the mirror and the rotating polygon enable the device to direct light in a sweeping pattern. This method of scanning is referred to as a raster scan and can produce an image in a number of scan patterns including but not limited to interlaced, de-interlaced, or progressive method.

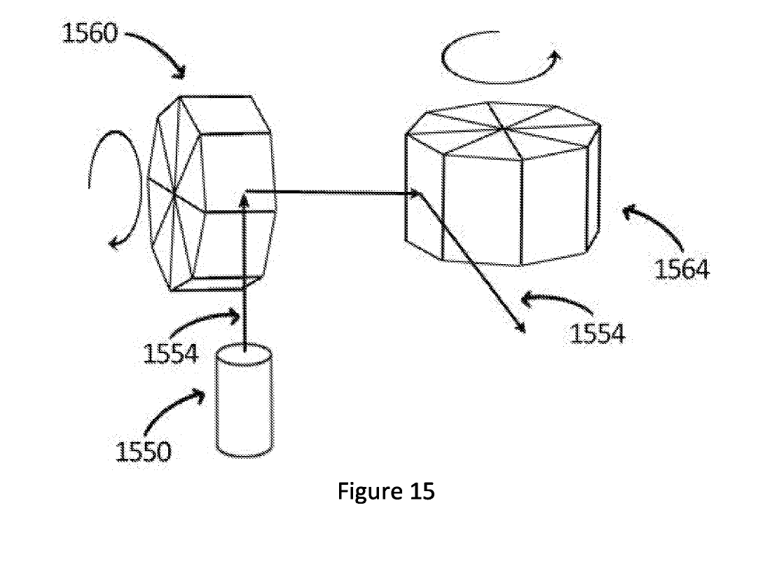

FIG. 15 illustrates an example system of creating a raster scan utilizing two rotating polygon mirrors. In this example, outgoing laser beam 1554 from the light source 1550 is directed onto the rotating polygon mirror 1560 which directs the beam in a vertical motion. The outgoing laser beam 1554 is then directed to another rotating polygon mirror 1564 which creates a horizontal sweeping motion of the outgoing laser beam 1554. The combined horizontal and vertical motions of the rotating polygon mirrors enable the device to direct light in a sweeping pattern. This method of scanning is referred to as a raster scan and can produce an image in an interlaced, de-interlaced, or progressive method.

Certain embodiments may use other ways to beam steer an illumination source, and the examples described here are not intended to be limiting. Other examples such as electromagnetic control of crystal reflection and/or refraction may be used to steer laser beams as well as others.

### Illumination Examples

In certain example embodiments, the users and/or system may desire to highlight a specific target within the target area field of view. This may be for any number of reasons including but not limited to object tracking, gesture recognition, 3D mapping, or any number of other reasons. Examples here include embodiments that may aid in any or all of these purposes, or others.

The example embodiments in the system here may first recognize an object that is selected by a user and/or the system via instructions to the computing portions. After the target is identified, the illumination portions of the system may be used to illuminate any or all of the identified targets or areas of the target. Through motion tracking, the illumination source may track the objects and change the illumination as necessary. The next few example figures disclose different illumination methods that may be used in any number of example embodiments.

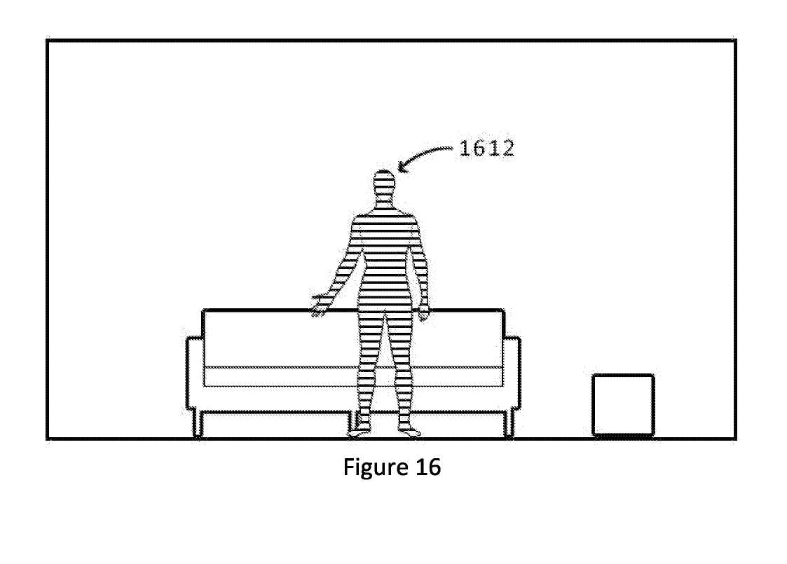

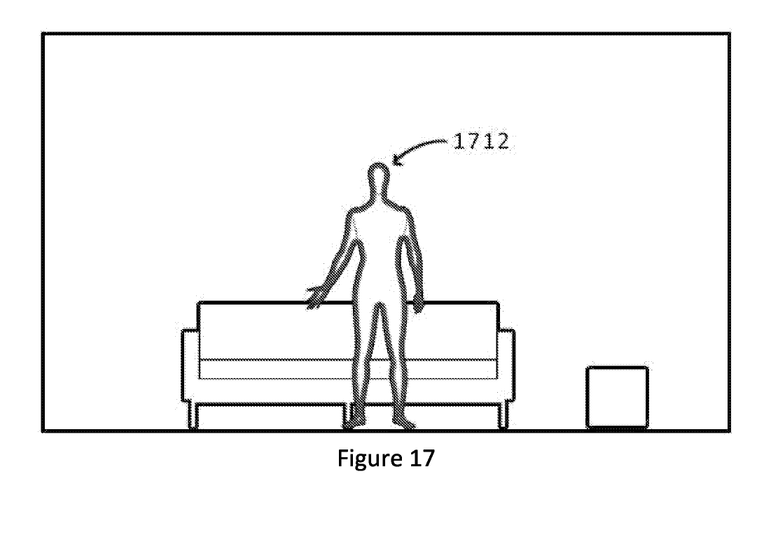

FIG. 16 depicts an illustration of the effect of a targeted subject being illuminated, in this case a human form 1612. In other example embodiments of FIG. 16 (not pictured), the subject of illumination could be other animate or inanimate objects or combinations thereof. This type of targeted illumination may be accomplished by first illuminating and recognizing a target, then directing subsequent illumination only on the specific target, in this case, a human.

FIG. 17 depicts an illustration of the effect of a targeted subject form having only the outline illuminated 1712. In other example embodiments of FIG. 17, the subject of outlined illumination could be other animate or inanimate objects or combinations thereof (not pictured).

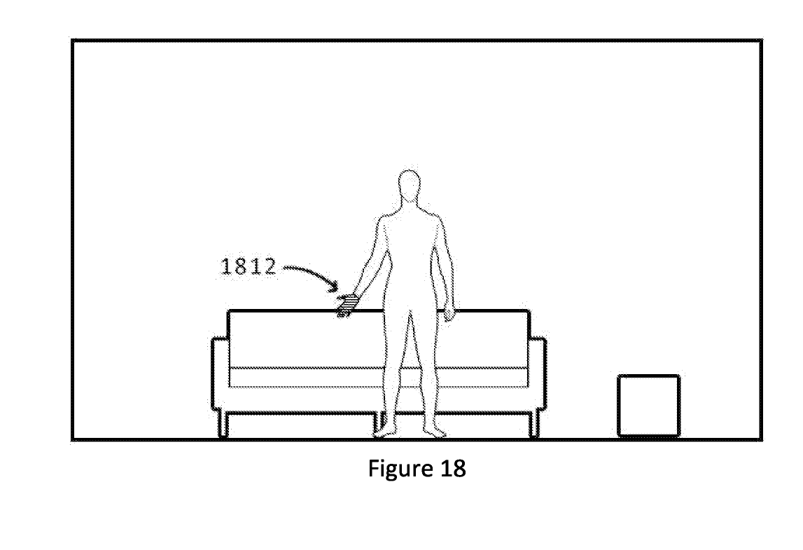

FIG. 18 depicts an illustration of the effect of a sub-area of targeted subject form being illuminated in this case the right hand 1812. In other example embodiments of FIG. 18, the subject of sub-area illumination could be other animate or inanimate objects or combinations thereof (not pictured).

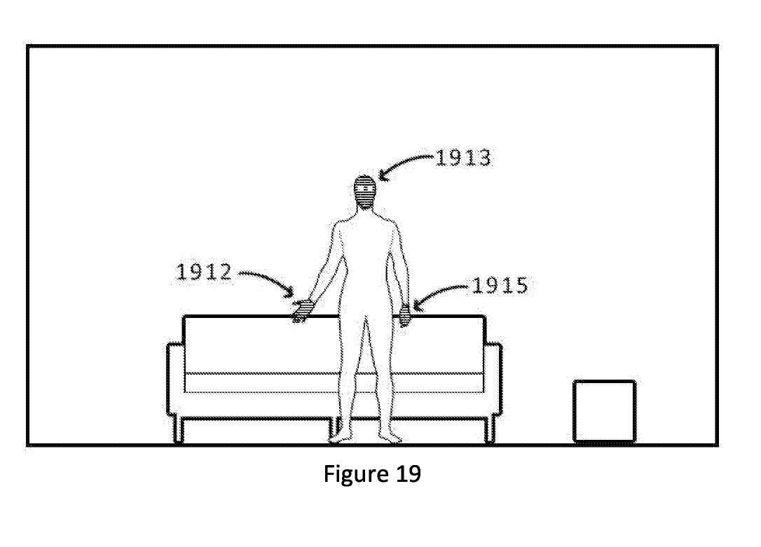

In certain embodiments, once identified, particular target areas require a focus of illumination in order to isolate the area of interest. This may be for gesture recognition, for example. One such example embodiment is shown in FIG. 19 which depicts an illustration of the effect of multiple sub-areas of targeted subject form being illuminated in this case the right hand 1912, the face 1913 and left hand 1915. In other example embodiments of FIG. 19, the subject of multiple sub-areas illumination could be other animate or inanimate objects or combinations thereof (not pictured).

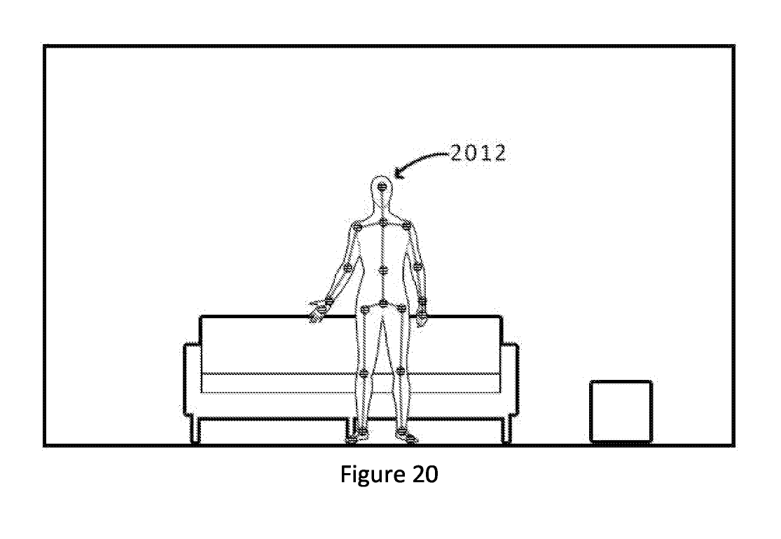

Once a target or target area is identified, it may be desirable to project light on only certain areas of that target, depending on the purpose of illumination. For target motion tracking for example, it may be desirable to merely illuminate certain areas of the target, to allow for the system to only have to process those areas, which represent the entire target object to be tracked. One such example is shown in FIG. 20 which depicts an illustration of the effect of illumination of skeletal tracking and highlighting of key skeletal points 2012. This may allow the system to track the target using only certain skeletal points, and not have to illuminate the entire target, and process information about the entire surface of the target to track its motion. In other example embodiments of FIG. 20, the skeletal tracking and key points could be other animate objects or combinations thereof (not pictured). Again, to accomplish such targeted illumination, a target must be first illuminated and then recognized and then subsequent illumination targeted.

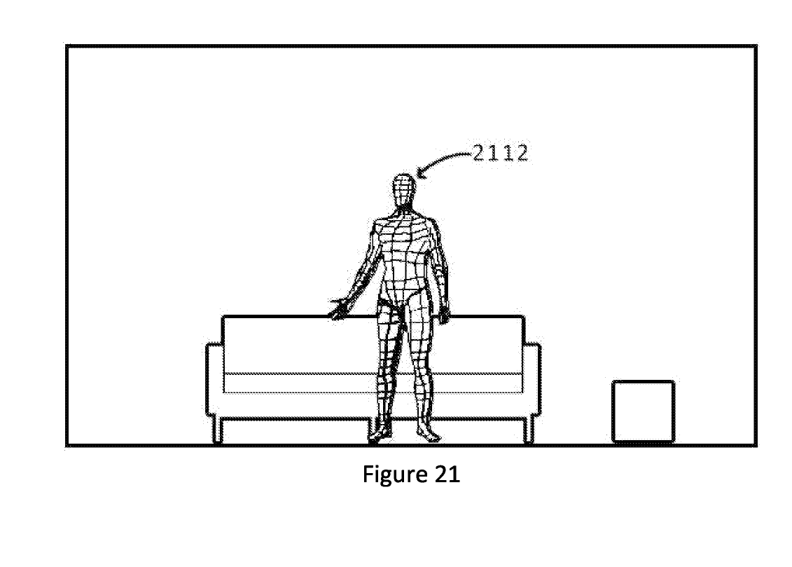

FIG. 21 depicts an example illustration of the effect of illumination of targeted subject with a grid pattern 2112. This pattern may be used by the recognition or other software to determine additional information such as depth and texture. Further discussion below, describes examples that utilize such pattern illuminations. The scanning device may also be used to project outlines, fill, skeletal lines, skeletal points, “Z” tags for distance, De Bruijn Grids, structured light or other patterns for example as required by the recognition software. In other embodiments, the system is capable of producing and combining any number of illumination styles and patterns as required by the recognition system.

### Maximum Illumination and Eye Safety

Turning to FIG. 22, a flow chart depicts one example of how the system may determine certain operational statistics. Such statistics may include measuring the amount, intensity and/or power the system puts out. This can be used, for example, to ensure that safety limits are met, such as eye safety limits for projection of IR/NIR. Also, the flow chart may be used to demonstrate calculations of multiple embodiments, such as the array illumination example with fixed intensity, an array with variable intensity, and also a raster scanned example using lasers described later in this disclosure, for example.

The flow chart begins with the illumination device 2210, whatever embodiment that takes, as disclosed here, directing low level full scan illumination over the entire target area 2220. This allows the system to capture one frame of the target area and the image sensor may receive that entire image 2230. From that image, the length of time of one frame or one complete scan per second may inform how the illumination device operates 2240. Next, the microprocessor, or system in general 2250, may determine a specific area of interest in the target area to illuminate specifically 2252. Using this information, once the system is satisfied that the identified area of interest is properly identified, the system may then map the target area and based on that information calculates the total level of intensity for one frame 2260. In examples where power out or total illumination per frame is important to eye safety, or some other parameter, the system can validate this calculation against a stored or accessible maximum number or value 2270. If calculated total intensity is less than or equal to the stored maximum, the system and/or microprocessor may provide the illumination device with instructions to complete one entire illumination scan of the target area 2280. If the calculated maximum is greater than the stored or accessed maximum number, the system may recalculate the intensity to a lower level 2274 and recalculation 2260. If the calculated maximum number cannot be reduced to a level lower than or equal to a stored maximum number, the system may be configured to not illuminate the target area 2272, or to perform some other function to limit eye exposure, and/or return an error message. This process may then repeat for every frame, or may be sampled randomly or at a certain interval.

Other kinds of examples of power or illumination measurement may be used in various circumstances, besides the illustration here for eye safety. For example, there may be light sensitive instruments in the target area, there may be system power limitations that must be met, etc. Similar methods as those described here may be used to check and/or verify the system power out to the illuminated target area. Specific eye safety calculations for each of the methodologies of illumination are described elsewhere in this disclosure.

In some embodiments of this device, a light shaping diffuser (reference FIG. 1, at 104), may be arranged somewhere after the array (not pictured) to create a smooth projection of the semiconductor light emitting devices in the array. The light shaping diffuser (not pictured) may create a smooth projection of the semiconductor light emitting devices in the array and a more homogenous overlap of illumination. The light shaping diffuser (not pictured) may also have an added effect of allowing for increased levels of illumination while remaining within eye safe limits.

In other examples, image capture devices may use a shutter or other device to break up image capture into frames. Examples of common durations are 1/30th, 1/60th or 1/120th of a second.

Examples that Incorporate Optical Elements

Video imaging sensors may utilize an optical filter designed to cut out or block light outside the range visible to a human being including IR/NIR. This could make utilizing IR/NIR an ineffective means of illumination in certain examples here. And according to certain embodiments here, the optical filter may be replaced with one that is specifically designed to allow for both the visible range of wavelengths and a specific band of IR/NIR that matches that of the illumination device. This may reduce the distortion created by the IR/NIR, while allowing for the maximum response to the IR/NIR.

According to certain embodiments, the optical filter is replaced with one specifically designed to allow for both the visible range of wavelengths and a specific band of IR/NIR that matches that of the semiconductor light source. This may help reduce the distortion created by the IR/NIR, while allowing for the maximum response to the IR/NIR.

According to certain embodiments, the optical filter is replaced with one specifically designed to block all wavelengths except only a specific band of IR/NIR that matches that of the semiconductor light source.

According to certain embodiments, a semiconductor light emitting device may be used to produce light in the infrared and or near infrared light wavelengths defined as 750 nm to 1 mm, for example. In some embodiments, the projection optics may be a projection lens.

IR/NIR could be used in certain situations, even if natural ambient light is present. In certain embodiments, the use of IR in or around the 976 nm range could be used by the illumination source, and filters on the image capture system could be arranged to only see this 976 nm range. In such examples, the natural ambient light has a dark spot, or very low emission in the 976 nm range. Thus, if the example system focuses the projected and captured IR in that 976 nm range, it may be able to be used where natural light is present, and still be able to illuminate and capture images.

In certain embodiments, a combined ambient and NIR device may be used for directed illumination utilizing single CMOS sensor.

In such an example system, a dual band pass filter may be incorporated into the optical path of an imaging sensor. This path may include a lens, an IR blocking filer, and an imaging sensor of various resolutions. In certain embodiments, the IR blocking filter may be replaced by a dual band pass filter including a band pass filter, which may allow visible light to pass in approximate wavelengths between 400 nm and 700 nm, and a narrow band pass or notch filter, which is closely matched to that of the IR/NIR illumination source.

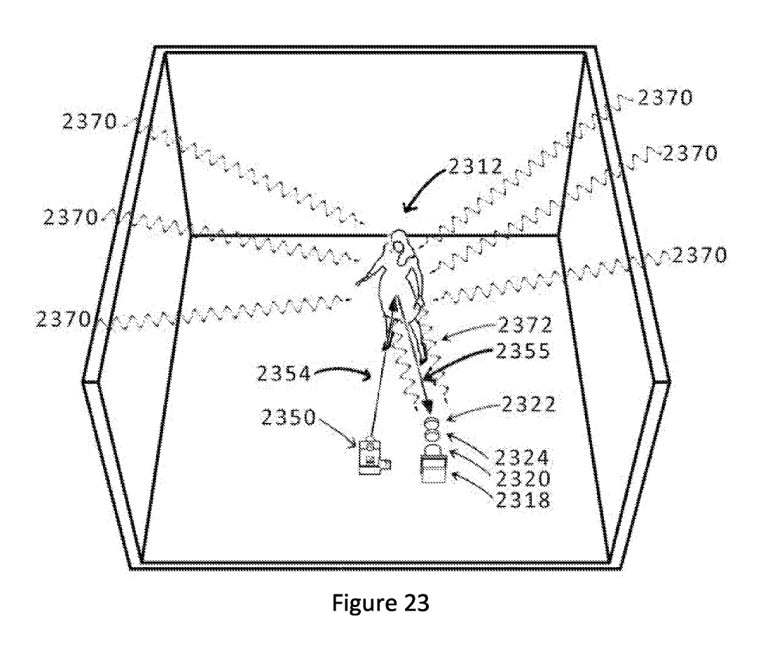

FIG. 23 illustrates the interaction of the physical elements of example embodiments here. An illumination device 2350 such as a dual axis or eye MEMS mirror or an array or other method which could direct an NIR light source, producing a source of augmented illumination onto the subject area 2312. Ambient light 2370 and NIR light 2354 are reflected off of the subject area 2312. Reflected ambient light 2372 and reflected NIR 2355 pass through lens 2322. A combined optical filter 2324 may allow only visible and a specific narrow range of IR to pass into optical housing 2320 blocking all other wave lengths of light from reaching image sensor 2318. In the example drawing, these objects are shown in exploded and/or exaggerated forms, whereas in practice they may take any number of shapes and configurations. Here, they are shown as sometimes separate and symbolic icons.

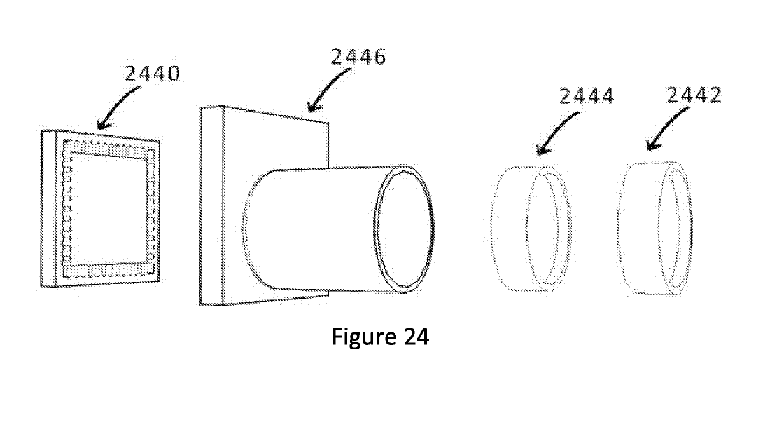

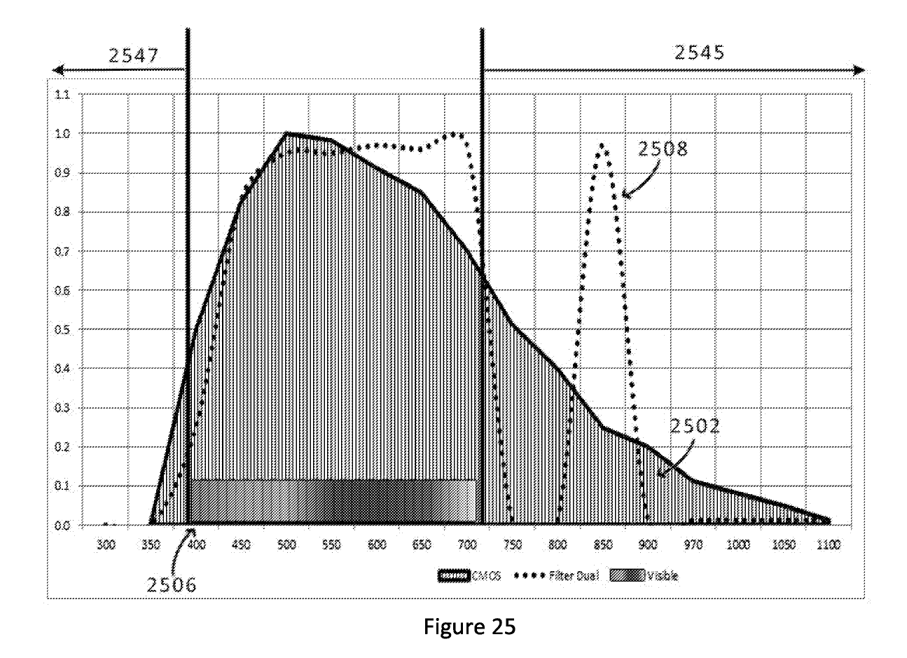

Turning now to an example of the image capture device/sensor, FIG. 24 depicts such an example in a side view of a CMOS or CCD camera 2440. This figure depicts a lens 2442, a filter 2444, and an optional lens tube 2446 or optics housing. Any number of combinations of lenses and filters of different sorts may be used, depending on the configuration of the embodiment and the purpose of the image capture. Also, many kinds of image capture devices could be used to receive the reflected illumination and pass it to computing devices for analysis and/or manipulation.

Referring again to FIG. 24, other embodiments of this device may have the order of the filter 2444 and the lens 2442 reversed. Still other embodiment of this device may have the lens 2442 and the filter 2444 combined, wherein the lens is coated and has the same filtering properties as a discrete filter element. This may be done to reduce cost and number of parts and could include any number of coatings and layers.

Still referring to FIG. 24, other embodiments may have the camera manufactured in such a way that the sensitivity of the device acts in a similar manner to that of a commercially available camera with a filter 2444. In such an example, the camera could be receptive to visible light and to only one specific range of IR/NIR, blocking out all of the other wavelengths of IR/NIR and non-visible light. This example device could still require a lens 2442 for the collection of light. Such examples are described in more detail below, for example in FIGS. 25, 26B and 27B.

Still referring to FIG. 24, such an example combined filter that blocks light below visible 400 nm is shown below by line 2547 in FIG. 25. Such a filter may also block above the visible 700 nm as shown below by line 2545 in FIG. 25.

According to one embodiment, the filter may only block above 700 nm allowing the inherent loss of responsivity of the sensor below the 400 nm to act like a filter. The filter may block some or all of IR/NIR above 700 nm typically referred to as an IR blocking filter.

In other embodiments of this device, the filter may only block above 700 nm allowing the inherent loss of responsivity of the sensor below the 400 nm to act like a filter. This filter may include a notch, or narrow band, allowing a desired wavelength of IR to pass. In this example, 850 nm, as shown by line 2508 in FIG. 25.

FIG. 25 depicts an example graph of the wavelength responsivity enabled by an example filter. The x axis shows wavelength in nanometers (nm) and the y axis shows percent sensitivity 0-100% as decimal values 0.0 to 1.1. Specific wavelengths are dependent upon the CMOS or CCD camera being utilized and the wavelength of the semiconductor light emitting devices. The vertically shaded area 2502 represents the typical sensitivity of a CMOS or CCD video imaging device. The “graduated rectangular bar” 2506 represents the portion of the spectrum that is “visible” to the human eye. The “dashed” line 2508 represents the additional responsivity of the proposed filter.

Turning again to FIG. 24, in this example embodiment, the optical filters may be combined into one element 2444. In FIG. 24, the example depicts an image sensor 2440, optical housing 2446, lens 2442, the combined filter 2444 blocking light below 400 nm, between 700 nm and 845 nm, and 855 nm and above. The example is illustrated assuming an NIR light source at 850 nm, wavelengths between 800 nm and 1000 nm may be utilized depending upon the specific device requirements. The band pass range is +/−5 nm for example only, the actual width of the band pass may be wider or narrower based on specific device requirements.

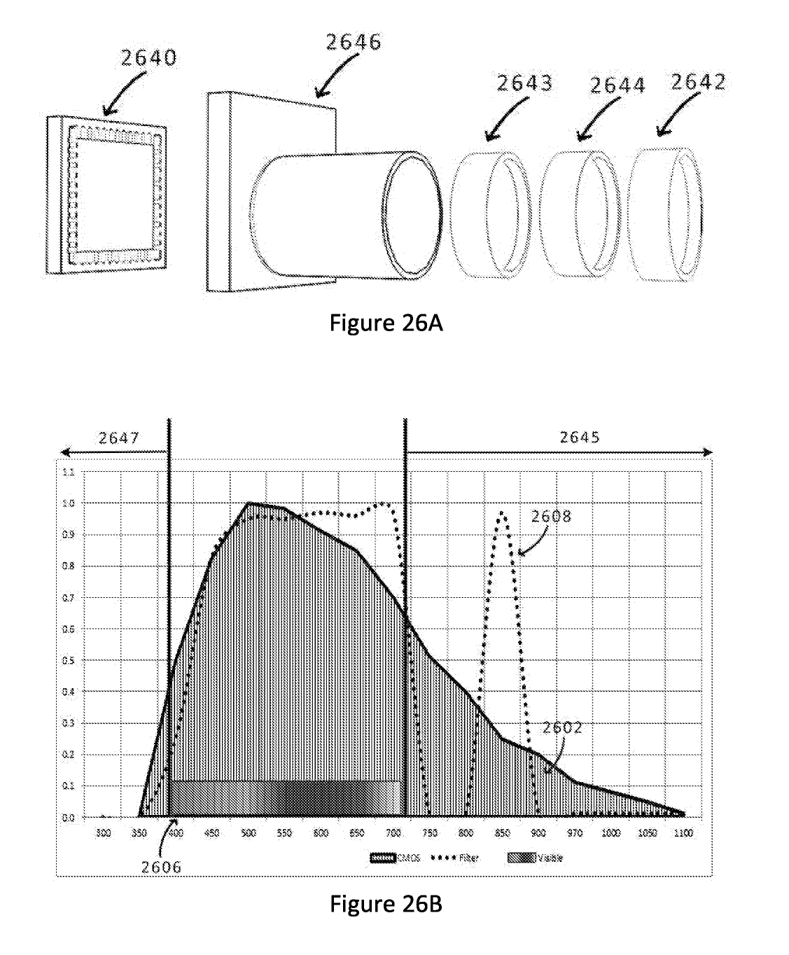

According to one embodiment, two optical filters are combined. In FIG. 26A, the example depicts an image sensor 2640, optical housing 2646, lens 2642, filter <400 nm 2643, and a narrow band filter 2644 blocking light between 700 nm and 845 nm, transmittance between 845 nm and 855 nm, blocking above 855 nm. The example is illustrated assuming an NIR light source at 850 nm, wavelengths between 800 nm and 1000 nm may be utilized depending upon the specific device requirements. The band pass range is +/−5 nm for example only, the actual width of the band pass may be wider or narrower based on specific device requirements.

FIG. 26B is a graphical depiction of example CMOS sensitivity to light. The x axis shows wavelength in nanometers (nm) and the y axis shows percent sensitivity. This example shows from 300 nm to 1100 nm 2602 (vertically shaded); the spectrum of light visible to human eye, 400 nm-700 nm 2606, (“graduated rectangular bar”); transmittance of filter from 0% to 100% across the spectrum 300 nm to 1100 nm (2608 dashed). The range covered by element is depicted above the graph. The narrow band filter 2644 blocking light between 700 nm and 845 nm, transmittance between 845 nm and 855 nm, blocking above 855 nm is shown as arrow 2645. The filter <400 nm 2643, is shown as arrow 2647.

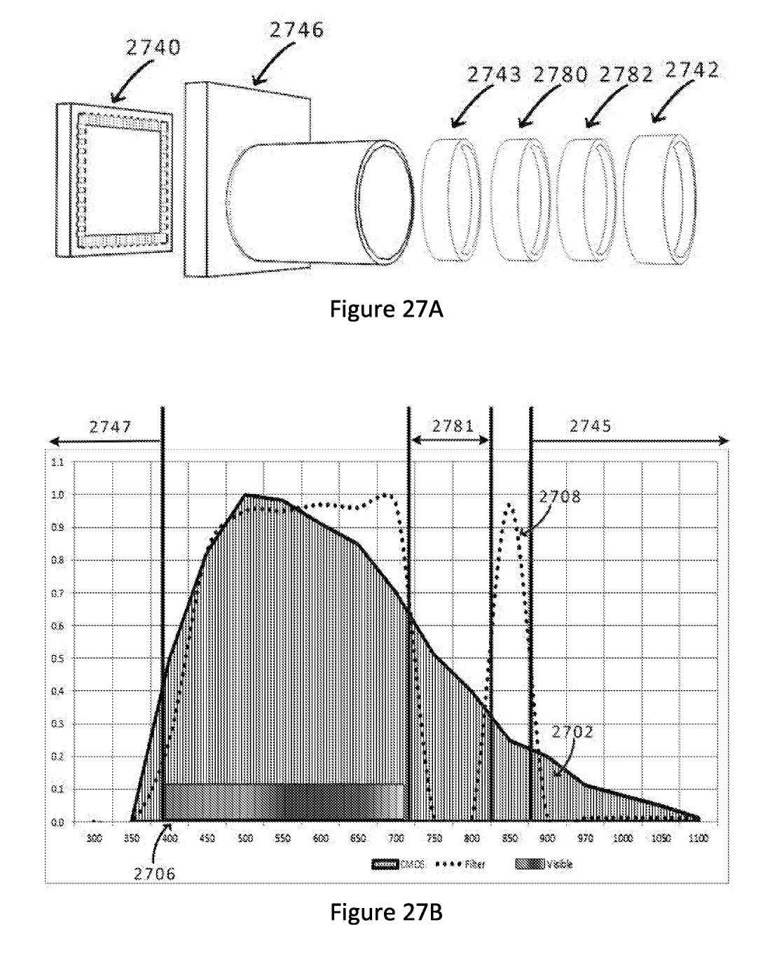

According to certain embodiments, three optical filters may be combined. In FIG. 27A, the example depicts an image sensor 2740, optical housing 2746, lens 2742, band filter <400 nm 2743, a narrow band filter 2780 between 700 nm and 845 nm, and a filter 2782 blocking above >855 nm. The example is illustrated assuming an NIR light source at 850 nm, wavelengths between 800 nm and 1000 nm may be utilized depending upon the specific device requirements. The band pass range is +/−5 nm for example only, the actual width of the band pass may be wider or narrower based on specific device requirements.

FIG. 27B is a graphical depiction of typical CMOS sensitivity to light. The x axis shows wavelength in nanometers (nm) and the y axis shows percent sensitivity. This example shows from 300 nm to 1100 nm (2702, shaded); the spectrum of light visible to human eye, 400 nm-700 nm (2706, black); transmittance of filter from 0% to 100% across the spectrum 300 nm to 1100 nm (2708, dashed). The range covered by band filter <400 nm 2743 is depicted as an arrow 2747, the range covered by, a narrow band filter 2780 between 700 nm and 845 nm is depicted as an arrow 2781, and the range covered by filter 2782 blocking above >855 nm, is shown as an arrow 2745.

In some example embodiments of this device, the system can alternate between RGB and NIR images by either the utilization of computing systems and/or software to filter out RGB and NIR, or by turning off the NIR illumination for a desired period of time. Polarization of a laser for example, may also be utilized to alternate and differentiate objects.

In other embodiments of this device, the optical filter or combination of filters may be used to block all light except a selected range of NIR light, blocking light in the visible range completely.

### Triangulation and Distance Measurement

Certain embodiments here may be used to determine distances, such as the distance from the example system to a target person, object, or specific area. This can be done as shown here in the example embodiments, using a single camera/image capture device and a scanning projection system for directing points of illumination. These distance measurement embodiments may be used in conjunction with many of the target illumination and image capture embodiments described in this disclosure. They could be used alone as well, or combined with other technologies.

The example embodiments here accomplish this by matching the projected points of illumination with a captured image at a pixel level. In such an example, first, image recognition is performed, over the target area in order to identify certain areas of interest to track, such as skeletal points on a human, or corners of a box, or any number of things. A series of coordinates may then be assigned to each key identified point. These coordinates may be sent to a computing system which may include microprocessing capabilities and which may in turn control a semiconductor light emitting device that may be coupled to a mechanism that scans the light across an area of interest.

The system may be configured to project light only on pixels that correspond to the specified area previously identified. Each pixel in the sequence may then be assigned a unique identifier. An image sensor could then collect the image within the field of view and assign a matching identifier to each projected pixel. The projected pixel's corresponding imaged pixel may be assigned horizontal and vertical angles or slope coordinates. With a known distance between the projection and image source, there is sufficient information to calculate distance to each point using triangulation calculations disclosed in examples here.

According to certain example embodiments, the system may direct one or more points or pixels of light onto a target area such as a human subject or object. The example device may include a scanning device using a dual axis or two singles axis MEMS, rotating polygon mirrors, or other method for directing light; a collimated light source such as a semiconductor or diode laser which can generate a single pixel; a CMOS, CCD or other imaging device which may incorporate a short band pass filter allowing visible and/or specific IR/NIR; a microprocessor(s) controlling the scanning device; object and/or gesture recognition software and a microprocessor.

In regards to using the system for distance measurement, the human or the software may identify the specific points for distance measurement. The coordinates of the points may be identified by the image sensor and the computing system and sent to the system which controls the light source and direction of projection. As the direction device scans, the device may energize the light at a pixel (input) corresponding to the points to be measured (output). The device may assign a unique identifier to each illuminated point along with its vertical and horizontal angular components.

The projected points and captured image may be synchronized. This may help reduce the probability that an area of interest has moved before a measurement can be taken. The imaged spot location may be compared to projected locations. If the variance between the expected projected spots map and the imaged spots is within a set tolerance then the system may accept them as matching.

The image sensor may produce one frame of information and transmits that to the software on the microprocessor. A frame refers to one complete scan of the target area and is the incremental period of time that the image sensor collects one image of the field of view. The software may be used to analyze the image information, identify projected pixels, assign and store information about the location of each point and match it to the illuminated point. Each image pixel may also be assigned angular values for horizontal and vertical orientation.

Based on the projected and imaged angles combined with known distance between the projector and image sensor, a trigonometric calculation can be used to help determine the depth from the device to each illuminated spot. The resultant distances can either be augmented to the display for human interpretation or passed onto software for further processing.

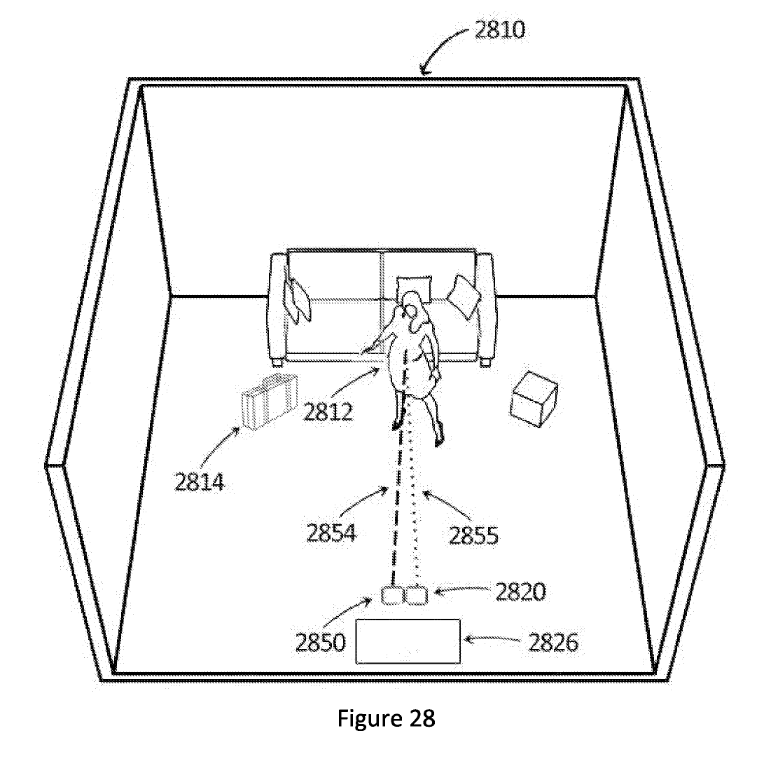

FIG. 28 illustrates an overview of the triangulation distance example embodiments here. These embodiments are not exclusive of the image illumination and capture embodiments disclosed here, for example, they may be used alone, or to augment, complement, and/or aid the image illumination and capture to help gather information and/or data about the target area for the system. In this example embodiment, the system is operating in a subject area 2810, here, a room. The illumination device 2850, in this example controlled by a microprocessor 2826, is used to project a beam 2854 to illuminate a point on a target 2812. The reflection of the beam 2855 may be captured by the image sensor 2820. Data from that capture may then be transmitted to the microprocessor 2826. Other objects in the room may similarly be identified, such as the briefcase 2814. Data from such an example system may be used to calculate distances to illuminated objects, as will be discussed further below.

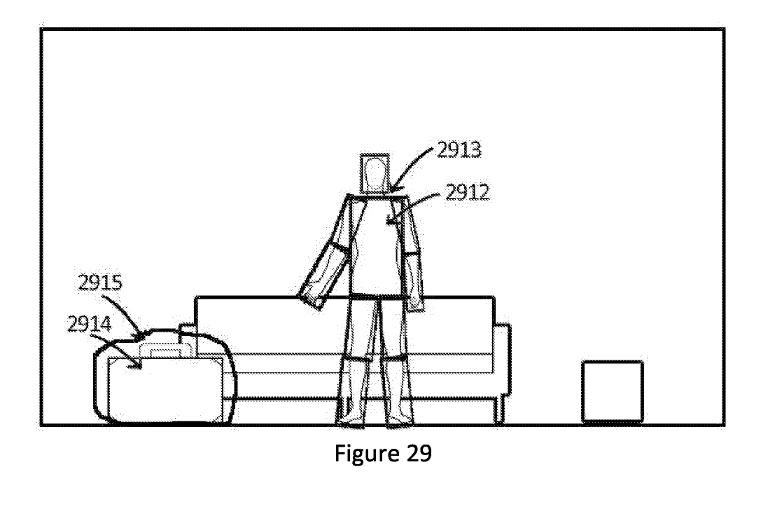

FIG. 29 illustrates an example of how the initial image recognition may be accomplished, in order to later target specific areas for illumination. Using an example image capture system including a camera and object or gesture recognition, a human 2912 may be identified. The identification of the area of interest is indicated by rectangular segments 2913. These rectangular segments may be any kind of area identification, used for the system to later target more specific areas to illuminate. The examples shown here are illustrative only. FIG. 29 also shows an example object 2914 which could also be identified by a larger area 2915. If computer instructions or software is not used to recognize objects or targets, human intervention could be used. A touch screen or cursor could be used to outline or identify targets of interest—to inform the system of what to focus illumination on, shown here by a traced line around the object.

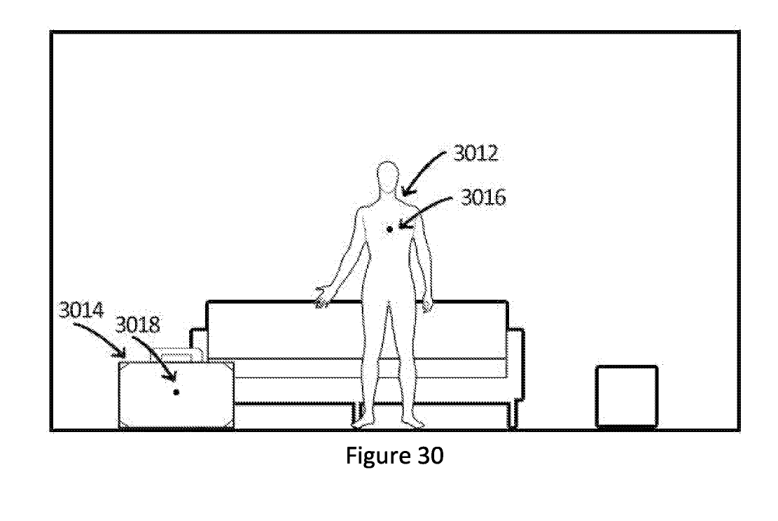

FIG. 30 illustrates an example scenario of a target area as seen by the image capture device, and/or caused to be displayed on a visual monitor for human interaction. In the example, as might be seen on a computer screen or monitor showing a single point illuminated 3016 for depth measurement on a target human 3012. Example gesture recognition software and software on the microprocessor could use the rectangular segments shown in FIG. 29, to direct an illuminated point 3016 on specific areas of a target human 3012. A similar process may be used for the examples that are manually identified. Likewise, object 3014 could also receive a directed illuminated point 3018. These points will be discussed later for distance calculations.

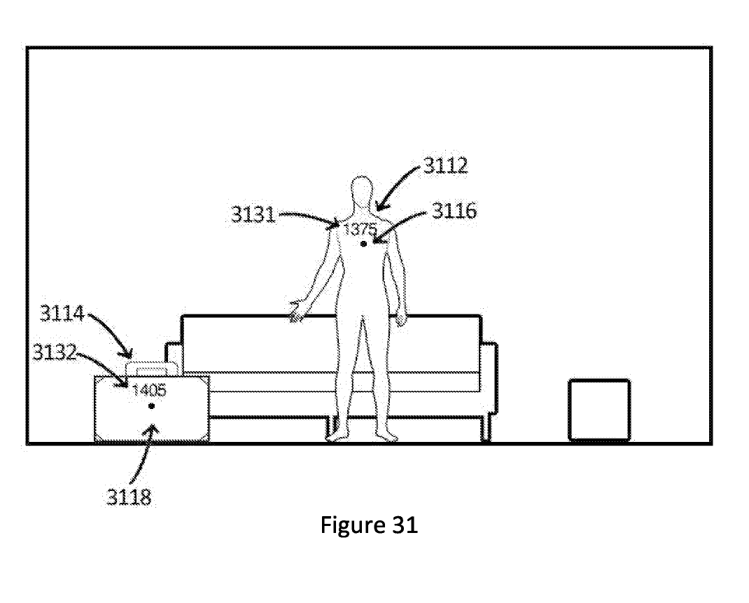

FIG. 31 illustrates an example imaged scenario as might be seen on a computer screen or monitor where the system has caused the display to show the calculated distance measurement from the system to the illuminated points 3118 and 3116 which are located on the object 3114 and human targets 3112, respectively. In this example, a display of the image, the distance calculations “1375” 3116 and “1405” 3118 show up on the screen. They could take any form or be in any unit of measurement, here they show up as 1375 and 1405 without showing the units of measurement, as an example.

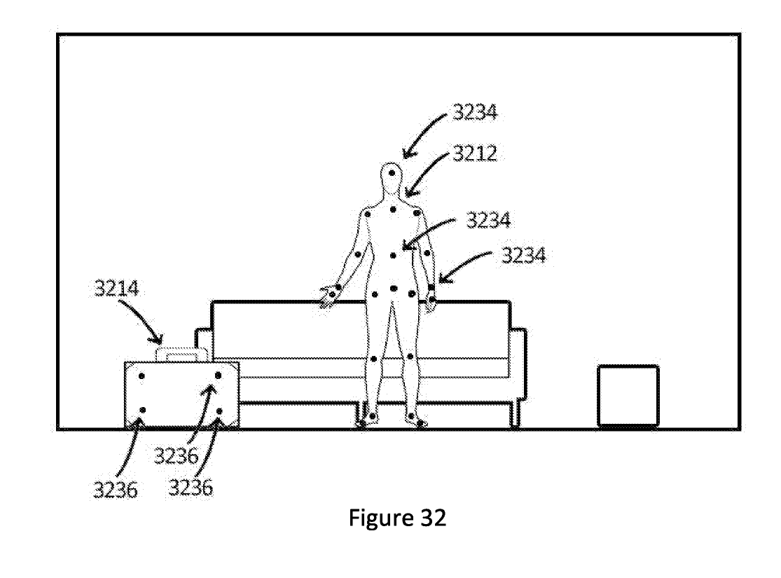

FIG. 32 illustrates a typical imaged scenario as might be seen on a computer screen or monitor showing multiple points illuminated for depth measurement. The system with gesture recognition capabilities such as those from software could use the rectangular segments as depicted in FIG. 29 to direct multiple illuminated points 3234 on a target human 3212. A similar process may be used to direct multiple illuminated points 3236 onto an object 3214. In certain examples, the system could be used to automatically select the human target 3212 and a human interface could be used to select the object 3214. This is only an example, and any combination of automatic and/or manually selected targets could be acquired and identified for illumination.

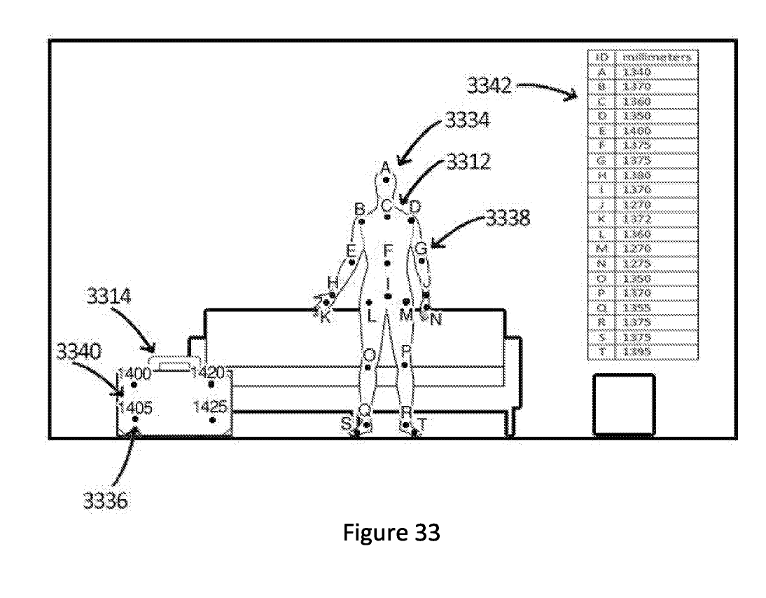

FIG. 33 illustrates an example embodiment where the system causes display on a computer screen or monitor showing the superimposing of the distance from the illumination device to the multiple illuminated points 3334 in tabular form 3342. The example multiple illuminated points are shown with labels of letters, which in turn are used to show the example distance measurements in the table 3342. FIG. 33 also depicts the manually selected object 3314 with multiple illuminated points 3336 superimposed on the image 3340 in this case showing “1400,” “1405,” “1420” and “1425” as distance calculations, without units depicted, as an example.

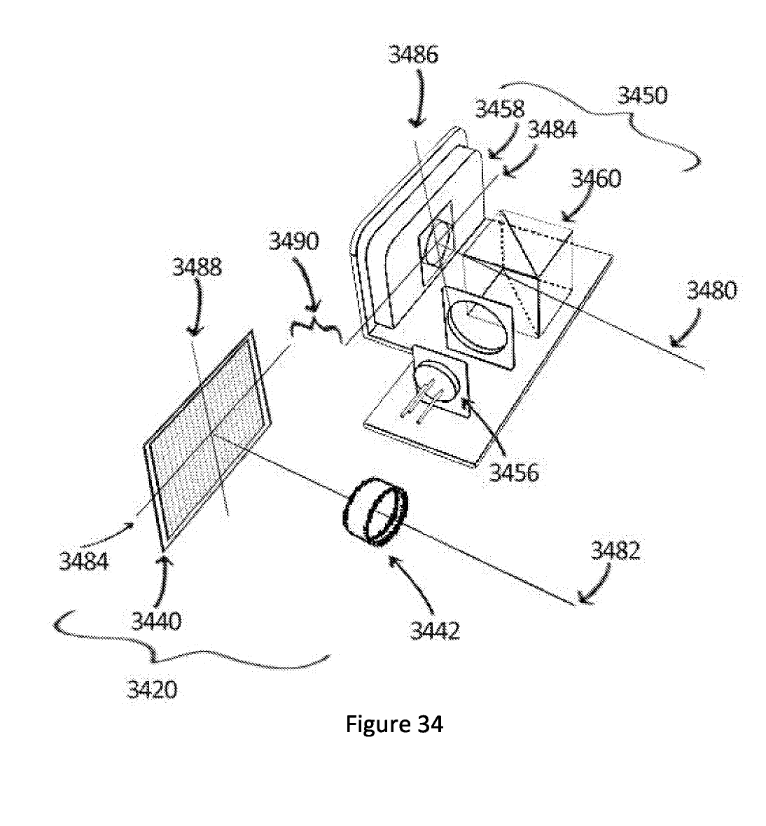

FIG. 34 illustrates an example of an embodiment of the physical relationship among components of the illumination device 3450 and the image sensor 3420. The relationship among these components may be used in distance calculations of the reflected illumination off of a target, as disclosed here. The illumination device 3450, as detailed above in FIG. 10, may include a light source 3456 which can be any number of sources, such as a semiconductor laser, LED, diode laser, VCSEL or laser array, or a non-coherent collimated light source. The light may pass through an optical component 3460 which may be used to direct the light onto the reflective system, in this example, a MEMS device 3458. The light may then be directed onto the area of interest; here the example beam is shown directed off the FIG. 3480.

Turning to the image capture device/camera/sensor, this example illustration shows the central Z axis 3482 for the image sensor 3420. The MEMS device 3458 also has a horizontal axis line 3484 and a vertical axis line 3486. The image sensor 3420 may include components such as a lens 3442 and a CMOS or CCD image sensor 3440. The image sensor 3440 has a central Z axis 3482 which may also be the path of illumination beam returning from reflection off the target to the center of the sensor 3440 in this example. The image sensor 3440 has a horizontal axis line 3484 and a vertical line axis 3488. In this example both the MEMS 3458 and the image sensor 3440 are offset both horizontally and vertically 3490 wherein z axis 3480 and 3482 are parallel, but the horizontal axis 3484 and the vertical axes 3488 and 3486 are offset by a vertical and/or horizontal value. In such examples, these offsets would have to be accounted for in the distance and triangulation calculations. As discussed throughout this document, the relationships and/or distance between the illumination source and the image capture z axis lines may be used in triangulation calculations.

In some example embodiments, the MEMS 3458 and the image sensor 3440 are aligned, wherein they share the horizontal axis 3484, and where their respective vertical axes 3488 and 3486 are parallel, and axial lines 3482 and 3480 are parallel.

Physical aspects of the components of the device may prevent the point of reflection of the directing device and the surface plane of the image sensor from being on the same plane, creating an offset such as discussed here. The offset may be intentionally introduced into the device as a means of improving functionality. The offset is a known factor and becomes an additional internal calibration to the distance algorithm.

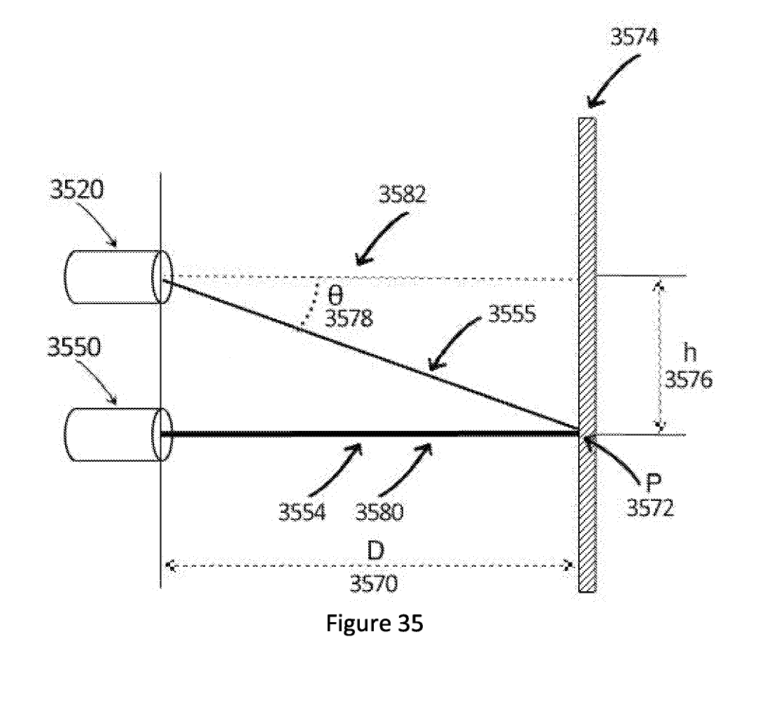

FIG. 35 illustrates an example of how data for triangulation calculations may be captured, which could be used in example embodiments to calculate distance to an illuminated object. The result of using the data in trigonometric calculations may be used to determine the distance D, 3570 from device to point P, 3572. Point P can be located any distance from the back wall of the subject area 3574 to the illumination device 3550. Outgoing laser beam 3554 is directed in this example from the illumination device 3550 to a point P 3572 on a subject area 3574. The reflected laser beam 3555 reflects back and is captured by the image sensor 3520. In this example the image sensor 3520 and the illumination device 3550 are aligned as illustrated earlier FIG. 34. Distance h 3576 is known in this example, and the angle represented by θ, 3578 can be determined as further illustrated in this disclosure. In this illustration there is no angular component to outgoing laser beam 3554. The central Z axis for the illumination device is represented by line 3580 and the image sensor 3520 by line 3582 are parallel. Using the functions described in above, the distance D 3570 can be determined.

In one example, the directed light is pointed parallel to the image sensor with an offset some distance “h” 3576 in the horizontal plane, and the subject area lies a distance “D” 3570 away. The illuminated point “P” 3572 appearing in camera's field of view is offset from the center through an angle θ, 3578 all as shown in FIG. 35:

Assuming a known angle θ 3578, using the separation between the directed spot at P 3572 and the center of the image sensor's field of view in the image, and the directed spot offset distance h, 3576 then the distance D 3570 is:

D=h/Tan(θ)

Since, because the image sensor and directed spot are parallel, the point P 3572 is a fixed distance, h 3576 away from the centerline of the image sensor, the absolute position (relative to the image device) of point P 3572 is known.

Thus, if the center of the focal plane of the image sensor is at a point (X,Y,Z)=(0,0,0), then P=(h,0,D).

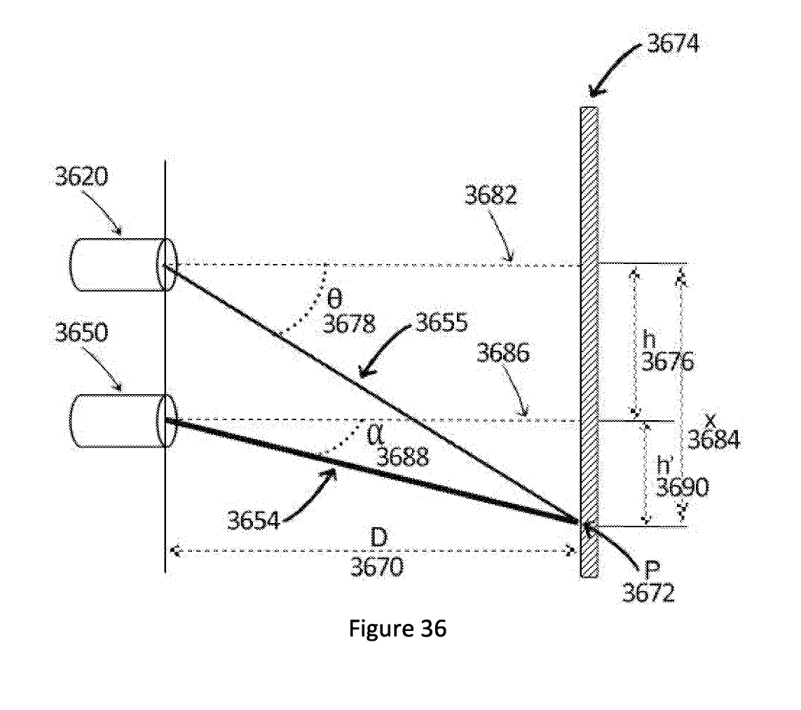

FIG. 36 illustrates an example calculation of distance where the angle the illumination source uses to illuminate the target is not directly down its own z axis. In this example, the trigonometric calculation may be used to determine the distance D, 3670 from device to point P, 3672. Point, 3672 can be located any distance from the back wall of the subject area 3674 to the illumination device 3650. Outgoing laser beam 3654 is directed from the illumination device 3650 to a point P, 3672 on a subject area 3674. The returning laser beam 3655 reflects back and is captured by the image sensor 3620. In this example the image sensor 3620 and the illumination device 3650 are aligned as further illustrated in FIG. 34. Distance h, 3676 is known and the angle represented by θ, 3678 can be determined as further herein. In this illustration the angular component α, 3688 of the outgoing laser beam 3654 can be determined based upon the horizontal and vertical coordinate of that pixel as described above. In this example h′ 3682 and x 3684 may be calculated. Using the function described above the distance D 3670 can be determined.

To determine the distance of many points all lying in the same plane as the above example. In this case, the output direction of the directed spot is changed, at some angle α relative to the line parallel to the image sensor, as shown in FIG. 36.

The image point P 3672 will be located a distance, where in the FIG. 36, x is 3684, h is 3676 and h′ is 3682, the formula x=h+h′ away from the centerline of the Image sensor, as shown in FIG. 36. In this case, the distance D 3670 can be determined from the angles θ 3678 and α 3688 and the directed spot “offset distance” h 3676:

D=h/[Tan(θ)−Tan(α)]

With the distance D 3670 known, the absolute position x 3684 of the image point can be determined, since:

x=D Tan(θ)

The absolute position of point P=(D Tan(θ), 0, D).

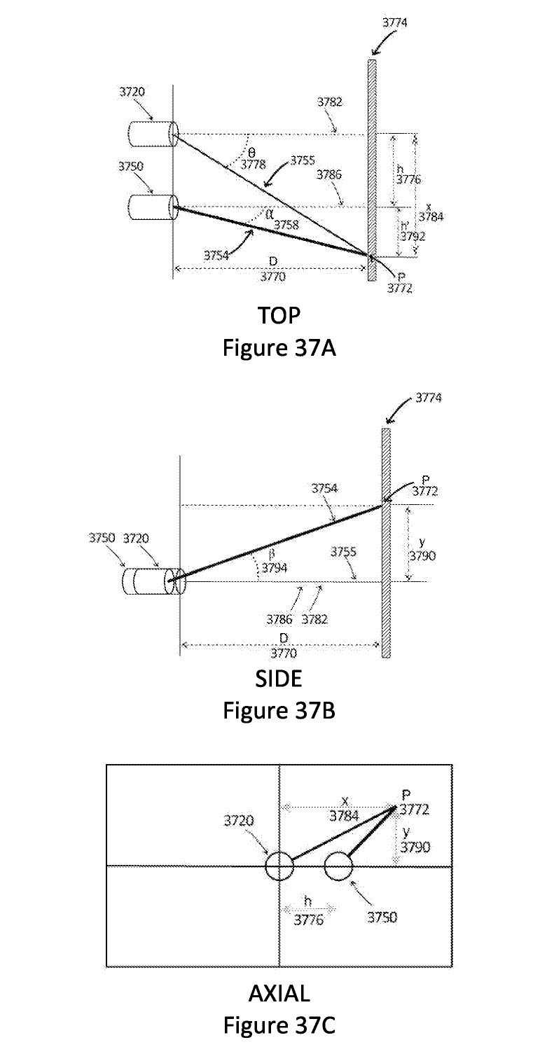

FIGS. 37 A, B and C show an example where in addition to the offset X 3784 of the outgoing laser beam 3754 there is also a vertical offset Y, 3790. With the numerals corresponding to the same numerals in FIG. 36, with the addition of Beta 3792, the vertical angle. This scenario is depicted in FIG. 37 A from a Top, FIG. 37 B Side, and FIG. 37 C from an Axial view.

To obtain both horizontal and vertical position information, it is sufficient to direct the spot with two known angles—angle α 3758 in the horizontal plane (as in case as shown above, and an angle β 3794 out of the plane—these are shown in the FIG. 37.

The distance to D 3770 is determined exactly as before in Equation above. The distance to D 3770 is known and the out of-plane angle θ 3792 of the directed spot, the vertical position y of the image spot P 3772 can be determined through:

y=D Tan(β)

The absolute position is known through equations above:

P=(D Tan(θ),D Tan(β),D).

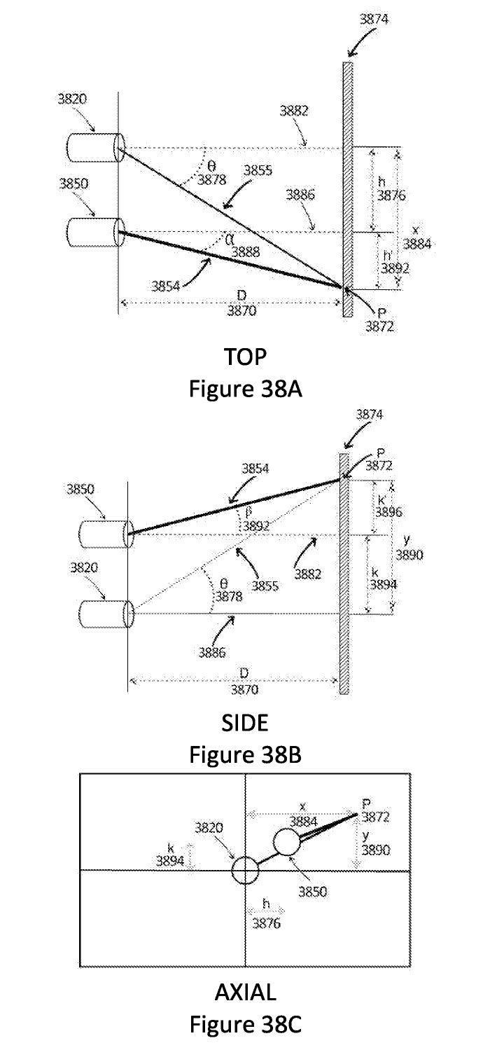

FIGS. 38 A, B and C further illustrates FIGS. 36 and 37, where there is an X and Y offset between the illumination device 3850 and the image sensor 3820. In this example, there is an additional offset k, 3894 shown in the axial view as the vertical distance between the image sensor 3820 and the illumination device 3850 and in the side view as the distance between the z axis of the image capture device 3820 and the z axis of the illumination device 3850. The variable k′ 3896 is also shown as the offset of the distance between illumination device 3850 z axis 3882 and the point P 3874 where the illumination pixel hits the object 3874.

Due to the possible 3-dimensional nature of objects to be imaged, it may be useful to have two “independent” measures of the distance D 3870. This can be accomplished by offsetting the directed spot in both the horizontal and vertical directions. This most general case is illustrated in FIGS. 38 A, B and C.

Since the directed spot is now offset a distance k 3894 in the vertical direction, there is an independent measure of D 3870 analogous to that in Equation above, using the vertical output angle of the directed spot, β 3892, and the angle φ, using the vertical separation between the directed spot at P and the center of the image sensor's field of view in the image:

D=k/[Tan(φ)−Tan(β)].

The vertical position y 3890 is now given by

y=D Tan(φ),

The absolute position of the image spot P=(D Tan(θ), D Tan(φ), D).

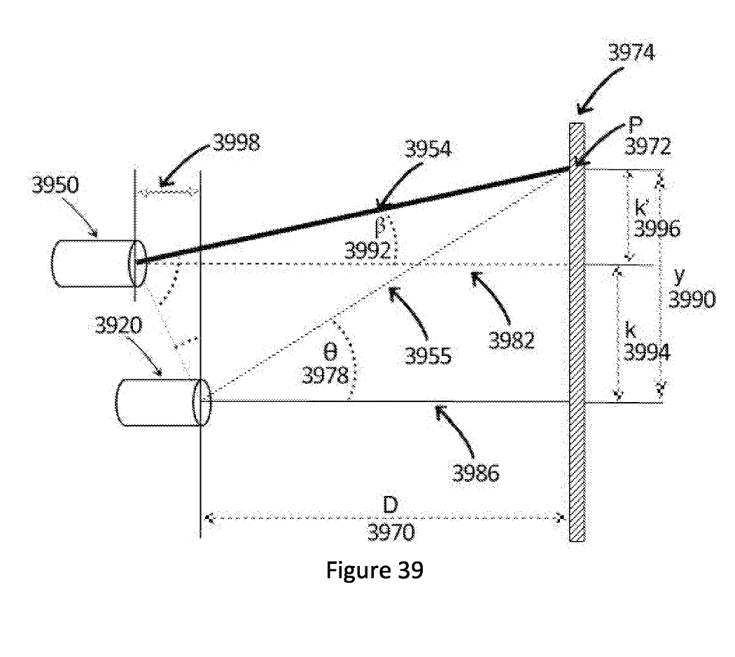

FIG. 39 shown an example embodiment similar to FIGS. 37-38 but in this example, there is an additional horizontal and vertical offset 3998 introduced where the directed illumination device is offset from the image sensor 3920 in the X, Y, and Z axis.

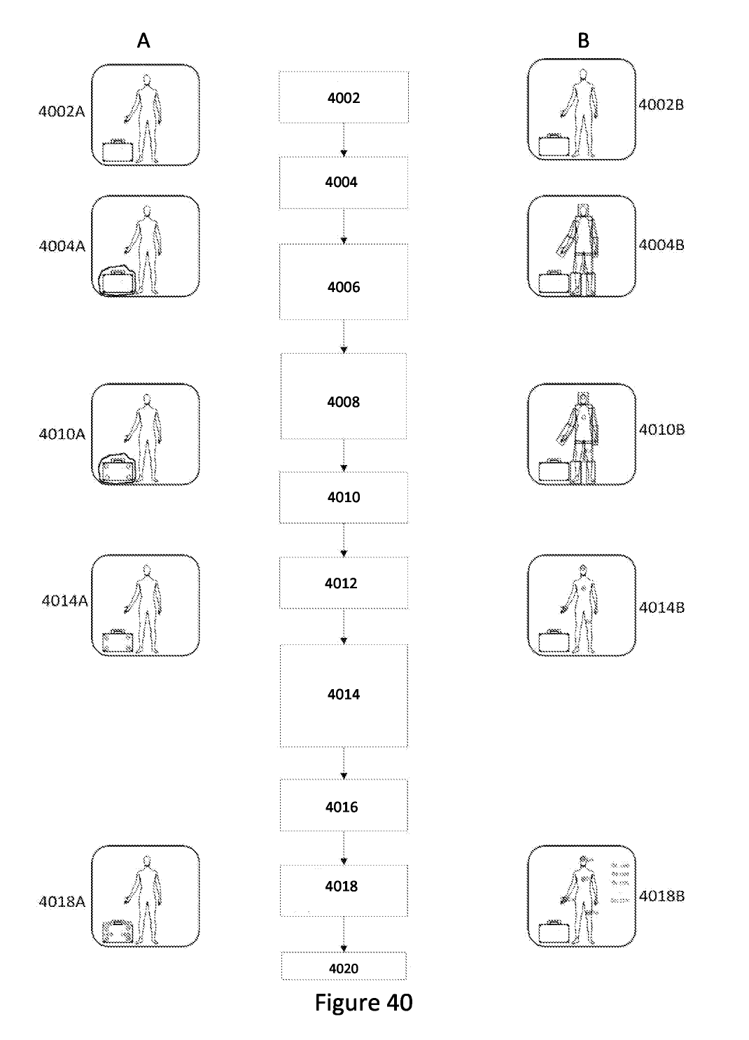

FIG. 40 illustrates the flow of information from identification of the point(s) to be measured through the calculation of the distance and display or passing of that information. Column A shows what a screen may look like if the human interface is responsible for image recognition. Column B shows a scenario where software is used to detect certain images. The center column describes what may happen at each section.

First, recognition occurs, 4002, where the camera or image sensor device is used to provide image data for analysis. Next, either the human or software is used to identify an area of interest 4004. Then, the system may assign to each area of interest, any number of things such as Pixel identification information, a unique identifier, a time stamp, and/or calculate or table angle, 4006. Next, the system and/or microprocessor may transmit a synchronizing signal to the image sensor, and pixel command to the illumination device 4008. The system may then illuminate the subject area with a spot of illumination, 4010. Then the image sensor may report the location of the pixels associated with the spot 4012. Next, the system and/or microprocessor may analyze the pixel values associated with imaged spot, match imaged pixel to illuminated spot and assign a location to pixel to calculate the angle value, 4014. Next, the microprocessor and/or system may calculate a value for depth, or distance from the system, 4016. Then the system may return a value for depth to the microprocessor for display, 4018. This is shown as a display of data on the example screen in 4018B. Then, the system may repeat the process 4020 as needed as the objects move over time.

Certain examples have the active FOV—Field Of View of the directed light and the capture FOV of the image sensor aligned for the calculations used in measuring distances. This calibration of the system may be accomplished using a software application.

According to some embodiments, input video data can be configured for streaming in a video format over a network.

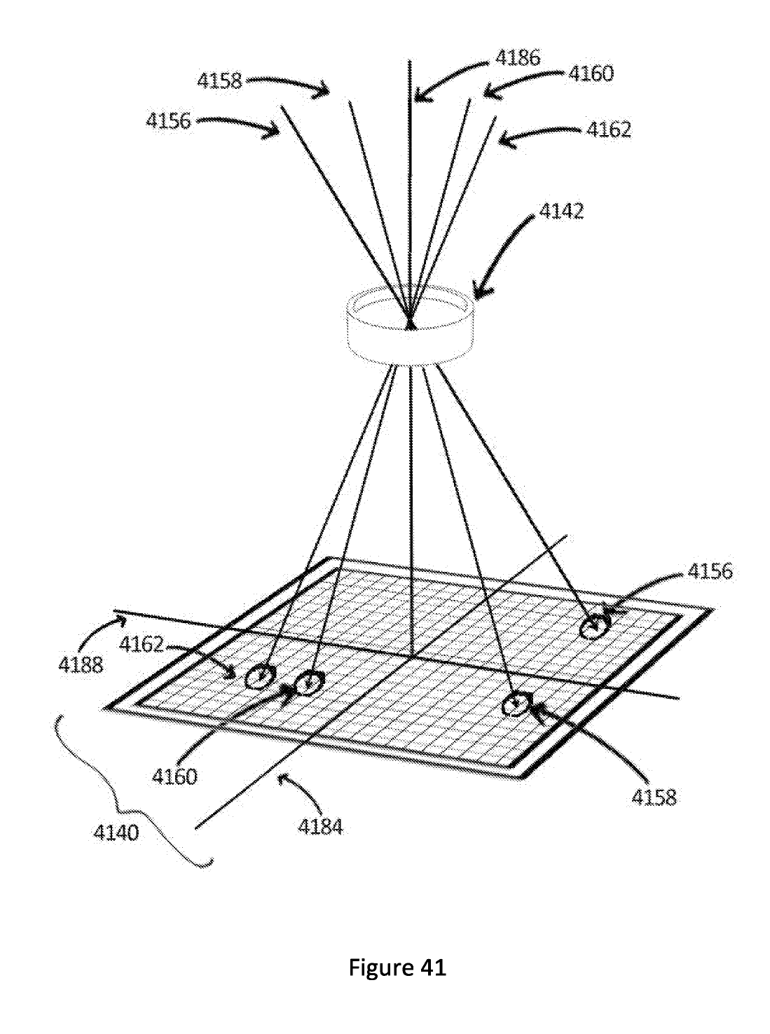

FIG. 41 shows an example image capture system embodiment. As the light, in this example, reflected laser light, is returned from reflecting off of the target, it passes through the lens 4142 and onto the image sensor 4140. The image sensor example here is made up of a number of cells, which, when energized by light, produce an electrical charge, which in turn may be mapped by the system in order to understand where that light source is located. The system can turn these charged cells into an image.

In this example, a returned reflected laser beam 4156, 4158, 4160, and 4162 returning from the area of interest along the center Z axis 4186 is identified by the CMOS or CCD image sensor 4140. Each point or pixel of light that is directed onto an area of interest, or target, may be captured with a unique pixel location, based on where the reflected light hits the image sensor 4140. Returning pixels 4156, 4158, 4160, 4162, represent examples of unique points with angular references different from 4186. That is, the reflected light beams are captured at different angles, relative to the z axis 4186. Each cell or pixel therefore has a unique coordinate identification and a unique set of angular values in relationship to the horizontal axis 4184 and the vertical axis 4188.

Not only can these reflected beams be used to map the image, as discussed, may be used to triangulate the distance of objects as well.

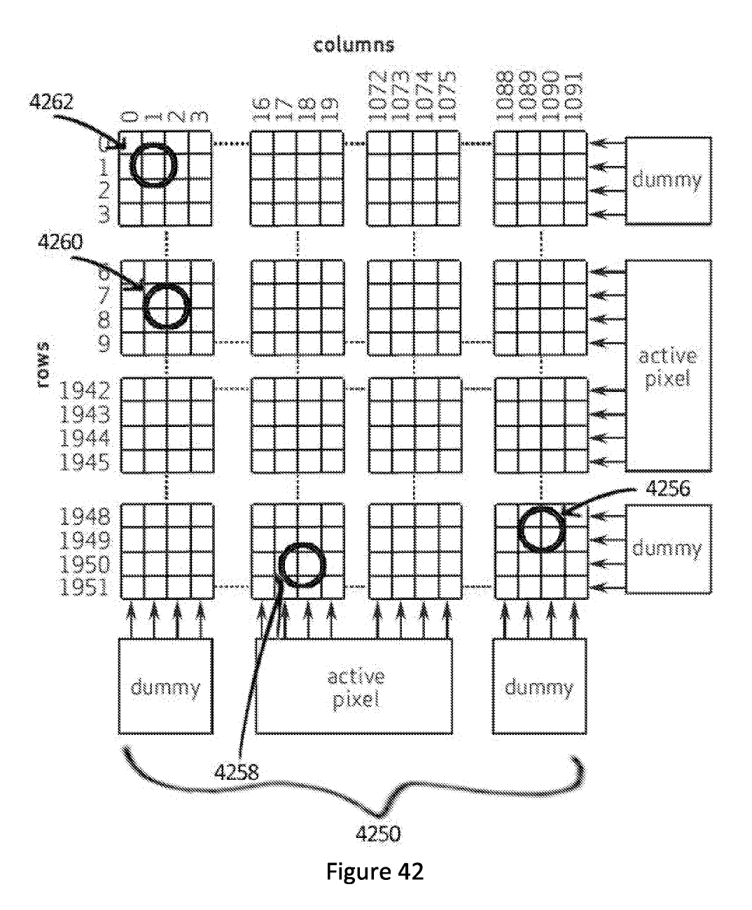

FIG. 42 illustrates an example image capture device that is using error correction to estimate information about the target object from which the light reflected. As was seen in FIG. 41, the reflected light hits certain cells of the image capture sensor. But in certain examples, the light does not strike the center of one sensor cell. Sometimes, in examples, the light strikes more than once cell or an intersection of more than one cell. The system may have to interpolate and estimate which of the cells receives the most of the returned light, or use different calculations and/or algorithms in order to estimate angular values. In some examples, the system may estimate where returning pixels 4256, 4258, 4260, 4262, will be captured by the image sensor 4250. In the case of pixel 4262 the light is centered on one pixel and/or cell and overflows partially onto eight adjacent pixels and/or cells. Pixel 4260 depicts the situation where the light is centered evenly across four pixels and/or cells. Pixels and/or cells 4256 and 4258 depict examples of the light having an uneven distribution across several pixels and/or cells of the image sensor 4250.

The probability that a projected spot will be captured on only one pixel of the image sensor is low. An embedded algorithm will be used to determine the most likely pixel from which to assign the angular value. In certain examples in FIG. 42 the imaged spot is centered on one pixel and overlaps eight others. The charged value of the center pixel is highest and would be used. In certain examples in FIG. 42, the spot is equally distributed over 4 pixels. In this case a fixed algorithm maybe used, selecting the top left pixel or lower right, etc. A more sophisticated algorithm may also be utilized where factors from prior frames or adjacent spots are incorporated into the equation as weighting factors. A third example may be where there is no one definite pixel. Charged weighting would be one method of selecting one pixel. A fixed algorithm could also be utilized. In another embodiment of this invention, a weighted average of the angular values could be calculated for imaged spot, creating new unique angular values.

Once the system has captured the reflected light energy, mapped it on the image sensor, the image sensor may send data information to the system for analysis and computations regarding mapping, distance, etc., for example.

Different example embodiments may utilize different sources of light in order to help the system differentiate the emitted and reflected light. For example, the system may polarize one laser beam pulse, send it toward an example target, and then change the polarization for all of the other pulses. In this way, the system may receive the reflected laser beam pulse, with the unique polarization, and be able to identify the location of the specific target, differentiated from all of the other returned beams. Any combination of such examples could be used to identify and differentiate any number of specific targets in the target field. These could be targets that were identified by the system or by human intervention, through an object recognition step earlier in the process, for example.

### Biometric Example Embodiments

In certain example embodiments, the system may be used to measure biometrics including a person's heartbeat if they are in the target area. This may be done with the system described here via various measurement techniques.

One such example may be because the human face changes reflectivity to IR depending upon how much blood is under the skin, which may be correlated to heart beat.

Another technique draws from Eulerian Video Magnification, a method for using identification of a subject area in a video, magnifying that area and comparing frame to frame motion which may be imperceptible to a human observer. Utilizing these technologies a system can infer a human heart beat from a distance of several meters. Some systems need to capture images at a high frame rate which requires sufficient lighting. Often times ambient lighting is not enough for acceptable image capture. One way to deal with this may include an embodiment here that uses directed illumination, according to the disclosures here, to be able to illuminate a specific area of a subject, thus enhancing the ability of a system to function in non-optimal lighting conditions or at significant distances.

Technologies that utilize a video image for determining biometric information may require particular illumination such that the systems can capture an acceptable video image at frame rates fast enough to capture frame to frame changes. Ambient lighting may not provide sufficient illumination, and augmented illumination may not be available or in certain circumstances it may not be desirable to provide high levels of visible light, such as a sleeping person, or where the subject is in crowded environment, or at a distance making conventional lighting alternatives unacceptable. Certain embodiments here include using illumination which can incorporate directing IR/NIR.

Such embodiments may determine distance and calibrate projected patterns onto a desired object or human, which may help determine surface contours, depth maps and generating point clouds. And in some embodiments, the system may direct illumination onto one or more areas of a human subject or object. Such a system to direct illumination may be controlled by a human or by software designed to recognize specific areas which require enhanced illumination. The system may work in conjunction with a CMOS, CCD or other imaging device, software which controls the projecting device, object and/or gesture recognition software or human interface, software which analyzes the video image and a microprocessor.

A human user, or the recognition software may analyze the image received from the image sensor, identify the subject or subjects of interest, assign one or more areas which require augmented or enhanced illumination. The system may then direct illumination onto those specifically identified areas. If the system is integrated with motion track capabilities, the illumination can be changed with each frame to match the movement of the subject area. The imaging system may then capture the video image and transfer that to the analysis software. Changes to the position, size and intensity of the illumination can be made when the analysis software may even provide feedback to the software controlling the illumination. Analysis of the processed video images may be passed onto other programs and applications.

Embodiments of this technology may include the use of color enhancement software which allows the system to replace the levels of gray scale produced in a monochromatic IR image with color equivalents. In such an example, software which utilizes minute changes in skin color reflectivity may not be able to function with a monochromatic image file. When the gray scale is replaced by assigned color, the system may then be able to interpret frame to frame changes.

Example embodiments may be used for collecting biometrics such as heart/pulse rate from humans and other living organisms. Examples of these can be a sleeping baby, patients in intensive care, elderly patients, and other applications where non-physical and non-light invasive monitoring is desired.

Example embodiments here could be used in many applications. For instance, example embodiments may be used for collecting information about non-human living organisms as well. For example, some animals cannot easily be contained for physical examination. This may be due to danger they may pose to humans, physical size, or the desire to monitor their activity without disturbing them. As another example, certain embodiments may be used for security systems. By isolating an individual in a crowd, a user could determine if that isolated target had an elevated heart rate, which could indicate an elevated level of anxiety. Some other example embodiments may be used for monitoring inanimate objects in non-optimal lighting conditions, such as production lines, and inventory management, for example.

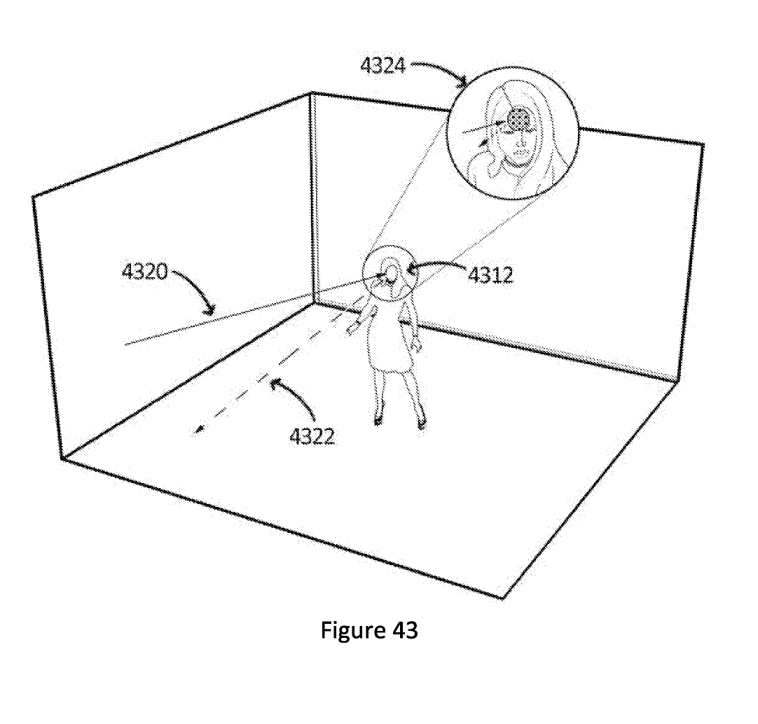

FIG. 43 illustrates an example embodiment where the biometric of a human target 4312 is desired from a distance of several meters. The distance could vary depending on the circumstances and level of accuracy desired, but this example is one of several meters. In this example, recognition software could identify an area of interest, using object recognition methods and/or systems. The coordinates of the target object may then be sent to the illumination device controlling the directed illumination 4320. The example laser beam 4320 may then be sent to and reflected 4322 to be captured by an image sensor (not pictured), and transmitted to the system for analysis. The illumination can be adjusted to optimally illuminate a specific area as depicted in the figure detail 4324 showing an example close up of the target and reflection off of a desired portion of the target person 4312.

This example beam could be motion tracked to follow the target, adjusted, or redirected depending on the circumstances. This may allow for the system to continue to track and monitor an identified subject area even if the object is in motion, and continue to gather biometric information and/or update the information.

### Sequential Triangulated Depth Map Example Embodiments

Certain example embodiments here include the ability to create sequential triangulated depth maps. Such depth maps may provide three-dimensional representation of surfaces of an area based on relative distance from an area to an image sensor. The term is related to and may be analogous to depth buffer, Z-buffer, Z-buffering and Z-depth, for example. Certain examples of these provide the Z or distance aspect as a relative value as each point relates to another. Such example technologies may incorporate a method of using sequentially triangulated points. A system that utilizes triangulation may generate accurate absolute distances from the device to the surface area. Furthermore, when the triangulated points are placed and captured sequentially, an accurate depth map of an area may be generated.

As described above, certain embodiments here may direct light onto specific target area(s), and more specifically to an interactive projected illumination system which may enable identification of an illuminated point and calculation of the distance from the device to that point by using trigonometric calculations referred to as triangulation.

According to some embodiments, a system may direct illumination onto a target area using projected points of light at specific intervals along a horizontal axis then steps down a given distance and repeats, until the entire area is scanned. Each pixel may be unique and identified and matched to an imaged pixel captured by an image sensor. The uniqueness of each pixel may be from a number of identifiers. For example, each projected pixel may have a unique outbound angle and each returning pixel also has a unique angle. Thus, for example, the angles combined with a known distance between the point of directed illumination may enable the system to calculate, using triangulation the distance to each point. The imaged pixel with and assigned Z, depth or distance component can be further processed to produce a depth map and with additional processing a point cloud.

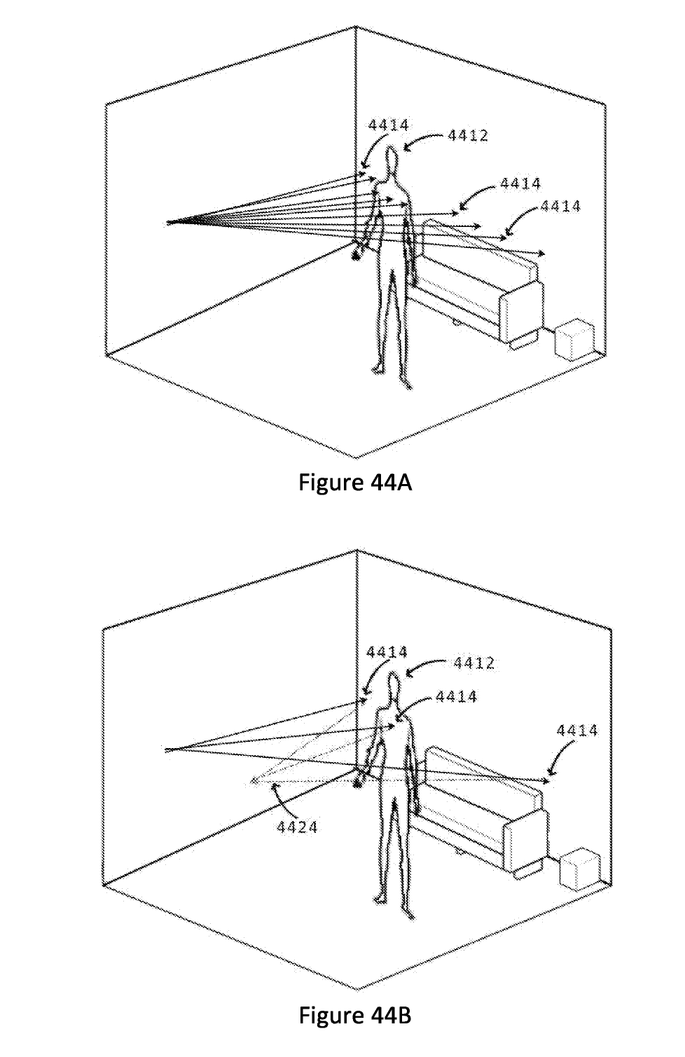

FIG. 44A illustrates an example embodiment generating one row of points 4414 with a human subject 4412 also in the room. In this example, each point illuminated has unique and known angular value from its projection. And each point in this example has a unique sequential value based on time and location. These points can be timed and spaced so as to prevent overlap or confusion by the system.

FIG. 44B illustrates example reflected pixels 4424. These reflected points are captured by an image sensor. In this example, each imaged pixel also has unique identifies such as angular values and time, as in FIG. 44A.

Thus, in this example embodiment, the unique identification of projected pixels and captured pixels may allow the system to match a projected point with an imaged point. Given the known angles and distance between the source of directed illumination and the image capturing device, by use of triangulation described above, distance can be calculated from the device to the surfaces in the field of view. This depth or distance information, “Z,” can be associated with a corresponding imaged pixel to create a depth map of the scanned target area or objects. Further processing of the depth map can produce a point cloud. Such example depth maps or point clouds may be utilized by other software systems to create three dimensional or “3D” representations of a viewed area, object and human recognition, including facial recognition and skeletal recognition. Thus, the example embodiments may capture data in order to infer object motion. This may even include human gesture recognition.

Certain example embodiments may produce the illumination scans in various ways, for example, a vertical scan which increments horizontally. Additionally, certain embodiments may use projected points that are sequential but not equally spaced in time.

Some embodiments may incorporate a random or asymmetric aspect to the pattern of points illuminated. This could enable the system to change points frame to frame and through software fill in the gaps between imaged pixels to provide a more complete depth map.

And some example embodiments either manually or as a function of the software, selectively pick one or more areas within a viewed area to limit the creation of a depth map. By reducing the area mapped, the system may run faster having less data to process. The system may also be dynamically proportioned such that it may provide minimal mapping of the background or areas of non or lesser interest and increase the resolution in those areas of greater interest, thus creating a segmented or hybrid depth map.

### Augmented Reality

Certain example embodiments could be used to direct the projection of images at targets. Such an example could using directed illumination incorporating IR/NIR wavelengths of light to improve the ability of object and gesture recognition systems to function in adverse lighting conditions. Augmented reality refers to systems that allow the human user to experience computer generated enhancements to real environments. This could be accomplished with either a monitor of display, or through some form of projected image. In the situation of a projected image, a system could work in low light environments to avoid the projected image from being washed out by ambient light sources. When combined with a directed illumination device that operates in the IR/NIR wavelengths, recognition systems can be given improved abilities to identify objects and motion without creating undesirable interference with projected images. Such example object recognition, object tracking and distance measuring are described elsewhere herein and could be used in these example embodiments to find and track targets.

Multiple targets could be identified by the system, according to the embodiments disclosed herein. By identifying more than one target, the system could project different or the same image on more than one target object, including motion tracking them. Thus, more than one human could find unique projections on them during a video game, or projected backgrounds could illuminate walls or objects in the room as well, for example.

Once found and tracked, the targets could be illuminated with a device that projects various images. This projector could be integrated with the tracking and distance systems or a separate device. Either way, in some embodiments, the two systems could be calibrated to correct for differences in projected throw angles.

Any different kind of projection could be sent to a particularly identified object and/or human target. The projected image could be monochrome or multicolored. In such a way, the system could be used with video games to project images around a target area. It could also have uses in medicine, entertainment, automotive, maintenance, education and security, just as examples.

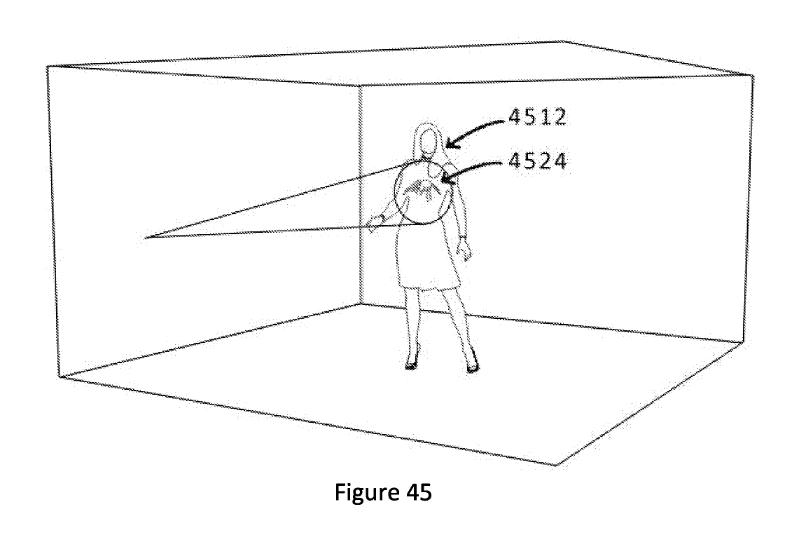

FIG. 45 illustrates an example embodiment showing an interactive game scenario. In this example embodiment, the directed illumination has enabled recognition software to identify where a human 4512 is located in the field of view and has been identified by the system according to any of the example ways described herein. The software may also define the basic size and shape of the subject for certain projections to be located. The example system may then adjust the image accordingly and projects it onto the subject, in this example an image of a spider 4524.

### Eye Safety Example Embodiment

Certain example embodiments here include the ability to recognize areas or objects onto which projection of IR/NIR or other illumination is not desired, and block projection to those areas. An example includes recognizing a human user's eyes or face, and keeping the IR/NIR projection away from the eyes or face for safety reasons.

Certain example embodiments disclosed here include using directed illumination incorporating IR/NIR wavelengths of light for object and gesture recognition systems to function in adverse lighting conditions. Any system which utilizes light in the infrared spectrum when interacting with humans or other living creatures has the added risk of eye safety. Devices which utilize IR/NIR in proximity to humans can incorporate multiple ways of safeguarding eyes.

According to some embodiments, light is projected in the IR/NIR wavelength onto specifically identified areas, thus providing improved illumination in adverse lighting conditions for object or gesture recognition systems. The illuminated area may then be captured by a CMOS or CCD image sensor. The example embodiment may identify human eyes and provide the coordinates of those eyes to the system which in turn blocks the directed illumination from beaming light directly at the eyes.

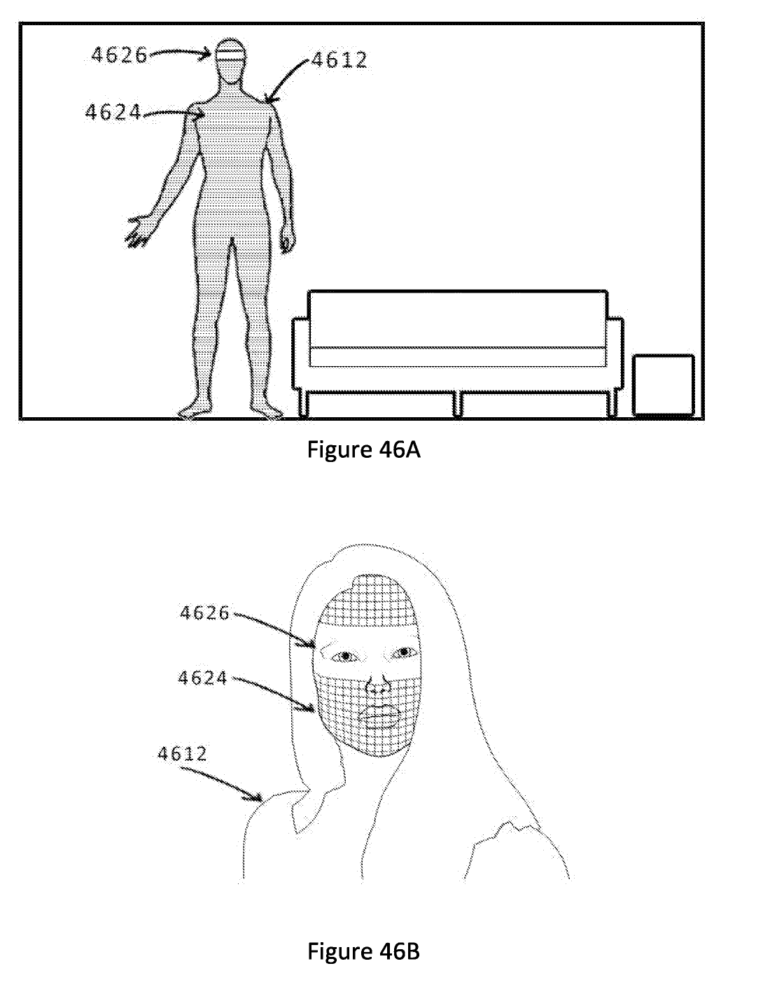

FIGS. 46A and 46B illustrate examples of how the system may be able to block IR/NIR projection to a human subject's eyes. For example, the image is captured with a CMOS or CCD image sensor and the image is sent to a microprocessor where one aspect of the software identifies the presence of human eyes in the field of view. The example embodiment may then send the coordinates of the eyes to the embodiment which controls the directed illumination. The embodiment may then create a section of blocked or blank illumination, as directed. As the directed illumination is scanned across a blanked area the light source is turned off. This prevents IR/NIR light from beaming directly into the eyes of a human.

FIG. 46A is an example of a human subject 4612 with projected illumination 4624 incorporating eye blocking 4626.

FIG. 46B is an example of a close up of human subject 4612 with a projected illumination incorporating 4624 eye blocking 4626.

There may be other reasons to block certain objects in the target area from IR/NIR or other radiation. Sensitive equipment may be located in the target area, that directed IR/NIR could damage. Cameras may be present, that flooding the sensors with IR illumination, may wash the camera out or damage the sensors. Any kind of motivation to block the IR/NIR could drive the embodiment to block out or restrict the amount of IR/NIR or other illumination to a particular area. Additionally, the system could be configured to infer eye location by identifying other aspects of the body. An example of this may be to recognize and identify the arms or the torso of a human target and calculate a probable relative position of a head and reduce or block the amount of directed illumination accordingly.

Certain example embodiments here include the ability to adjust the size of the output window and the relative beam divergence as it relates to the overall eye safe operation of the device. The larger the output window of the device, which represents the closest point a human eye can be placed relative to the light source, and/or the greater the divergence of the throw angle of the scanned beam, the less IR/NIR can enter the eye over a given period of time. A divergent scanned beam has the added effect of increasing the illuminated spot on the retina, which reduces the harmful effect of IR/NIR over the same period of time.

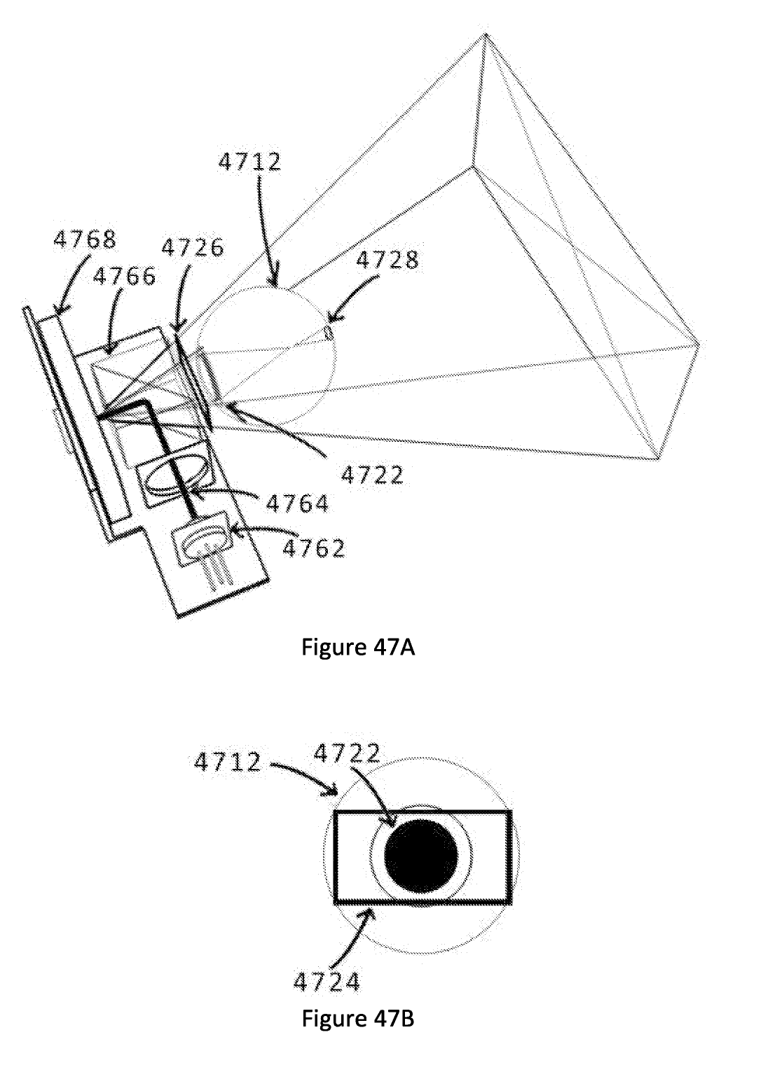

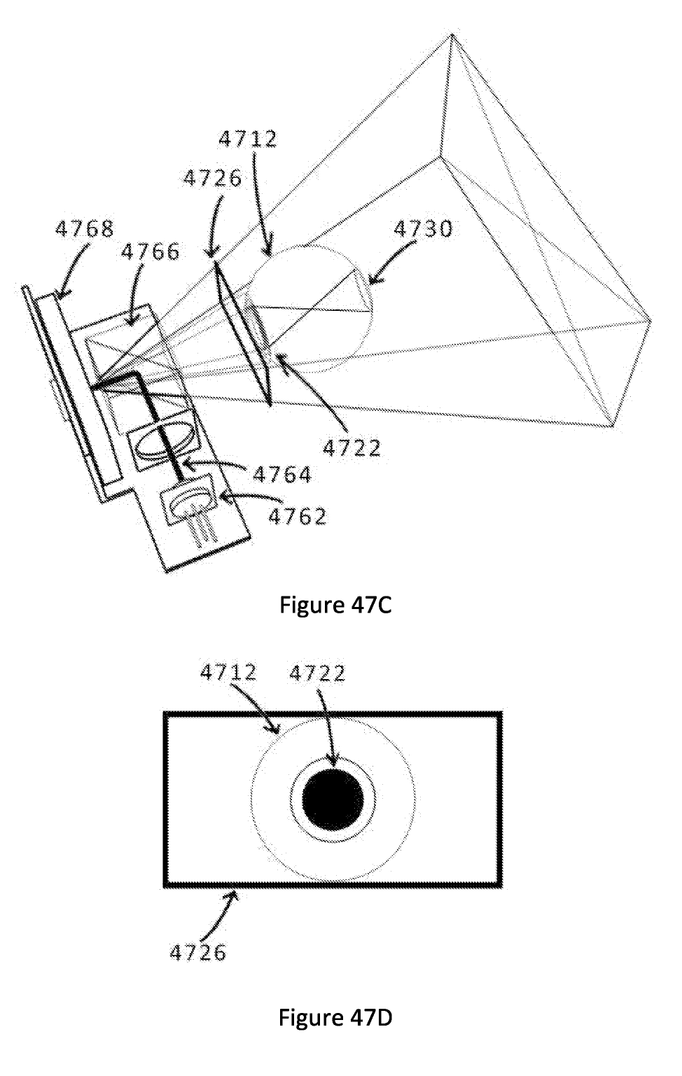

FIGS. 47A and 47B illustrate the impact of output window size to the human eye 4722. Safe levels of IR are determined by intensity over area over time. The lower the intensity is for a given period of time, the safer the MPE or maximum permissible exposure is. In 47B where the output window 4724 is relatively the same height as the pupil 4722, in this example an output window 7 mm tall by 16 mm wide and the average dilated pupil is 7 mm, approximately 34.4% of the light exiting the output window can enter the eye. If the output window is doubled in size 4726 to 14 mm tall and 32 mm wide, the maximum light that could enter the pupil drops to 8.6% as illustrated in FIGS. 47C and 47D, for example.

FIG. 47A is a detailed illustration of 47B showing the relationship of elements of the device to a human eye at close proximity. Light from a semiconductor laser 4762 or other light source passes through optical element 4766 and is directed onto a 2D MEMs 4768 or other device designed to direct or steer a beam of light. The angular position of the MEMs reflects each pixel of a raster scanned image with a unique angle which creates an effective throw angle of each scan or frame of illumination. The scanned range of light exits the device through an output window 4726 which dimensionally matches the image size of the scanned area. The human eye 4712 is assumed to be located as close as possible to the exit window. A portion of the light from the exit window can enter the pupil 4722 and is focused on the back or retina of the eye 4728. The angular nature of each sequential pixel causes the focused are to be larger than that of a collimated beam. This has the same effect as if the beam had passed through a divergent lens.

FIG. 47C is a detailed illustration of 47D showing the relationship of elements of the device to a human eye at some distance. Light from a semiconductor laser 4762 or other light source passes through optical element 4766 and is directed onto a 2D MEMs 4768 or other device designed to direct or steer a beam of light. The angular position of the MEMs reflects each pixel of a raster scanned image with a unique angle which creates an effective throw angle of each scan or frame of illumination. The scanned range of light exits the device through an output window 4726 which dimensionally matches the image size of the scanned area. The human eye 4712 is assumed to be located as close as possible to the exit window. A portion of the light from the exit window can enter the pupil 4722 and is focused on the back or retina of the eye 4730. The angular nature of each sequential pixel causes the focused are to be larger than that of a collimated beam. This has the same effect as if the beam had passed through a divergent lens. The grater the throw angle of the device, the more small changes in the distance of the output window to the MEMs will result in a positive effect on reducing the total amount of light which can enter the eye.

An embodiment of this technology incorporates the ability for the device to dynamically adjust the effective size of the output window. By controlling the MEMs in such a way as to change the throw angle or changing the horizontal and vertical scan rates, the system can effective adjust the output window to optimize the use of directed illumination while maximizes the eye safety.

Certain embodiments here also may incorporate adding the distance from the device to the human and calibrating the intensity of the directed illumination in accordance with the distance. In this embodiment even if the eyes are not detectable, a safe level of IR/NIR can be utilized.

### Color Enhanced IR

Certain example embodiments here may include color variation of the projected illumination. This may be useful because systems using directed illumination may incorporate IR/NIR of light. These are outside of the spectrum of light visible to humans. When this light is captured by a CMOS or CCD imaging sensor may generate a monochromatic image normally depicted in a black and white or gray scale. Humans and image processing systems may rely on color variation to distinguish edges, objects, shapes and motion. In situations where IR/NIR directed illumination works in conjunction with a system that requires color information, specific colors can be artificially assigned to each level of grey for display. Furthermore by artificially applying the color values, differentiation between subtle variations in gray can be emphasized thus improving the image for humans.

According to certain embodiments, directing illumination in the IR/NIR wavelength onto specifically identified areas, may provide augmented illumination, as disclosed in here. Such an example illumination may then be captured by a CMOS or CCD image sensor. In certain embodiments, the system may then apply color values to each shade of gray and either passes that information onto other software for further processing or displays the image on a monitor for a human observer.

Projected color is additive, adding light to make different colors, intensity, etc. For example, 8 bit color provides 256 levels for each projection device such as a lasers or LEDs, etc. The range is 0-255 since 0 is a value. For example, 24 bit color 8×3 results in 16.8 million colors.

Referring to IR/NIR, the system processing the IR/NIR signals may return black, white and shades of gray in order to interpret the signals. Many IR cameras produce 8 bit gray scale. And it may be very difficult for a human to discern the difference between gray 153 and gray 154. Factors include the quality and calibration of the monitor, the ambient lighting, the observer's biological sensitivity, number of rods versus cones in the eye, etc. The same problem exists for gesture and object recognition software—it has to interpret grey scale into something meaningful.

Embodiments here include the ability to add back color values to the grey scales. The system may set grey 153 to be red 255 and 154 to be green 255, or any other settings, this being only one example. Using various assignment methods and systems, color levels may be assigned to each grey scale value. For example, everything below 80 gets 000 or black and everything above 130 gets, 255,255,255 white and the middle range is expanded.

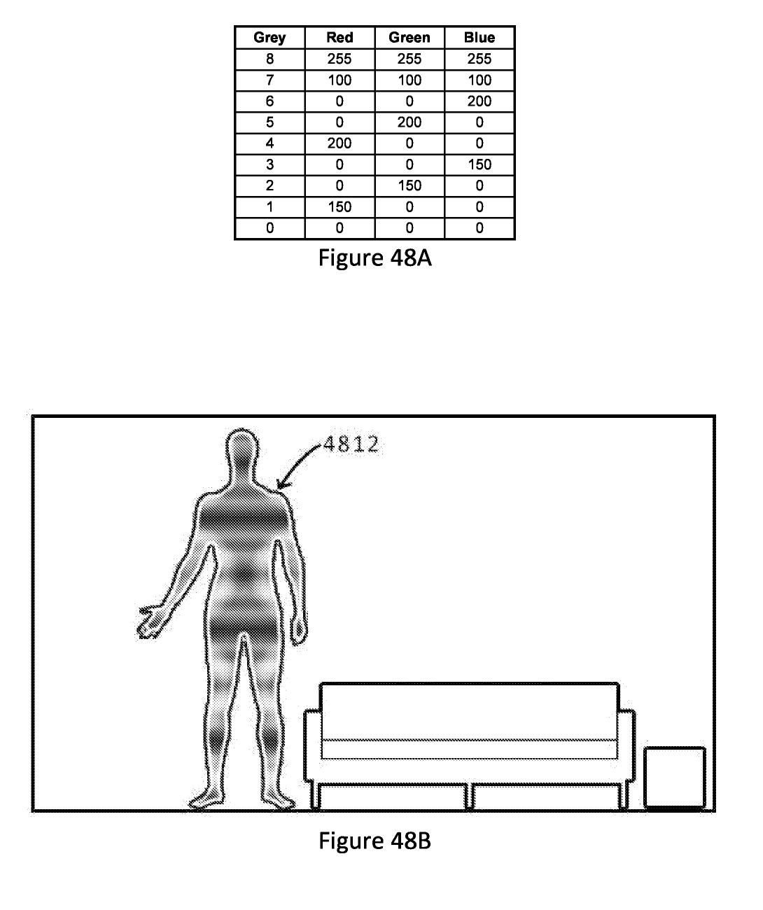

FIG. 48A illustrates a nine level gray scale with arbitrarily assigned R—red G—green B—blue values using an 8 bit RGB additive index color scale. Because the assignment of color to gray is artificial the scale and assignments can be in formats that are best matched to the post enhancement systems. Any variation of assigned colors may be used, the example shown in FIG. 48A is illustrative only.

FIG. 48B illustrates an example image captured inclusive of a subject 4812 which has been color enhanced according to the assignments of color from FIG. 48A. Thus, the colors, Red, Green and Blue show up in the amounts indicated in FIG. 48A, according to the level of grey scale assigned by the example system. Thus, for example, if the monochrome system assigned a pixel a grey scale of 5, the system here would assign 0 Red, 0 Blue and 200 Green to that pixel, making it a certain shade of green on the display of 48B. A grey scale assignment of 1 would assign 150 Red, 0 Green and 0 Blue, assigning a certain shade of red to the pixels with that grey scale value. In such a way, the grey scale shading becomes different scales of colors instead of a monochrome scale.

And some example embodiments could include the display of the color could apply color enhancement to select areas only, once a target is identified and illuminated. Some embodiments may enable a nonlinear allocation of color. In such an embodiment, thresholds can be assigned to the levels. An example of this could be to take all low levels and assign them the same color or black, thus extenuating a narrower range of gray.

And certain example embodiments could include identification of a particular target by a human user/observer of the displayed image to be enhanced. This could be accomplished with a mouse, touch screen or other gesture recognition which would allow the observer to indicate an area of interest.

### Square Wave Propagation

Certain embodiments here also include the ability to utilize propagation of a light-based square wave, and more specifically an interactive raster scanning system/method for directing a square wave. In such a way, directed illumination and ToF—Time-Of-Flight imaging may be used to map and determine distance of target objects and areas.

Square waves are sometimes used by short range TOF or time-of-flight depth mapping technologies. For example, an array of LEDs may be turned on an off at a certain rate, to create a square wave.

In some embodiments, the LEDs may switch polarity to create waves of light with square waves of polarity shifted. In some embodiments, when these waves bounce off or reflect off objects, the length of the wave may change. This may allow Current Assisted Photon Demodulating (CAPD) image sensors to create a depth map.

In certain examples, projected light from LEDs may not be suitable for generating square waves without using current modulation to switch the polarity of the LEDs, thus resulting in optical switching. In such embodiments, a single Continuous Wave (CW) laser may be pulsed at high rates, for example 1.1 nanoseconds, and adjust the timing such that a sweeping laser may create a uniform wave front.

Some example embodiments here include using a directed single laser beam which is configured to produce a raster scan based on a 2D MEMs or similar optical steering device. In this example, a continuous wave laser such as a semiconductor laser which can be either amplitude modulated or pulse width modulated, or both, is used as the source for generating the square wave. Also, in this example embodiment, a raster scan can form an interlaced, de-interlaced, or progressive pattern. When the laser is reflected off of a beam steering mechanism capable of generating a raster scan, an area of interest can be fully illuminated during one complete scan or frame. Some raster scans are configured to have horizontal lines made up of a given number of pixels and a given number of horizontal lines. In such an example, during each pixel the laser can be turned on. The on time as well as the optical power or amplitude of each pixel may be controlled by the system, generating one or more pulses of a square wave. In this example, when timed such that the pulses for each sequential pixel are in phase with the desired wave format, they may generate a wave front that will appear to the imaging system as if generated as a single wave front.

In some embodiments, further control over the placement of the square wave may be accomplished where a human/user or a system may analyze the reflected image received from the image sensor, and help identify the subject or subjects of interest. The system may then control the directed illumination to only illuminate a desired area. This can reduce the amount of processing required by the imaging system, as well as allow for a higher level of intensity, which also improves the system performance.

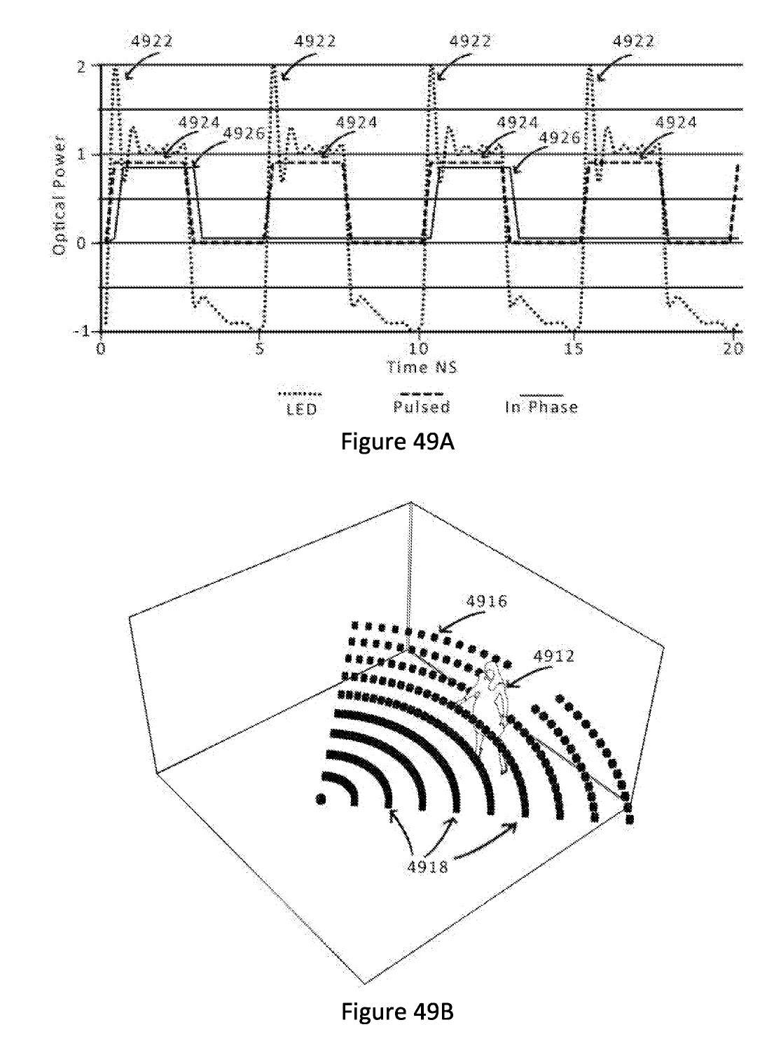

FIG. 49A is an example representative graph which shows four cycles of an example square wave. Dotted line 4922 shows a sample wave generated gain shifted LED. Dashed line 4924 represents an example pulse which is generated by an example semiconductor laser. These example lasers may have switching time that are beneficial to such a system and allow for particular square wave propagation, as shown, with less or nearly no noise on the wave propagation. Solid line 4926 illustrates how the example pulses may be kept in phase if the constraints of the system prevent sequential pulses.

FIG. 49B illustrates an example target area including a target human FIG. 4912 in an example room where a propagated square wave generated by system for directed illumination 4916 is used. In such a way, an example embodiment may use an optical switching mechanism to switch a laser on and off, producing clean pulses to reflect off of a target. In an example where in-phase pulses are used, they may form uniform wave fronts 4918. Thus, the returning, reflected waves (not pictured) can then be captured and analyzed for demodulation of the square waves. Additionally, certain embodiments include using gain switching to change the polarity of the laser, creating on and off pulses at various intervals.

### Dynamically Calibrated Projected Patterns for 3D Surface Imaging

There are many elements which impact the performance of 3D surface imaging methodologies which rely on the projection of patterns of light onto a subject. These systems analyze the captured image of the patterns on the subject through various algorithms. These algorithms derive information which allows those systems to generate depth maps or point clouds, data bases which can be used by other systems to infer three dimensional characteristics of a two dimensional image. This information can be further processed to extract such information as gesture, human, facial and object recognition.

Factors which these methodologies and others not described here have in common are the need to optimize the pattern projected onto a subject. The frequency of the pattern, or number of times it repeats, number of lines, and other aspects of the pattern effect the system's ability to accurately derive information. Alternating patterns in some examples are necessary to produce the interference or fringe patterns required for the methodology's algorithm. In other methods the orientation of the patterns projected onto subject and the general orientation of the subject influences various characteristics related to optimal data extraction.

The ability to dynamically adjust the projected patterns on a subject may improve the accuracy, which is the deviation between calculated dimensions and actual, as well as resolution, the number of final data points, and increase information gathering and processing speeds.

Certain embodiments here include the ability to direct light onto specific target area(s), determining distance to one or more points and calibrating a projected pattern accordingly. This may be done with directed illumination and single or multipoint distance calculation used in conjunction with projected patterns including structured light, phase shift, or other methods of using projected light patterns to determine surface contours, depth maps or generation of a point clouds.

For example, a projected pattern from a single source will diverge the further it is from the origin, this is known as the throw angle. As a subject moves further away from the projector, the projected pattern will increase in size, because of the divergence. And, as a subject gets further away from a camera, the subject will occupy a smaller portion of the imaged area as a result of the FOV or viewing angle of the camera. The combined effect of the projected throw angle and the captured FOV may increase the distortion of the projected image. Thus, a calibrated projection system may be helpful to map an area and objects in an area where objects may have different locations from the camera.

A system that incorporates directed illumination with the ability to determine distance from a projector to one or more subject areas is used to statically or dynamically adjust projected patterns, as disclosed above. Further, some example embodiments may be able to segment a viewed area and adjust patterns accordingly to multiple areas simultaneously. Such example embodiments may analyze each segment independently and combine the results to create independent depth maps or combine independent depth maps into one. And such example embodiments may be used to determine if a flat wall or background is present and eliminate the background from either being projected upon or be removed in post processing.

An embodiment of this system incorporates a system for detecting when either a projected or captured frame is corrupted, or torn. Corruption of a projected or captured image file may result from a number of errors introduced into the system. In this example of a corrupt frame of information the system can recognize that either a corrupt image has been projected or that a corrupted image has been captured. The system then may identify the frame such that later processes can discard the frame, repair the frame or determine if the frame is useable.

Some embodiments here may determine depth, 3D contours and/or distance and incorporate dynamically calibrating the patterns for optimization. Such examples may be used to determine distance and calibrate projected patterns onto a desired object or human, which may help determine surface contours, depth maps and generating point clouds.

According to certain embodiments, one or more points or pixels of light may be directed onto a human subject or an object. Such direction may be via a separate device, or an integrated one combined with a projector, able to direct projected patterns which can be calibrated by the system. The patterns may be projected with a visible wavelength of light or a wavelength in IR/NIR. The projector system may work in conjunction with a CMOS, CCD or other imaging device, software which controls the projecting device; object and/or gesture recognition software or human interface and a microprocessor as disclosed herein.

### Structured Light for Surface Imaging

For example, a human/user or the recognition software analyzes the image received from the image sensor, identifies the subject or subjects of interest, assigns one or more points for distance calculation. The system may calculate the distance to each projected point. The distance information may be passed onto the software which controls the projected pattern. The system may then combine the distance information with information about the relative location and shape of the chosen subject areas. The system may then determine which pattern, pattern size and orientation depending on the circumstances. The projector may then illuminate the subject areas with the chosen pattern. The patterns may be captured by the image sensor and analyzed by software which outputs information in the form of a 3D representation of the subject, a depth map, point cloud or other data about the subject, for example.

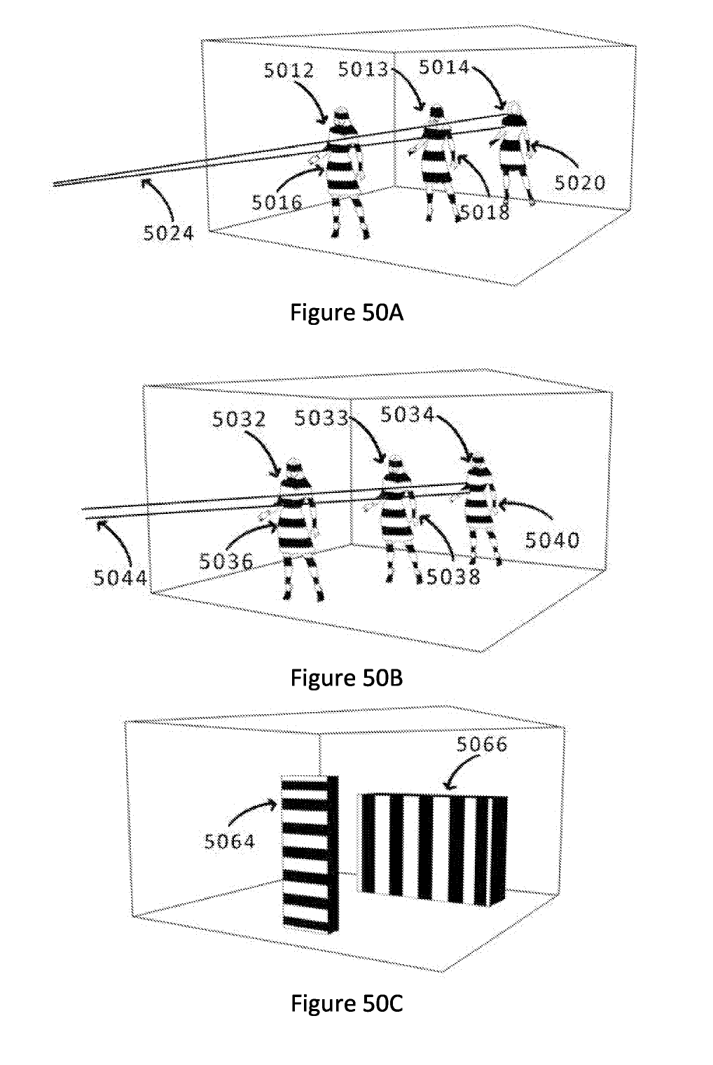

FIG. 50A illustrates an example embodiment using non-calibrated phase shift patterns projected onto human subjects 5012, 5013, and 5014. The effect of the throw angle as indicated by reference lines 5024 is illustrated as bands 5016, 5018, and 5020. In this example, the further from the point of origin the subject is, the wider the band becomes and the fewer bands are projected on to the subject.

FIG. 50B illustrates an example embodiment, similar to 50A but where the pattern has been calibrated. Thus, in 50B, the phase shift pattern is projected onto human subjects 5032, 5033, and 5034. Using these calibrated patterns, the example system may determine the distance from the subjects of interest to the image sensor and generates a uniquely calibrated pattern for each subject. In this example, patterns 5036, 5038, and 5040 are calibrated such that they will produce the same number and line characteristics on each subject. This may be useful for the system to use in other calculations as described herein.

Continuing to refer to FIG. 50B, there may be multiple subjects at varying distances from the device. In such instances the system can segment the area and project uniquely calibrated patterns onto each subject. In such a way, segmented depth maps can be compared and added together to create a complete depth map of an area. And in such an example, the distance calculating ability of the system can also be used to determine the existence of a wall and other non-critical areas. The example system may use this information to eliminate these areas from analysis.

FIG. 50C illustrates an example embodiment showing an ability to determine the general orientation of an object, in this example a vertical object 5064 and a horizontal object 5066. In this example, phase shifting is optimized when the patterns run perpendicular to the general orientation of the subject. The example system may identify the general orientation of a subject area and adjust the X, Y orientation of the pattern. The pattern projected in FIGS. 50A, B and C are exemplary only. Any number of patters may be used in the ways described here.

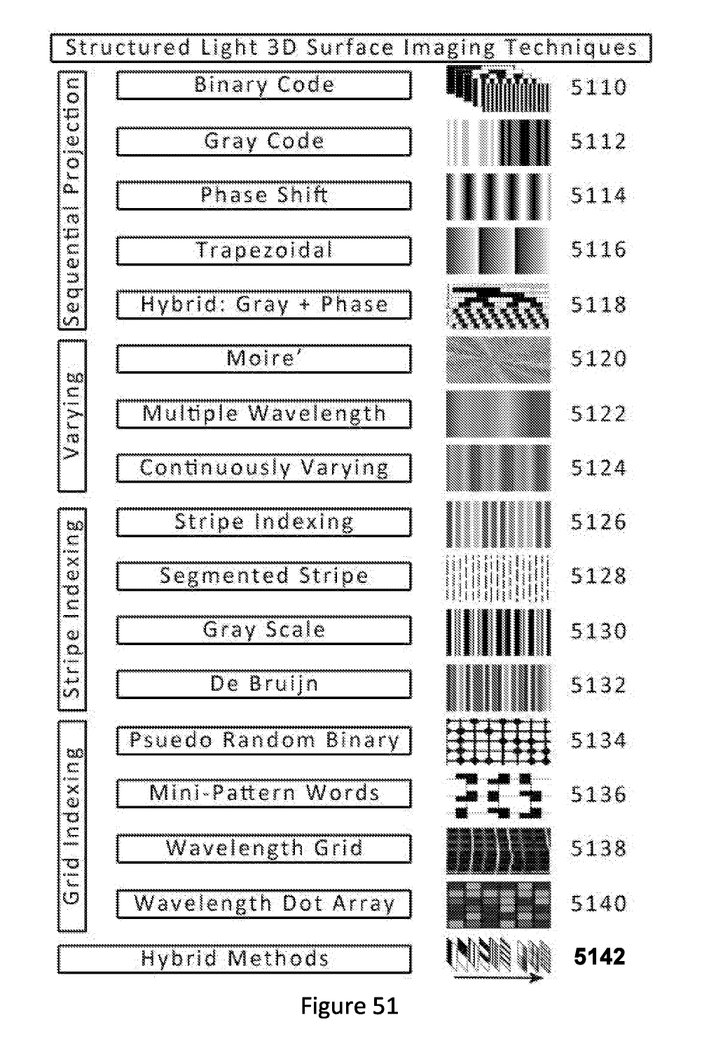

FIG. 51 shows a table depicting some examples of projected patterns that can be used with dynamic calibration. These examples discussed below are not meant to be exclusive of other options but exemplary only. Further, the examples below only describe the patterns for reference purposes and are not intended as explanations of the process nor the means by which data is extracted from the patterns.

One embodiment example of this is sequential binary coding, 5110, is comprised of alternating black (off) and white (on) stripes generating a sequence of projected patterns, such that each point on the surface of the subject is represented by a unique binary code. N patterns can code 2^{N} stripes, in the example of a 5 bit pattern, the result are 32 stripes. The example pattern series is 2 stripes (1 black, 1 white), then 4, 8, 16 and 32. When the images are captured and combined by the software, 32 unique x, y coordinates for each point along a line can be identified. Utilizing triangulation for each of the 32 points the z-distance can be calculated. When the data from multiple lines are combined a depth map of the subject can be derived.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination. Further, in this example there is a series of 5 separate patterns projected, by controlling the projected pixels, the software can change the projected pattern each frame or frames as required.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is sequential gray code, 5112, is similar to sequential binary code referenced in 5110, with the use of intensity modulated stripes instead of binary on/off patterns. This increases the level information that can be derived with the same or fewer patterns. In this example, L represents the levels of intensity and N the number of patterns in a sequence. Further in this example, there are 4 levels of intensity, black (off), white (100% on), 1 step gray (33% on), 2nd step gray (66% on) or L=4. N, the number of patterns in a sequence in this example is 3 resulting in 43 or 64, the number of unique points in one line.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination. Further, in this example there is a series of 3 separate patterns projected, by controlling the projected pixels, the software can change the projected pattern each frame or frames as required.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is sequentially projected phase shifting, 5114, which utilizes the projection of sequential sinusoidal patterns onto a subject area. In this example a series of three of sinusoidal fringe patterns represented as I_{N}, are projected onto the area of interest. The intensities for each pixel (x, y) of the three the patterns are described as

I₁(x,y)=I₀(x,y)+I mod(x,y)cos(φ)(x,y)−θ),

I₂(x,y)=I₀(x,y)+I mod(x,y)cos(φ)(x,y)),

I₃(x,y)=I₀(x,y)+I mod(x,y)cos(φ(x,y)+θ),

where I₁(x, y), I₂(x, y), and I₃(x, y) are the intensities of three patterns, I₀(x, y) is the component background, Imod(x, y) is the modulation signal amplitude, (φ(x, y) is the phase, and θ is the constant phase-shift angle.

Phase unwrapping is the process that converts the wrapped phase to the absolute phase. The phase information can be retrieved and unwrapped is derived from the intensities in the three fringe patterns.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination. Further, in this example there is a series of 3 separate patterns projected, by controlling the projected pixels, the software can change the projected pattern each frame or frames as required.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is Trapezoidal, 5116. This method is similar to that described in 5114 phase shifting, but replaces a sinusoidal pattern with trapezoidal-shaped gray levels. Interpretation of the data into a depth map is similar, but can be more computationally efficient.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination. Further, in this example there is a series of 3 separate patterns projected, by controlling the projected pixels, the software can change the projected pattern each frame or frames as required.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is a hybrid method, 5118, which combines methods of gray coding as described in 5112 and phase shifting as described in 5114 can be combined to form a precise series of patterns with reduced ambiguity. The gray code pattern determines non ambiguous range of phase while phase shifting provides increased sub-pixel resolution. In this example, 4 patterns of a gray code are combined with 4 patterns of phase shifting to create an 8 frame sequence.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination. Further, in this example there is a series of 8 separate patterns projected, by controlling the projected pixels, the software can change the projected pattern each frame or frames as required.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this utilizes a Moire' pattern, 5120, which is based on the geometric interference between two patterns. The overlap of the patterns forms a series of dark and light fringes. These patterns can be interpreted to derive depth information.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination. Further, in this example there is a series of at least 2 separate patterns projected, by controlling the projected pixels, the software can change the projected pattern each frame or frames as required.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is multi-wavelength also referred to as Rainbow 3D, 5122, is based upon spatially varying wavelengths projected onto the subject. With a known physical relationship between the directed illumination and image sensor, D and the calculated value for θ, the angle between the image sensor and a particular wavelength of light λ, unique points can be identified on a subject and utilizing methods of triangulation distances to each point can be calculated.

This system can utilize light in the visible spectrum or in the IR/NIR spaced apart such that they can be subsequently separated by the system.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is a continuously varying code, 5124, can be formed utilizing three additive wavelengths, often times primary color channels of RGB or unique wavelengths of IR/NIR such that when added together form a continuously varying pattern. The interpretation of the captured image is similar to that as described in 5122.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is striped indexing, 5126, utilizes multiple wavelengths selected far enough apart to prevent cross talk noise from the imaging sensor. The wavelengths may be in the visible spectrum, generated by the combination of primary additive color sources such as RGB, or a range of IR/NIR. Stripes may be replaced with patterns to enhance the resolution of the image capture. The interpretation of the captured image is similar to that as described in 5122.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is the use of segmented stripes, 5128, where to provide additional information about a pattern, a code is to introduced within a stripe. This creates a unique pattern for each line, and when known by the system, can allow one stripe to be easily identified from another.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is stripe indexing gray scale, 5130, where amplitude modulation provides for control of the intensity, stripes can be given gray scale values. In a simple example a 3 level sequence can be black, gray, and white. The gray stripes can be created by setting the level of each projected pixel at some value between 0 and the maximum. In non-amplitude modulated system the gray can be generated by a pattern of on/off pixels producing an average illumination of a stripe equivalent to level of gray or by reducing the on time of the pixel such that during one frame of exposure of an imaging device the on is a fraction of the full exposure. In such an example the charged level of the imaged pixels is proportionally less than that of full on and greater than off. An example of a pattern sequence is depicted below where B represents black, W represents white, and G represents gray. The pattern is depicted such that the sequence does not necessarily repeat as long as no two values appear next to each other.
BWGWBGWGBGWBGBWBGW.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is De Bruijn sequence, 5132, which refers to a cyclic sequence of patterns where no pattern of elements repeats during the cycle in either an upward or downward progression through the cycle. In this example a three element pattern where each element has only 2 values 1 or 0, generates a cyclic pattern of 23=8 unique patterns (000, 001, 010, 100, 101, 110, 111). These sequences generate a pattern where no variation is adjacent to a similar pattern. The decoding of a De Bruijn sequence requires less computation work than other similar patterns. The variation in the pattern may be color/wavelength, width or combination of width and color/wavelength.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is pseudo-random binary, 5134, utilizes a 2D grid pattern which segments the projected area into smaller areas in which a unique pattern is projected into each sub area such that one area is identifiable from adjacent segments. Pseudo-random binary arrays utilize a mathematical algorithm to generate a pseudo-random pattern of points which can be projected onto each segment.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is similar to the methodology described in 5134, where the binary points can be replaced by a point made up of multiple values generating a mini-pattern or code word, 5136. Each projected mini-pattern or code word creates a unique point identifier in each grid segment.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is a color/wavelength coded grid, 5138. In some instances it may be beneficial to have grid lines with alternating colors/wavelengths.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment example of this is a color/wavelength dot array, 5140 where unique wavelengths are assigned to points within each segment. In this example visible colors of R red, G green, and B blue are used. These could also be unique wavelengths of IR/NIR spaced far enough apart such as to minimize the cross talk that might occur on the image sensor.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

One embodiment of this is the ability of the system to combine multiple methods into hybrid methods, 5142. The system determines areas of interest and segments the area. The system can then determine which method or combination/hybrid of methods is best suited for the given subject. Distance information can be used to calibrate the pattern for the object. The result is a segmented projected pattern where a specific pattern or hybrid pattern is calibrated to optimize data about each subject area. Factors influencing the patterns selected may include but not be limited to, if the subject is living, inanimate, moving, stationary, relative distance from the device, general lighting, and environmental conditions. The system processes each segment as a unique depth map or point cloud. The system can further recombine the segmented pieces to form a more complete map of the viewed area.

Systems that utilize this methodology require changing the projected pattern for each frame in the sequence. Projection systems have additional challenges in projecting the pattern evenly across a subject, especially one that may move along a Z axis, distance from the device, as the throw angle of the projection will alter the number of lines on the subject, or one where the subject may move allowing for only a portion or disproportionate spacing of the pattern to be projected onto the subject.

Directed illumination as described here, controls the illumination of an area at a pixel level. The system has the ability to control amplitude of each pixel from zero, or off, to a maximum level. An image captured by a sensor can be analyzed by system or a human observer to determine an area or areas of interest. Using triangulation or other method of determining the distance to the object from the device, the system determines the boundaries of the subject to be illuminated with a pattern and with the known distance, applies a calibration algorithm to the projected pattern and by controlling which projected pixels are turned on during one frame, optimize the pattern illumination. Further, in this example there is a series of multiple separate patterns projected, by controlling the projected pixels, the software can change the projected pattern each frame or frames as required. Further, in this example there are any number of separate patterns projected, by controlling the projected pixels, the software can change the projected pattern each frame or frames as required.

Subject areas of interest may be located at distances from the device which are not optimal for one level of calibration. In these instances the system is configured such that the projection area is segmented and uniquely calibrated projected patterns are generated for each area of interest. The system has the ability to analyze each segment independently. To form a cohesive 3D map of independent segments, the information used to segment the areas of interest is utilized to reassemble or stitch the depth map for each segment into one image. As the subjects move, the system is configured to reanalyze the environment and dynamically calibrate the projected patterns accordingly.

### Shared Aperture

Some embodiments include features for directing light onto specific target area(s), and image capture when used in a closed or open loop system. Such an example embodiment may include using use of a shared optical aperture for both the directed illumination and image sensor to help achieve matched throw angels and FOV angles.

For example, generally there may be three basic methodologies for optically configuring a shared aperture: adjacent, common and objective, with variations on the basic configurations to utilize a shared aperture configuration to best fit the overall system design objectives.

Certain embodiments may include a device for directing illumination and an image sensor that share the same aperture and for some portion of the optical path have comingled light paths. In such an example, at some point the path may split, thus allowing the incoming light to be directed to an image sensor. Continuing with this example, the outgoing light path may exit through the same aperture as the incoming light. Such an example embodiment may provide an optical system where the throw angle of the directed illumination and the FOV angle of the incoming light are matched. This may create a physically calibrated incoming and outgoing optical path. This may also create a system which requires only one optical opening in a device.

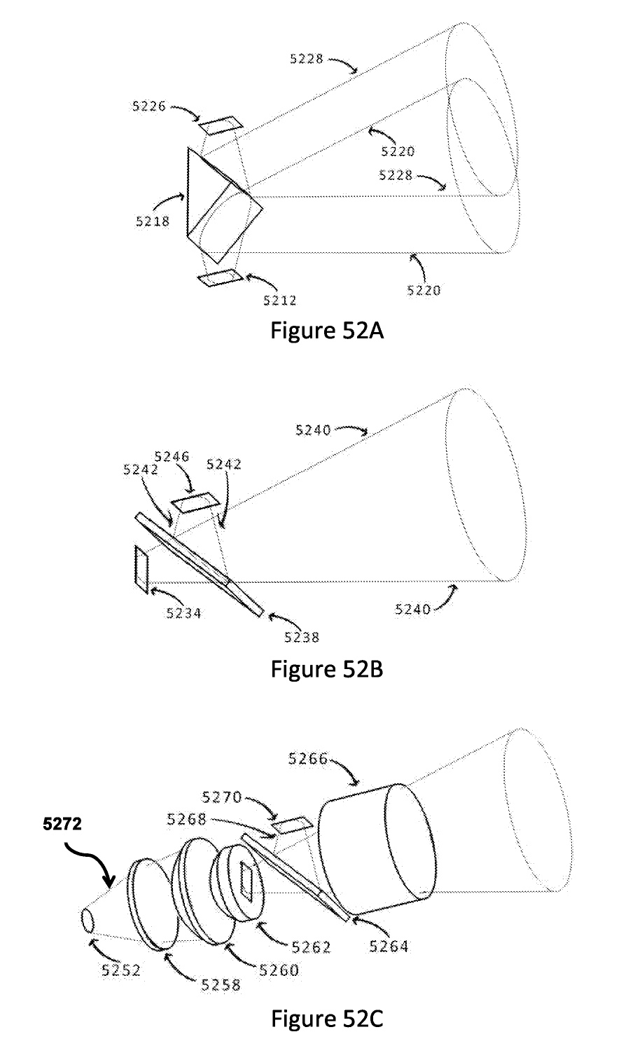

FIG. 52A illustrates an adjacent configuration example where the outgoing and incoming light paths share the same aperture but are not comingled paths. In this example, light from a semiconductor laser or other light emitting device 5212 is directed by an optical element (not pictured) to a 2D MEMs (not pictured) or other mechanism for directing the beam. The outgoing light 5220 is the reflected off of a prism 5218 through the shared aperture (not pictured). Incoming light 5228 is reflected off of the same prism 5218 through a lens (not pictured) and onto an image sensor 5226. In this configuration example, the prism 5218 can be replaced by two mirrors that occupy the same relative surface (not pictured). This example configuration assumes that some degree of image and directed illumination may be corrected for by other means such as system calibration algorithms.

FIG. 52B illustrates an example embodiment of one example configuration where the outgoing and incoming light paths share the same aperture and for some portion the optical path is comingled. In this example, light from a semiconductor laser or other light emitting device 5234 is directed by an optical element (not pictured) to a 2D MEMs (not pictured), for example, but any other mechanism could be used to direct the beam. The outgoing light 5240 passes through a polarized element 5238 and continues through the shared aperture (not pictured). Incoming light 5242 enters the shared aperture and is reflected off of the polarized element 5238 onto an image sensor 5246. This configuration provides for a simple configuration to achieve coincident apertures.

FIG. 52C illustrates an example embodiment of an example configuration where outgoing and incoming light paths share the same common objective lens and for some portion the optical path is comingled. In this example, light from a semiconductor laser or other light emitting device 5252, for example, is directed by an optical element (not pictured) to a 2D MEMs (not pictured) or other mechanism for directing the beam. The outgoing light 5272 passes through lens 5258 to a scan format lens 5260 which creates a focused spot that maps the directed illumination to the same dimensions as the image sensor active area. The outgoing light then passes through optical element 5262, through a polarized element 5264 and exits through common objective lens 5266. In the example embodiment, incoming light enters through the common objective lens 5266 and is reflected off of the polarized element 5264 and onto the image sensor 5270.

Certain example embodiments may allow for a secondary source of illumination such as a visible light projector to be incorporated into the optical path of the directed illumination device. And certain example embodiments may allow for a secondary image sensor, enabling as an example for one image sensor designed for visible light and one designed for IR/NIR to share the same optical path.

### CONCLUSION

It should be noted that in this disclosure, the notion of “black and white” is in reference to the IR gray scale and is for purposes of human understanding only. One of skill in the art understands that the in dealing with IR and IR outputs, a real “black and white” as the human eye perceives it, may not exist. Instead, for IR, black is actually the absence of illumination—or binary “off” and White which in additive illumination is the full spectrum of visible light (400-700 nm) combined. For IR (700-1000 nm) “white” does not mean anything, but is relative to the binary “on”.

The inventive aspects here have mainly been described above with reference to a few embodiments. However, as is readily appreciated by a person, other embodiments than the ones disclosed above are equally possible within the scope of the invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A system for target illumination and mapping, comprising,
a light source and an image sensor;
the light source configured to,
communicate with a processor;
scan a target area within a field of view;
receive direction from the processor regarding projecting light within the field of view on at least one target;
the image sensor configured to,
communicate with the processor;
receive reflected illumination from the target area within the field of view;
generate data regarding the received reflected illumination; and
send the data regarding the received reflected illumination to the processor.

2. The system of claim 1 wherein the light source is an array of light emitting diodes (LEDs).

3. The system of claim 1 wherein the light source is a laser, wherein the laser is at least one of, amplitude modulated and pulse width modulated.

4. The system of claim 3 wherein the laser is an infrared laser and the image sensor is configured to receive and process infrared energy.

5. The system of claim 4 wherein the direction received from the processor includes direction to track the at least one target.

6. The system of claim 5 wherein the data regarding the received reflected illumination includes information that would allow the processor to determine the distance from the system to the select target via triangulation.

7. The system of claim 5 wherein the system is light source is further configured to receive direction from the processor to illuminate the tracked target in motion and
wherein the light source is further configured to block illumination of particular areas on the at least one select target via direction from the processor.

8. The system of claim 7 wherein the target is a human; and
wherein the particular areas on the at least one select target are areas which correspond to eyes of the target.

9. The system of claim 4 wherein the scan of the target area is a raster scan completed within one frame of the image sensor.

10. The system of claim 9 wherein the light source includes at least one of, a single axis micro electromechanical system mirror (MEMS) and a dual axis MEMS, to direct the light.

11. The system of claim 1 wherein the image sensor is one of,
a complementary metal oxide semiconductor (CMOS), and a charge coupled device (CCD).

12. A system for illuminating a target area, comprising,
a directionally controlled laser light source, and an image sensor;
the directionally controlled laser light source configured to,
communicate with a processor;
scan the target area,
receive direction on illuminating specific selected targets within the target area from the processor,
wherein the laser is at least one of, amplitude modulated and pulse width modulated; and
the image sensor configured to,
communicate with the processor;
receive the laser light reflected off of the target area;
generate data regarding the received reflected laser light; and
send the data regarding the received laser light to the processor.

13. The system of claim 12 wherein the laser light source is further configured to receive direction from the processor to illuminate at least two target objects with different illumination patterns.

14. The system of claim 12 wherein the data regarding the received reflected laser light is configured to allow the processor to calculate a depth map.

15. The system of claim 13 wherein the pattern is one of,
alternating illuminated and non-illuminated stripes, intensity modulated stripes, sequential sinusoidal, trapezoidal, Moire' pattern, multi-wavelength 3D, continuously varying, striped indexing, segmented stripes, coded stripes, indexing gray scale, De Bruiin sequence, pseudo-random binary, mini-pattern, wavelength coded grid, and wavelength dot array.

16. The system of claim 14 wherein the data regarding the received reflected laser light is configured to allow the processor to calculate a point cloud.

17. A method for target illumination and mapping, comprising,
via a light source,
communicating with a processor;
scanning a target area within a field of view;
receiving direction from the processor regarding projecting light within the field of view on at least one target;
via an image sensor,
communicating with the processor;
receiving reflected illumination from the target area within the field of view;
generating data regarding the received reflected illumination; and
sending the data regarding the received reflected illumination to the processor.

18. The method of claim 17 wherein the light source is an array of light emitting diodes (LEDs).

19. The method of claim 17 wherein the light source is a laser, wherein the laser is at least one of, amplitude modulated and pulse width modulated.

20. The method of claim 19 wherein the laser is an infrared laser and the image sensor is configured to receive and process infrared energy, and
wherein the direction received from the processor includes direction to track the at least one target, and
wherein the data regarding the received reflected illumination includes information that would allow the processor to determine the distance from the system to the select target via triangulation.
